(19) United States
(12) Patent Application Publication
(10) Pub. No.: US 2021/0329002 A1
(43) Pub. Date: Oct. 21, 2021

(54) INTELLIGENT SERVICE PROVIDING METHOD AND APPARATUS BASED ON AUTHENTICATION LEVEL

(71) Applicant: LG ELECTRONICS INC., Seoul (KR)

(72) Inventors: Jiyoung HUH, Seoul (KR); Eunyoung PARK, Seoul (KR); Jinsung PARK, Seoul (KR)

(73) Assignee: LG ELECTRONICS INC., Seoul (KR)

(21) Appl. No.: 16/491,554

(22) PCT Filed: May 9, 2019
(86) PCT No.: PCT/KR2019/005594

§ 371 Date: Sep. 5, 2019

(51) Int. Cl. H04L 29/06; H04W 12/06

(52) U.S. Cl. CPC H04L 63/108; H04L 63/105; H04W 12/06; H04L 63/0861

(57) ABSTRACT

A method for providing a service using a device based on an authentication level is disclosed. The method for providing a service using a device based on an authentication level according to one embodiment of the present invention includes, when a first authentication request to request configuring of a first authentication level for the device is obtained, configuring the first authentication level for the device; when an access request to one of a plurality of services provided using the device is obtained, determining whether the first authentication level for the device matches the access request; and upon determination that the first authentication level matches the access request, providing the service using the device. Thus, the service corresponding to the authentication level matching with the authentication may be provided without the need of further authentication. The present intelligent devices may be associated with autonomous driving vehicles, drones (unmanned aerial vehicles, UAVs), robots, augmented reality (AR) devices, virtual reality (VR) devices, and devices related to 5G services.

### TECHNICAL FIELD

The present invention relates to a service providing method and apparatus. More particularly, the present invention relates to a method and an apparatus capable of intelligently controlling a user's access based on an authentication level to provide a service.

### BACKGROUND ART

Recently, it has become possible to provide users with various types of user interface (UI) using a smart device.

When the user intends to access or use a specific device, for example, a mobile terminal, door lock, home security camera, TV, vehicle, etc. authentication based on the characteristics of each device should be completed.

Further, various types of services provided by each device are provided via a single authentication. For example, even when the user only performs unlocking as relatively low-level of authentication means on the mobile terminal's screen, the user may access any application that does not require authentication means and any application that requires a relatively high level of authentication means. However, in this case, arbitrary user (for example, the owner of the device or others) may access private information (for example, photos, contacts, chat applications, etc.) provided by the specific device.

In order to solve this problem, in a prior art, authentication means for unlocking on the screen of the mobile terminal and authentication means for accessing an application having a relatively high security level may be individually required. That is, various methods of authentication are required for various applications. However, in this case, a high level of authentication means is required to access a low security level application. Further, it is troublesome to input authentication means every time when accessing the application of the same security level again.

### DISCLOSURE

### Technical Problem

An object of the present invention is to meet the needs and solve the problems.

Further, the present invention aims to implement a service providing method and apparatus that provide various services provided by a device based on an authentication level configured for the device.

### Technical Solution

In one aspect of the present disclosure, there is provided a method for providing a service using a device based on an authentication level, the method comprising: when a first authentication request to request configuring of a first authentication level for the device is obtained, configuring the first authentication level for the device; when an access request to one of a plurality of services provided using the device is obtained, determining whether the first authentication level for the device matches the access request; and upon determination that the first authentication level matches the access request, providing the service using the device.

The method may further comprise, upon determination that the authentication level does not match the access request, recommending an authentication level matching the access request.

The method may further comprise, when a threshold time duration has elapsed after the first authentication level has been set, cancelling the first authentication level.

The cancelling includes: when a second authentication request is obtained before the threshold time duration has elapsed, maintaining the first authentication level.

The maintaining includes: reconfiguring a timer as soon as the second authentication request is obtained.

The cancelling includes: switching the first authentication level gradually to a default authentication level in an inverse proportional manner to a time lapse for the threshold time duration.

The method may further comprise configuring a third authentication level for the device when a second authentication request to request a second authentication level is obtained, wherein a number of services matching the second authentication level is smaller than a number of services matching the first authentication level, and a number of services matching the third authentication level is larger than a number of services matching the first authentication level.

The method may further comprise, when a first threshold time duration has elapsed after the first authentication level is set, switching the third authentication level to the second authentication level for the device; and when a second threshold time duration has elapsed after the second authentication request is obtained, cancelling the second authentication level.

A service matching the second authentication level requires a security level lower than a security level of a service matching the first authentication level.

The first authentication request includes fingerprint recognition or face recognition, wherein the second authentication request includes touch recognition, speech recognition, or gesture recognition.

In one aspect of the present disclosure, there is provided an intelligent service providing apparatus for providing a service based on an authentication level, the apparatus comprising: an input interface configured for obtaining a first authentication request to request configuring of a first authentication level for a device, and for obtaining an access request to one of a plurality of services provided using the device; a processor configured for configuring the first authentication level for the device in response to the first authentication request, and for determining, in response to the access request, whether the first authentication level for the device matches the access request; and an output interface configured for providing the service using the device, upon determination that the first authentication level matches the access request.

The processor recommends an authentication level matching the access request, upon determination that the authentication level does not match the access request.

The processor cancels the first authentication level when a threshold time duration has elapsed after the first authentication level has been configured.

The processor maintains the first authentication level when a second authentication request is obtained before the threshold time duration has elapsed.

The processor reconfigures a timer as soon as the second authentication request is obtained.

The processor switches the first authentication level gradually to a default authentication level in an inverse proportional manner to a time lapse for the threshold time duration.

The processor configures a third authentication level for the device when a second authentication request to request a second authentication level is obtained, wherein a number of services matching the second authentication level is smaller than a number of services matching the first authentication level, wherein a number of services matching the third authentication level is larger than a number of services matching the first authentication level.

The processor switches the third authentication level to the second authentication level for the device when a first threshold time duration has elapsed after the first authentication level is set; and cancels the second authentication level when a second threshold time duration has elapsed after the second authentication request is obtained.

A service matching the second authentication level requires a security level lower than a security level of a service matching the first authentication level.

The first authentication request includes fingerprint recognition or face recognition, wherein the second authentication request includes touch recognition, speech recognition, or gesture recognition.

### Advantageous Effects

In the service providing method and the apparatus according to one embodiment of the present invention, the authentication means may be input once and then the services corresponding to the authentication level that matches the authentication means as input may be provided without additional authentication.

Further, in the service providing method and apparatus according to one embodiment of the present invention, the currently configured authentication level may be maintained for a predetermined time without inputting the same authentication means as previously input, such that the user may continue to be provided with the services corresponding to the authentication level service for a certain period of time upon the single authentication.

### DESCRIPTION OF DRAWINGS

FIG. 1 is a block diagram of a wireless communication system to which the methods proposed herein may be applied.

FIG. 2 shows an example of a basic operation of an user equipment and a 5G network in a 5G communication system.

FIG. 3 illustrates an example of application operation of an user equipment and a 5G network in a 5G communication system.

FIGS. 4 to 7 show an example of an operation of an user equipment using 5G communication.

FIG. 8 is a diagram illustrating an example of a 3GPP signal transmission/reception method.

FIG. 9 illustrates an SSB structure and FIG. 10 illustrates SSB transmission.

FIG. 11 illustrates an example of a random access procedure.

FIG. 12 shows an example of an uplink grant.

FIG. 13 shows an example of a conceptual diagram of uplink physical channel processing.

FIG. 14 shows an example of an NR slot in which a PUCCH is transmitted.

FIG. 15 is a block diagram of a transmitter and a receiver for hybrid beamforming

FIG. 16 shows an example of beamforming using an SSB and a CSI-RS.

FIG. 17 is a flowchart illustrating an example of a DL BM process using an SSB.

FIG. 18 shows another example of DL BM process using a CSI-RS.

FIG. 19 is a flowchart illustrating an example of a process of determining a reception beam of a UE.

FIG. 20 is a flowchart illustrating an example of a transmission beam determining process of a BS.

FIG. 21 shows an example of resource allocation in time and frequency domains related to an operation of FIG. 18.

FIG. 22 shows an example of a UL BM process using an SRS.

FIG. 23 is a flowchart illustrating an example of a UL BM process using an SRS.

FIG. 24 is a diagram showing an example of a method of indicating a pre-emption.

FIG. 25 shows an example of a time/frequency set of pre-emption indication.

FIG. 26 shows an example of a narrowband operation and frequency diversity.

FIG. 27 is a diagram illustrating physical channels that may be used for MTC and a general signal transmission method using the same.

FIG. 28 is a diagram illustrating an example of scheduling for each of MTC and legacy LTE.

FIG. 29 shows an example of a frame structure when a subcarrier spacing is 15 kHz.

FIG. 30 shows an example of a frame structure when a subscriber spacing is 3.75 kHz.

FIG. 31 shows an example of a resource grid for NB-IoT uplink.

FIG. 32 shows an example of an NB-IoT operation mode.

FIG. 33 is a diagram illustrating an example of physical channels that may be used for NB-IoT and a general signal transmission method using the same.

FIG. 34 is a block diagram illustrating the intelligent service providing apparatus associated with the present invention.

FIG. 35 is a block diagram illustrating an example of the controller in FIG. 34.

FIG. 36 is a flow chart illustrating an intelligent service providing method according to an embodiment of the present invention.

FIG. 37 is a flow chart showing a method for configuring the authentication level according to one embodiment of the present invention.

FIG. 38 shows an example of a graph showing authentication levels over time.

FIG. 39 shows another example of a graph showing authentication levels over time.

FIG. 40 shows still another example of a graph showing authentication levels over time.

FIG. 41 shows still another example of a graph showing authentication levels over time.

FIG. 42 shows still another example of a graph showing authentication levels over time.

FIG. 43 shows a process for the authentication request and authentication level configuring for the mobile terminal.

FIG. 44 shows a service provided according to each authentication level of the mobile terminal.

FIG. 45 shows an example of obtaining an application execution request while a first authentication level has been configured.

FIG. 46 shows an example of obtaining an application execution request while a first authentication level has been configured.

FIG. 47 shows an intelligent service providing system according to another embodiment of the present invention.

FIG. 48 shows an example of a vehicle in FIG. 47.

FIG. 49 is a block diagram showing a detailed configuration of an autonomous driving vehicle of FIG. 48.

FIG. 50 is a block diagram showing a detailed configuration of a smart key 400 in FIG. 47.

FIG. 51 shows a process for the authentication request and authentication level configuring for the vehicle.

FIG. 52 shows a service provided based on each authentication level of the vehicle.

FIG. 53 shows an example of acquiring a door unlocking request while a first authentication level has been configured for the vehicle.

FIG. 54 shows an example of obtaining a start-up request while a first authentication level has been configured for the vehicle.

FIG. 55 shows one process in which the vehicle obtains a second authentication request.

FIG. 56 shows an intelligent service provisioning system according to another embodiment of the present invention.

FIG. 57 shows a detailed configuration of the intelligent service providing apparatus 500 of FIG. 56.

FIG. 58 shows a camera in FIG. 56.

FIG. 59 shows a robot in FIG. 56.

FIG. 60 shows a process for the authentication request and authentication level configuring for a door lock.

FIG. 61 shows an example of acquiring a door unlocking request while a first authentication level has been configured for the door lock.

FIG. 62 shows another example of obtaining a door unlocking request while a first authentication level has been configured for the door lock.

FIG. 63 shows another example of obtaining a door unlocking request while a second authentication level has been configured for the door lock.

### DETAILED DESCRIPTIONS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus may be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Autonomous Vehicle and 5G Network

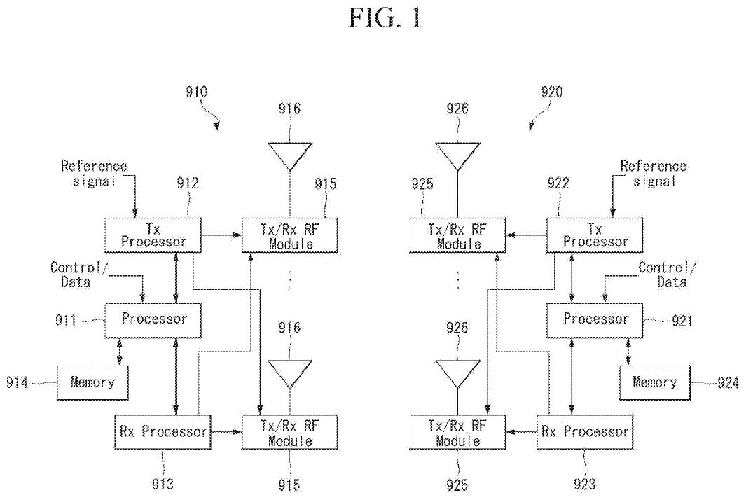

FIG. 1 is a block diagram of a wireless communication system to which methods proposed in the disclosure are applicable.

Referring to FIG. 1, a device including an autonomous driving module is defined as a first communication device (910 of FIG. 1 and see paragraph N for detailed description), and a processor 911 may perform detailed autonomous driving operations.

Another vehicle or a 5G network communicating with the autonomous driving device is defined as a second communication device (920 of FIG. 1, and see paragraph N for details), and a processor 921 may perform detailed autonomous driving operations.

Details of a wireless communication system, which is defined as including a first communication device, which is an autonomous vehicle, and a second communication device, which is a 5G network, may refer to paragraph N.

B. AI Operation Using 5G Communication

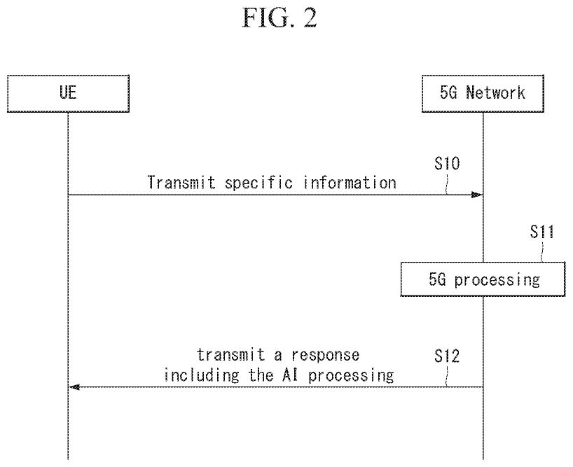

FIG. 2 shows an example of a basic operation of a user equipment and a 5G network in a 5G communication system.

The UE transmits the specific information transmission to the 5G network (S1).

Then, the 5G network performs 5G processing on the specific information (S2).

In this connection, the 5G processing may include AI processing.

Then, the 5G network transmits a response including the AI processing result to the UE (S3).

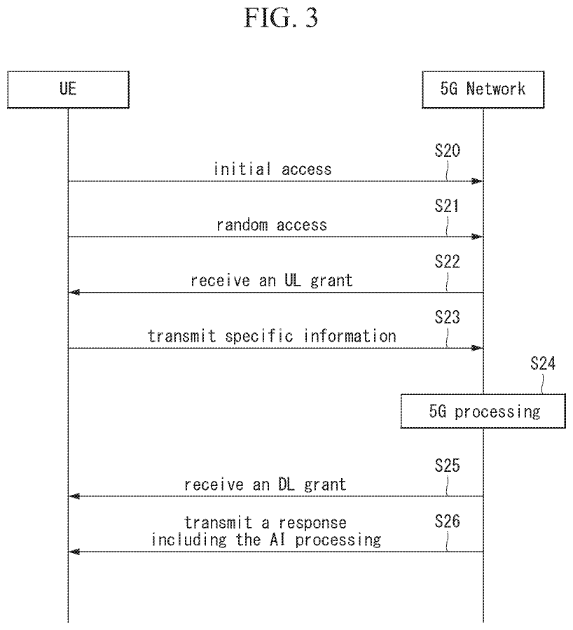

FIG. 3 shows an example of application operation of a user terminal and a 5G network in a 5G communication system.

The UE performs an initial access procedure with the 5G network (S20). The initial connection procedure will be described in more detail in paragraph F.

Then, the UE performs a random access procedure with the 5G network (S21). The random access procedure will be described in more detail in paragraph G.

The 5G network transmits an UL grant for scheduling transmission of specific information to the UE (S22). The process of the UE receiving the UL grant will be described in more detail in the UL transmission/reception operation in paragraph H.

Then, the UE transmits specific information to the 5G network based on the UL grant (S23).

Then, the 5G network performs 5G processing on the specific information (S24).

In this connection, the 5G processing may include AI processing.

Then, the 5G network transmits a DL grant for scheduling transmission of the 5G processing result of the specific information to the UE (S25).

Then, the 5G network transmits a response including the AI processing result to the UE based on the DL grant (S26).

In FIG. 3, an example in which the AI operation and the initial connection process, or the random access process and the DL grant reception process are combined with each other has been exemplarily described using the S20 to S26. However, the present invention is not limited thereto.

For example, the initial connection process and/or the random access process may be performed using the process of S20, S22, S23, S24, and S24. In addition, the initial connection process and/or the random access process may be performed using, for example, the process of S21, S22, S23, S24, and S26. Further, the AI operation and the downlink grant reception procedure may be combined with each other using the process of S23, S24, S25, and S26.

C. UE Operation Using 5G Communication

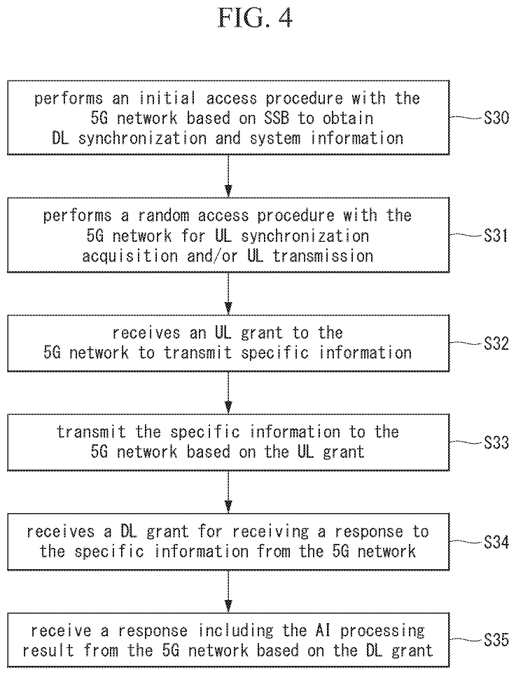

FIG. 4 to FIG. 7 show an example of the operation of the UE using 5G communication.

Referring first to FIG. 4, the UE performs an initial access procedure with the 5G network based on SSB to obtain DL synchronization and system information (S30).

Then, the UE performs a random access procedure with the 5G network for UL synchronization acquisition and/or UL transmission (S31).

Then, the UE receives an UL grant to the 5G network to transmit specific information (S32).

Then, the UE transmits the specific information to the 5G network based on the UL grant (S33).

Then, the UE receives a DL grant for receiving a response to the specific information from the 5G network (S34).

Then, the UE receives a response including the AI processing result from the 5G network based on the DL grant (S35).

A beam management (BM) process may be added to S30. A beam failure recovery process may be added to S31. A quasi-co location relationship may be added to S32 to S35. A more detailed description thereof will be described in more detail in paragraph I.

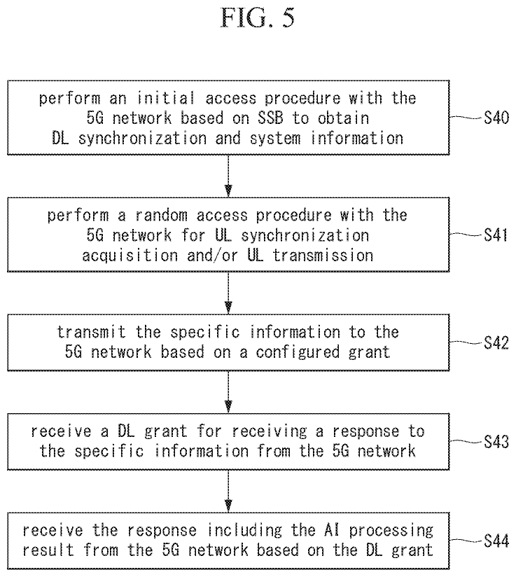

Next, referring to FIG. 5, the UE performs an initial access procedure with the 5G network based on SSB to obtain DL synchronization and system information (S40).

Then, the UE performs a random access procedure with the 5G network for UL synchronization acquisition and/or UL transmission (S41).

Then, the UE transmits the specific information to the 5G network based on a configured grant (S42). A procedure for configuring the grant in place of receiving the UL grant from the 5G network will be described in more detail in paragraph H.

Then, the UE receives a DL grant for receiving a response to the specific information from the 5G network (S43).

Then, the UE receives the response including the AI processing result from the 5G network based on the DL grant (S44).

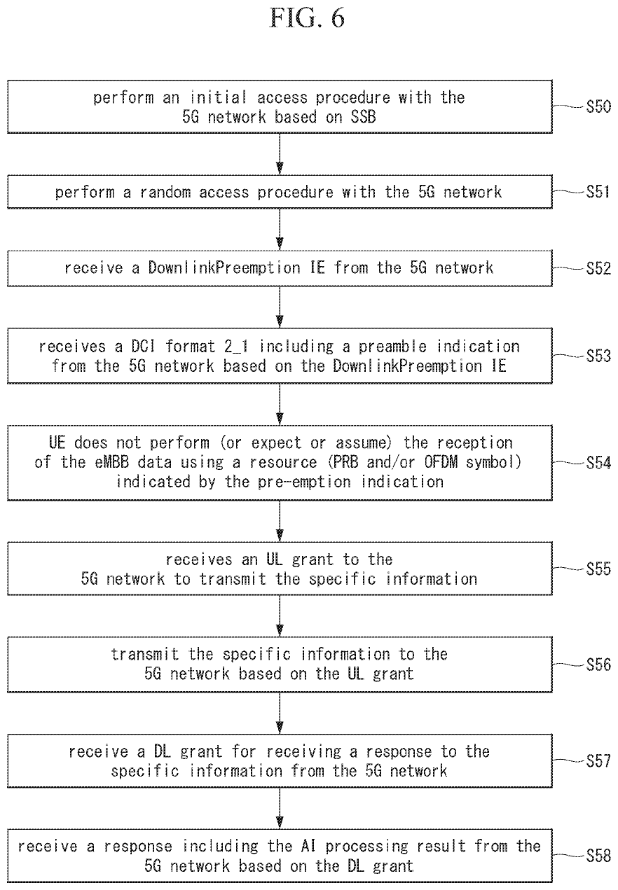

Next, referring to FIG. 6, the UE performs an initial access procedure with the 5G network based on the SSB to obtain DL synchronization and system information (S50).

Then, the UE performs a random access procedure with the 5G network for UL synchronization acquisition and/or UL transmission (SM).

Then, the UE receives a DownlinkPreemption IE from the 5G network (S52).

The UE receives a DCI format 2_1 including a preamble indication from the 5G network based on the DownlinkPreemption IE (S53).

Then, the UE does not perform (or expect or assume) the reception of the eMBB data using a resource (PRB and/or OFDM symbol) indicated by the pre-emption indication (S54).

The operation related to the preemption indication is described in more detail in paragraph J.

Then, the UE receives an UL grant to the 5G network to transmit the specific information (S55).

Then, the UE transmits the specific information to the 5G network based on the UL grant (S56).

Then, the UE receives a DL grant for receiving a response to the specific information from the 5G network (S57).

Then, the UE receives a response including the AI processing result from the 5G network based on the DL grant (S58).

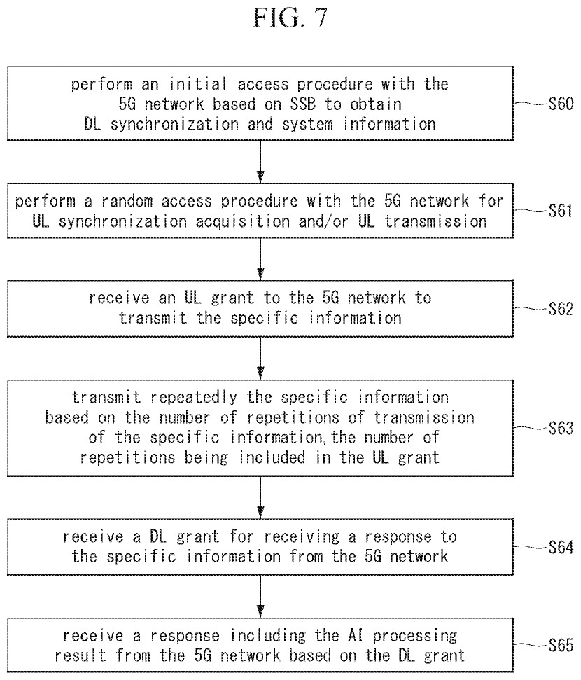

Next, referring to FIG. 7, the UE performs an initial access procedure with the 5G network based on SSB to obtain DL synchronization and system information (S60).

Then, the UE performs a random access procedure with the 5G network for UL synchronization acquisition and/or UL transmission (S61).

Then, the UE receives an UL grant to the 5G network to transmit the specific information (S62).

The UL grant includes information on the number of repetitions of transmission of the specific information. The specific information is repeatedly transmitted based on the information on the repetition number (S63).

The UE transmits the specific information to the 5G network based on the UL grant.

Then, the iterative transmission of the specific information is performed using the frequency hopping. The first transmission of the specific information may be done using a first frequency resource, and the second transmission of the specific information may be done using a second frequency resource.

The specific information may be transmitted over a narrow band of 6RB (Resource Block) or 1RB (Resource Block).

Then, the UE receives a DL grant for receiving a response to the specific information from the 5G network (S64).

Then, the UE receives a response including the AI processing result from the 5G network based on the DL grant (S65).

The mMTC described in FIG. 7 will be described in more detail in the paragraph K.

D. Introduction

Hereinafter, downlink (DL) refers to communication from a base station (BS) to user equipment (UE), and uplink (UL) refers to communication from a UE to a BS. In the downlink, a transmitter may be part of the BS and a receiver may be part of the UE. In the uplink, a transmitter may be part of the UE and a receiver may be part of the BS. Herein, the UE may be represented as a first communication device and the BS may be represented as a second communication device. The BS may be replaced with a term such as a fixed station, a Node B, an evolved NodeB (eNB), a next generation nodeB (gNB), a base transceiver system (BTS), an access point (AP), a network or a 5G (5th generation), artificial intelligence (AI) system, a road side unit (RSU), robot, and the like. Also, the UE may be replaced with a terminal, a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, a device-to-device (D2D) device, a vehicle, a robot, an AI module, and the like.

Techniques described herein may be used in a variety of wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunications System (UMTS). 3rd Generation Partnership Project (3GPP) Long Term Evolution (LTE) is a part of Evolved UMTS (E-UMTS) using E-UTRA. LTE-Advanced (LTE-A)/LTE-A pro is an evolution of 3GPP LTE. 3GPP NR NR(New Radio or New Radio Access Technology) is an evolution of 3GPP LTE/LTE-A/LTE-A pro.

For clarity, the following description focuses on a 3GPP communication system (e.g., LTE-A, NR), but technical features of the present invention is not limited thereto. LTE refers to technology after 3GPP TS 36.xxx Release 8. In detail, LTE technology after 3GPP TS 36.xxx Release 10 is referred to as LTE-A, and LTE technology after 3GPP TS 36.xxx Release 13 is referred to as LTE-A pro. 3GPP 5G (5th generation) technology refers to technology after TS 36.xxx Release 15 and technology after TS 38.XXX Release 15. The technology after TS 38.xxx Release 15 may be referred to as 3GPP NR, and technology after TS 36.xxx Release 15 may be referred to as enhanced LTE. “xxx” refers to a standard document detail number. LTE/NR may be collectively referred to as a 3GPP system.

In this disclosure, a node refers to a fixed point capable of transmitting/receiving a radio signal through communication with a UE. Various types of BSs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be a BS. For example, the node may be a radio remote head (RRH) or a radio remote unit (RRU). The RRH or RRU generally has a power level lower than a power level of a BS. At least one antenna is installed per node. The antenna may refer to a physical antenna or refer to an antenna port, a virtual antenna, or an antenna group. A node may be referred to as a point.

In this specification, a cell refers to a prescribed geographical area to which one or more nodes provide a communication service. A “cell” of a geographic region may be understood as coverage within which a node can provide a service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, coverage of the node may be associated with coverage of “cell” of a radio resource used by the node. Accordingly, the term “cell” may be used to indicate service coverage by the node sometimes, a radio resource at other times, or a range that a signal using a radio resource can reach with valid strength at other times.

In this specification, communicating with a specific cell may refer to communicating with a BS or a node which provides a communication service to the specific cell. In addition, a DL/UL signal of a specific cell refers to a DL/UL signal from/to a BS or a node which provides a communication service to the specific cell. A node providing UL/DL communication services to a UE is called a serving node and a cell to which UL/DL communication services are provided by the serving node is especially called a serving cell. Furthermore, channel status/quality of a specific cell refers to channel status/quality of a channel or communication link formed between a BS or node which provides a communication service to the specific cell and a UE.

Meanwhile, a “cell” associated with radio resource may be defined as a combination of DL resources and UL resources, that is, a combination of a DL component carrier (CC) and a UL CC. A cell may be configured to be a DL resource alone or a combination of DL resources and UL resources. If carrier aggregation is supported, a linkage between a carrier frequency of a DL resource (or DL CC) and a carrier frequency of a UL resource (or UL CC) may be indicated by system information transmitted through a corresponding cell. Here, the carrier frequency may be the same as or different from a center frequency of each cell or CC. Hereinafter, a cell operating at a primary frequency will be referred to as a primary cell (Pcell) or a PCC, and a cell operating at a secondary frequency will be referred to as a secondary cell (Scell) Or SCC. The Scell may be configured after the UE performs a radio resource control (RRC) connection establishment with the BS to establish an RRC connection therebetween, that is, after the UE is RRC_CONNECTED. Here, RRC connection may refer to a channel through which an RRC of the UE and an RRC of the BS may exchange RRC messages with each other. The Scell may be configured to provide additional radio resources to the UE. Depending on the capabilities of the UE, the Scell may form a set of serving cells for the UE together with the Pcell. In the case of a UE which is in the RRC_CONNECTED state but is not configured in carrier aggregation or does not support carrier aggregation, there is only one serving cell that is only configured as the Pcell.

Cells support unique wireless access technologies. For example, transmission/reception according to LTE radio access technology (RAT) is performed on an LTE cell, and transmission/reception according to 5G RAT is performed on a 5G cell.

A carrier aggregation (CA) system refers to a system for supporting a wide bandwidth by aggregating a plurality of carriers each having a narrower bandwidth than a target bandwidth. A CA system is different from OFDMA technology in that DL or UL communication is performed using a plurality of carrier frequencies each of which forms a system bandwidth (or a channel bandwidth), whereas the OFDM system carries a base frequency band divided into a plurality of orthogonal subcarriers on a single carrier frequency to perform DL or UL communication. For example, in the case of OFDMA or orthogonal frequency division multiplexing (OFDM), one frequency band having a constant system bandwidth is divided into a plurality of subcarriers having a certain subscriber spacing, and information/data is mapped in the plurality of subcarriers, and the frequency band to which the information/data is mapped is unconverted and transmitted as a carrier frequency of the frequency band. In the case of wireless carrier aggregation, frequency bands having their own system bandwidth and carrier frequency may be simultaneously used for communication, and each frequency band used for carrier aggregation may be divided into a plurality of subcarriers having a predetermined subcarrier spacing.

The 3GPP-based communication standard defines DL physical channels corresponding to resource elements carrying information derived from a higher layer of a physical layer (e.g., a medium access control (MAC) layer, a radio link control (RLC) layer, a packet data convergence protocol (PDCP) layer, a radio resource control (RRC) layer, a service data adaptation protocol (SDAP), and a non-access stratum (NAS) layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), and a physical downlink control channel (PDCCH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS, a positioning RS (PRS), channel state information RS (CSI-RS), and a demodulation reference signal (DMRS) may be defined as DL RSs. Meanwhile, the 3GPP-based communication standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DM RS) for a UL control/data signal and a sounding reference signal (SRS) used for UL channel measurement are defined as the UL physical signals.

In this specification, a physical downlink control channel (PDCCH) and a physical downlink shared channel (PDSCH) may refer to a set of a time-frequency resources or a set of resource elements carrying downlink control information (DCI) and downlink data, respectively. In addition, a physical uplink control channel, a physical uplink shared channel (PUSCH), and a physical random access channel refer to a set of a time-frequency resources or a set of resource elements carrying uplink control information (UCI), uplink data and random access signals, respectively. Hereinafter, UE's transmitting an uplink physical channel (e.g., PUCCH, PUSCH, or PRACH) means transmitting UCI, uplink data, or a random access signal on the corresponding uplink physical channel or through then uplink physical channel. BS's receiving an uplink physical channel may refer to receiving DCI, uplink data, or random access signal on or through the uplink physical channel BS's transmitting a downlink physical channel (e.g., PDCCH and PDSCH) has the same meaning as transmitting DCI or downlink data on or through the corresponding downlink physical channel. UE's receiving a downlink physical channel may refer to receiving DCI or downlink data on or through the corresponding downlink physical channel.

In this specification, a transport block is a payload for a physical layer. For example, data given to a physical layer from an upper layer or a medium access control (MAC) layer is basically referred to as a transport block.

In this specification, HARQ (Hybrid Automatic Repeat and reQuest) is a kind of error control method. HARQ-acknowledgement (HARQ-ACK) transmitted through the downlink is used for error control on uplink data, and HARQ-ACK transmitted on the uplink is used for error control on downlink data. A transmitter that performs the HARQ operation transmits data (e.g., a transport block, a codeword) and waits for an acknowledgment (ACK). A receiver that performs the HARQ operation sends an acknowledgment (ACK) only when data is properly received, and sends a negative acknowledgment (NACK) if an error occurs in the received data. The transmitter may transmit (new) data if ACK is received, and retransmit data if NACK is received. After the BS transmits scheduling information and data according to the scheduling information, a time delay occurs until the ACK/NACK is received from the UE and retransmission data is transmitted. This time delay occurs due to channel propagation delay and a time taken for data decoding/encoding. Therefore, when new data is sent after the current HARQ process is finished, a blank space occurs in the data transmission due to the time delay. Therefore, a plurality of independent HARQ processes are used to prevent generation of the blank space in data transmission during the time delay period. For example, if there are seven transmission occasions between an initial transmission and retransmission, the communication device may operate seven independent HARQ processes to perform data transmission without a blank space. Utilizing the plurality of parallel HARQ processes, UL/DL transmissions may be performed continuously while waiting for HARQ feedback for a previous UL/DL transmission.

In this specification, channel state information (CSI) refers to information indicating quality of a radio channel (or a link) formed between a UE and an antenna port. The CSI may include at least one of a channel quality indicator (CQI), a precoding matrix indicator (PMI), a CSI-RS resource indicator (CRI), an SSB resource indicator (SSBRI), a layer indicator (LI), a rank indicator (RI), or a reference signal received power (RSRP).

In this specification, frequency division multiplexing (FDM) may refer to transmission/reception of signals/channels/users at different frequency resources, and time division multiplexing (TDM) may refer to transmission/reception of signals/channels/users at different time resources.

In the present invention, a frequency division duplex (FDD) refers to a communication scheme in which uplink communication is performed on an uplink carrier and downlink communication is performed on a downlink carrier wave linked to the uplink carrier, and time division duplex (TDD) refers to a communication scheme in which uplink and downlink communications are performed by dividing time on the same carrier.

For background information, terms, abbreviations, etc. used in the present specification, may refer to those described in standard documents published before the present invention. For example, the following document may be referred:

3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol
3GPP TS 23.303: Proximity-based services (Prose); Stage 2
3GPP TS 23.285: Architecture enhancements for V2X services
3GPP TS 23.401: General Packet Radio Service (GPRS) enhancements for Evolved Universal Terrestrial Radio Access Network (E-UTRAN) access
3GPP TS 23.402: Architecture enhancements for non-3GPP accesses
3GPP TS 23.286: Application layer support for V2X services; Functional architecture and information flows
3GPP TS 24.301: Non-Access-Stratum (NAS) protocol for Evolved Packet System (EPS); Stage 3
3GPP TS 24.302: Access to the 3GPP Evolved Packet Core (EPC) via non-3GPP access networks; Stage 3
3GPP TS 24.334: Proximity-services (ProSe) User Equipment (UE) to ProSe function protocol aspects; Stage 3
3GPP TS 24.386: User Equipment (UE) to V2X control function; protocol aspects; Stage 3

3GPP NR
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

E. 3GPP Signal Transmission/Reception Method

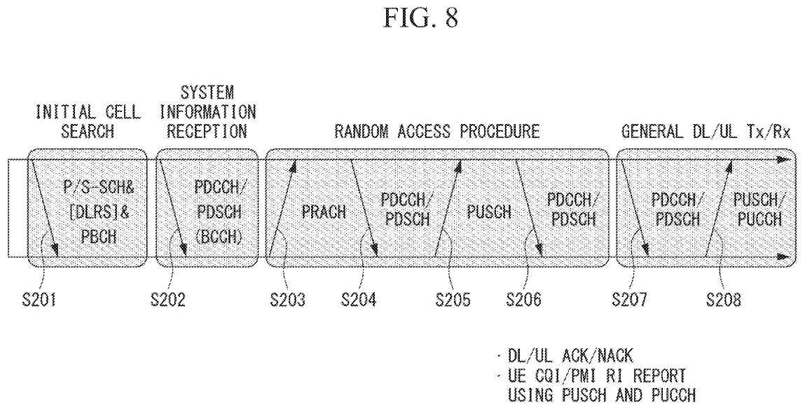

FIG. 8 is a diagram illustrating an example of a 3GPP signal transmission/reception method.

Referring to FIG. 8, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). The initial cell search procedure is described in detail in paragraph F. below.

After initial cell search, the UE can acquire broadcast information in the cell by receiving a physical broadcast channel (PBCH) from the BS. Further, the UE can receive a downlink reference signal (DL RS) in the initial cell search step to check a downlink channel state.

After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed. The random access procedure is described in detail in paragraph G. below.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH

The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH.

The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

F. Initial Access (IA) Process

Synchronization signal block (SSB) transmission and related operation

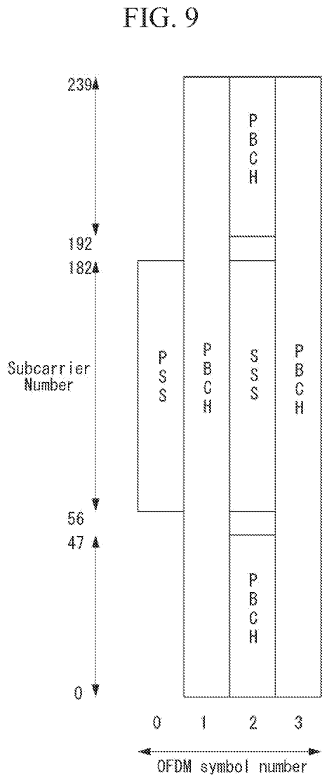

FIG. 9 illustrates an SSB structure. The UE can perform cell search, system information acquisition, beam alignment for initial access, and DL measurement on the basis of an SSB. The SSB is interchangeably used with a synchronization signal/physical broadcast channel (SS/PBCH) bloc.

Referring to FIG. 9, the SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers. The PBCH is encoded/decoded on the basis of a polar code and modulated/demodulated according to quadrature phase shift keying (QPSK). The PBCH in the OFDM symbol includes data resource elements (REs) to which a complex modulation value of a PBCH is mapped and DMRS REs to which a demodulation reference signal (DMRS) for the PBCH is mapped. There are three DMRS REs per resource block of the OFDM symbol, and there are three data REs between the DMRS REs.

Cell Search

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

The cell search procedure of the UE may be summarized as shown in Table 1 below.

TABLE 1

| | Type of | |
|---|---|---|
| | Signals | Operations |
| 1st step | PSS | * SS/PBCH block (SSB) symbol timing |
| | | acquisition |
| | | * Cell ID detection within a cell ID |
| | | group(3 hypothesis) |
| 2nd Step | SSS | * Cell ID group detection (336 hypothesis) |
| 3rd Step | PBCH | * SSB index and Half frame (HF) index |
| | DMRS | (Slot and frame boundary detection) |
| 4th Step | PBCH | * Time information (80 ms, System Frame |
| | | Number (SFN), SSB index, HF) |
| | | * Remaining Minimum System Information |
| | | (RMSI) Control resource set (CORESET)/ |
| | | Search space configuration |
| 5th Step | PDCCH and | * Cell access information |
| | PDSCH | * RACH configuration |

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

FIG. 10 illustrates SSB transmission.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS). An SSB burst set is configured at a start portion of the SSB period. The SSB burst set includes a 5 ms time window (i.e., half-frame), and the SSB may be transmitted up to N times within the SS burst set. The maximum transmission number L of the SSB may be given as follows according to a frequency band of a carrier wave. One slot includes a maximum of two SSBs.
For frequency range up to 3 GHz, L=4
For frequency range from 3 GHz to 6 GHz, L=8
For frequency range from 6 GHz to 52.6 GHz, L=64

A time position of an SSB candidate in the SS burst set may be defined according to a subscriber spacing. The SSB candidate time position is indexed from 0 to L−1 (SSB index) in time order within the SSB burst set (i.e., half-frame).

A plurality of SSBs may be transmitted within a frequency span of a carrier wave. Physical layer cell identifiers of these SSBs need not be unique, and other SSBs may have different physical layer cell identifiers.

The UE may acquire the DL synchronization by detecting the SSB. The UE may identify a structure of the SSB burst set on the basis of the detected SSB (time) index and thus detect a symbol/slot/half-frame boundary. The number of the frame/half-frame to which the detected SSB belongs may be identified using system frame number (SFN) information and half-frame indication information.

Specifically, the UE may acquire a 10-bit SFN for a frame to which the PBCH belongs from the PBCH. Next, the UE may acquire 1-bit half-frame indication information. For example, if the UE detects a PBCH with a half-frame indication bit set to 0, it may determine that the SSB, to which the PBCH belongs, belongs to a first half-frame in the frame, and if the UE detects a PBCH with a half-frame indication bit set to 1, it may determine that the SSB, to which the PBCH belongs, belongs to a second half-frame in the frame. Finally, the UE may acquire an SSB index of the SSB to which the PBCH belongs on the basis of a DMRS sequence and PBCH payload carried by the PBCH.

Acquisition of System Information (SI)

SI is divided into a master information block (MIB) and a plurality of system information blocks (SIBs). The SI other than the MIB may be referred to as remaining minimum system information (RMSI). Details thereof may be referred to the following:
The MIB includes information/parameters for monitoring the PDCCH scheduling PDSCH carrying system information block1 (SIB1) and is transmitted by the BS through the PBCH of the SSB. For example, the UE may check whether a control resource set (CORESET) exists for the Type 0-PDCCH common search space on the basis of the MIB. The Type 0-PDCCH common search space is a kind of PDCCH search space and is used to transmit a PDCCH for scheduling an SI message. If the Type 0-PDCCH common search space is present, the UE may determine (i) a plurality of contiguous resource blocks and one or more consecutive resource blocks constituting a CORESET on the basis of information in the MIB (e.g., pdcch-ConfigSIB1) and (ii) a PDCCH occasion (e.g., time domain position for PDCCH reception). If no Type 0-PDCCH common search space exists, pdcch-ConfigSIB1 provides information on a frequency location where SSB/SIB1 exists and information on a frequency range where SSB/SIB1 does not exist.
SIB1 includes information related to availability and scheduling (e.g., transmission periodicity and SI-window size) of the remaining SIBs (hereinafter, SIBx, x is an integer equal to or greater than 2). For example, SIB1 may indicate whether the SIBx is periodically broadcast or provided according to a request from the UE on an on-demand basis. If SIBx is provided on the on-demand basis, SIB1 may include information necessary for the UE to perform the SI request. The SIB1 is transmitted through the PDSCH, the PDCCH for scheduling the SIB1 is transmitted through the Type 0-PDCCH common search space, and the SIB1 is transmitted through the PDSCH indicated by the PDCCH.
The SIBx is included in the SI message and transmitted via the PDSCH. Each SI message is transmitted within a time window (i.e., SI-window) that occurs periodically.

G. Random Access Procedure

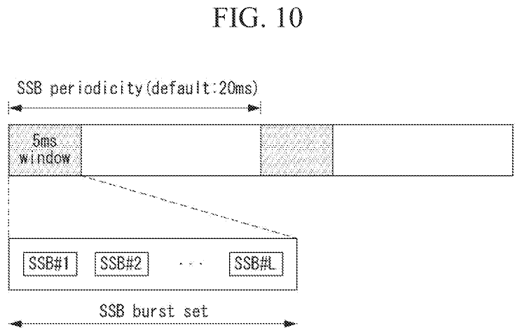

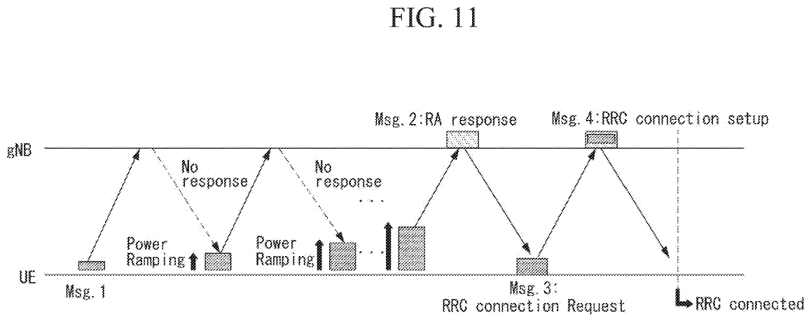

The random access procedure of the UE may be summarized as shown in Table 2 and FIG. 11.

TABLE 2

| | Signal type | Acquired operation/information |
|---|---|---|
| First | PRACH preamble | * Acquire initial beam |
| step | in UL | * Random selection of random access |
| | | preamble ID |
| Second | Random access | * Timing advance information |
| step | response on | * Random access preamble ID |
| | PDSCH | * Initial UL grant, temporary C-RNTI |
| Third | UL transmission | * RRC connection request |
| step | on PUSCH | * UE identifier |
| Fourth | Contention | * Temporary C-RNTI on PDCCH for |
| step | resolution on DL | initial access |
| | | * C-RNTI on PDCCH for |
| | | RRC_CONNECTED UE |

The random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure.

FIG. 11 illustrates an example of a random access procedure. In particular, FIG. 11 illustrates a contention-based random access procedure.

First, a UE can transmit a random access preamble through a PRACH as Msg1 of a random access procedure in UL.

Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

Multiple preamble formats are defined by one or more RACH OFDM symbols and different cyclic prefixes (and/or guard time). RACH configuration for a cell is included in the system information of the cell and is provided to the UE. The RACH configuration includes information on a subcarrier spacing of the PRACH, available preambles, preamble format, and the like. The RACH configuration includes association information between SSBs and RACH (time-frequency) resources. The UE transmits a random access preamble in the RACH time-frequency resource associated with the detected or selected SSB.

A threshold value of the SSB for the RACH resource association may be set by the network, and RACH preamble is transmitted or retransmitted on the basis of the SSB in which reference signal received power (RSRP) measured on the basis of the SSB satisfies the threshold value. For example, the UE may select one of the SSB (s) satisfying the threshold value and may transmit or retransmit the RACH preamble on the basis of the RACH resource associated with the selected SSB.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

When the random access response information includes timing advance information for UL synchronization and an UL grant, and when a temporary UE receives a random response information regarding the UE itself on the PDSCH, the UE may know timing advance information for UL synchronization, an initial UL grant, and a UE temporary cell RNTI (cell RNTI, C-RNTI). The timing advance information is used to control uplink signal transmission timing. In order to ensure that the PUSCH/PUCCH transmission by the UE is better aligned with the subframe timing at a network end, the network (e.g. BS) may measure a time difference between the PUSCH/PUCCH/SRS reception and subframes and send timing advance information on the basis of the time difference. The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

Meanwhile, the contention-free random access procedure may be performed when the UE performs handover to another cell or BS or when the contention-free random access procedure is requested by a BS command A basic process of the contention-free random access procedure is similar to the contention-based random access procedure. However, unlike the contention-based random access procedure in which the UE randomly selects a preamble to be used among a plurality of random access preambles, in the case of the contention-free random access procedure, a preamble (hereinafter referred to as a dedicated random access preamble) to be used by the UE is allocated by the BS to the UE. Information on the dedicated random access preamble may be included in an RRC message (e.g., a handover command) or may be provided to the UE via a PDCCH order. When the random access procedure is started, the UE transmits a dedicated random access preamble to the BS. When the UE receives the random access procedure from the BS, the random access procedure is completed.

As mentioned above, the UL grant in the RAR schedules PUSCH transmission to the UE. The PUSCH carrying initial UL transmission based on the UL grant in the RAR will be referred to as Msg3 PUSCH. The content of the RAR UL grant starts at an MSB and ends at a LSB and is given in Table 3.

TABLE 3

| RAR UL grant field | Number of bits |
|---|---|
| Frequency hopping flag | 1 |
| Msg3 PUSCH frequency resource allocation | 12 |
| Msg3 PUSCH time resource allocation | 4 |
| Modulation and coding scheme (MCS) | 4 |
| Transmit power control (TPC) for Msg3 PUSCH | 3 |
| CSI request | 1 |

The TPC command is used to determine transmission power of the Msg3 PUSCH and is interpreted, for example, according to Table 4.

TABLE 4

| TPC command | value [dB] |
|---|---|
| 0 | −6 |
| 1 | −4 |
| 2 | −2 |
| 3 | 0 |
| 4 | 2 |
| 5 | 4 |
| 6 | 6 |
| 7 | 8 |

In the contention-free random access procedure, the CSI request field in the RAR UL grant indicates whether the UE includes an aperiodic CSI report in the corresponding PUSCH transmission. A subcarrier spacing for the Msg3 PUSCH transmission is provided by an RRC parameter. The UE will transmit the PRACH and Msg3 PUSCH on the same uplink carrier of the same service providing cell. A UL BWP for Msg3 PUSCH transmission is indicated by SIB1 (SystemInformationBlock1).

H. DL and UL Transmitting/Receiving Operations

DL Transmitting/Receiving Operation

A downlink grant (also referred to as a downlink assignment) may be divided into (1) dynamic grant and (2) configured grant. The dynamic grant, which is intended to maximize resource utilization, refers to a method of data transmission/reception on the basis of dynamic scheduling by the BS.

The BS schedules downlink transmission through a DCI. The UE receives on the PDCCH the DCI for downlink scheduling (i.e., including scheduling information of the PDSCH) from the BS. DCI format 1_0 or 1_1 may be used for downlink scheduling. The DCI format 1_1 for downlink scheduling may include, for example, the following information: an identifier for DCI format, a bandwidth part indicator, a frequency domain resource assignment, time domain resource assignment, MCS.

The UE may determine a modulation order, a target code rate, and a transport block size for the PDSCH on the basis of the MCS field in the DCI. The UE may receive the PDSCH in time-frequency resource according to frequency domain resource allocation information and time domain resource allocation information.

The DL grant is also referred to as semi-persistent scheduling (SPS). The UE may receive an RRC message including a resource configuration for transmission of DL data from the BS. In the case of the DL SPS, an actual DL configured grant is provided by the PDCCH and is activated or deactivated by the PDCCH. If the DL SPS is configured, at least the following parameters are provided to the UE via RRC signaling from the BS: a configured scheduling RNTI (CS-RNTI) for activation, deactivation and retransmission; and cycle. The actual DL grant of the DL SPS is provided to the UE by the DCI in the PDCCH addressed to the CS-RNTI. The UE activates an SPS associated with the CS-RNTI if specific fields of the DCI in the PDCCH addressed to the CS-RNTI are set to specific values for scheduling activation. The UE may receive downlink data through the PDSCH on the basis of the SPS.

UL Transmitting/Receiving Operation

The BS transmits a DCI including uplink scheduling information to the UE. The UE receives on the PDCCH the DCI for uplink scheduling (i.e., including scheduling information of the PUSCH) from the BS. DCI format 0_0 or 0_1 may be used for uplink scheduling. The DCI format 0_1 for uplink scheduling may include the following information: an identifier for DCI format, a bandwidth part indicator, a frequency domain resource assignment, a time domain resource assignment, MCS.

The UE transmits uplink data on the PUSCH on the basis of the DCI. For example, when the UE detects the PDCCH including the DCI format 0_0 or 0_1, the UE transmits the PUSCH according to an instruction based on the DCI. Two transmission schemes are supported for PUSCH transmission: codebook-based transmission and non-codebook-based transmission.

When an RRC parameter ‘txConfig’ receives an RRC message set to ‘codebook’, the UE is configured to a codebook-based transmission. Meanwhile, when an RRC message in which the RRC parameter ‘txConfig’ is set to ‘nonCodebook’ is received, the UE is configured to a non-codebook-based transmission. The PUSCH may be semi-statically scheduled by the DCI format 0_0, by the DCI format 0_1, or by RRC signaling.

The uplink grant may be divided into (1) a dynamic grant and (2) a configured grant.

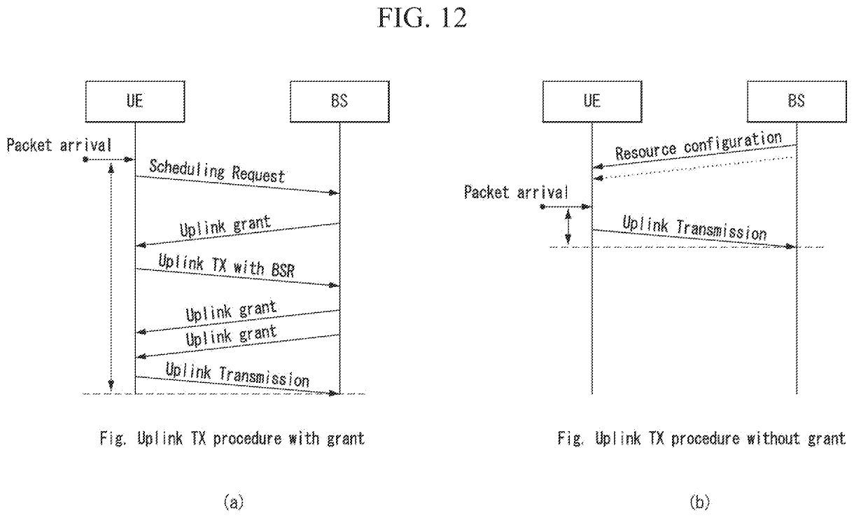

FIG. 12 shows an example of an uplink grant. FIG. 12(a) illustrates an UL transmission process based on the dynamic grant, and FIG. 12(b) illustrates an UL transmission process based on the configured grant.

A dynamic grant, which is to maximize utilization of resources, refers to a data transmission/reception method based on dynamic scheduling by a BS. This means that when the UE has data to be transmitted, the UE requests uplink resource allocation from the BS and transmits the data using only uplink resource allocated by the BS. In order to use the uplink radio resource efficiently, the BS must know how much data each UE transmits on the uplink. Therefore, the UE may directly transmit information on uplink data to be transmitted to the BS, and the BS may allocate uplink resources to the UE on the basis of the information. In this case, the information on the uplink data transmitted from the UE to the BS is referred to as a buffer status report (BSR), and the BSR relates to the amount of uplink data stored in a buffer of the UE.

Referring to FIG. 12(a), an uplink resource allocation process for actual data when the UE does not have an uplink radio resource available for transmission of the BSR is illustrated. For example, since the UE which does not have a UL grant cannot available for UL data transmission cannot transmit the BSR through a PUSCH, the UE must request resource for uplink data must by starting transmission of a scheduling request via a PUCCH, and in this case, an uplink resource allocation process of five steps is used.

Referring to FIG. 12(a), if there is no PUSCH resource for transmitting a BSR, the UE first transmits a scheduling request (SR) to the BS in order to be allocated a PUSCH resource. The SR is used by the UE to request the BS for PUSCH resources for uplink transmission when a reporting event occurs but there is no PUSCH resource available to the UE. Depending on whether there is a valid PUCCH resource for the SR, the UE transmits the SR via the PUCCH or initiates a random access procedure. When the UE receives the UL grant from the BS, it transmits the BSR to the BS via the PUSCH resource allocated by the UL grant. The BS checks the amount of data to be transmitted by the UE on the uplink on the basis of the BSR and transmits a UL grant to the UE. The UE receiving the UL grant transmits actual uplink data to the BS through the PUSCH on the basis of the UL grant.

Referring to FIG. 12(b), the UE receives an RRC message including a resource configuration for transmission of UL data from the BS. There are two types of UL-configured grants in the NR system: Type 1 and Type 2. In the case of UL-configured grant type 1, an actual UL grant (e.g., time resource, frequency resource) is provided by RRC signaling, and in the case of Type 2, an actual UL grant is provided by the PDCCH and is activated or deactivated by the PDCCH. If the grant type 1 is configured, at least the following parameters are provided to the UE via RRC signaling from the BS: CS-RNTI for retransmission; periodicity of the configured grant type 1; information about a start symbol index S and a symbol length L for an intra-slot PUSCH; time domain offset representing an offset of the resource for SFN=0 in the time domain; MCS index indicating modulation order, target code rate, and transport block size. If the grant type 2 is configured, at least the following parameters are provided to the UE via RRC signaling from the BS: CS-RNTI for activation, deactivation and retransmission; periodicity of configured grant type 2. The actual UL grant of the configured grant type 2 is provided to the UE by the DCI in the PDCCH addressed to the CS-RNTI. If the specific fields of the DCI in the PDCCH addressed to the CS-RNTI are set to a specific value for scheduling activation, the UE activates the configured grant type 2 associated with the CS-RNTI.

The UE may perform uplink transmission via the PUSCH on the basis of the configured grant according to the type 1 or type 2.

Resources for initial transmission by the configured grant may or may not be shared by one or more UEs.

FIG. 13 shows an example of a conceptual diagram of uplink physical channel processing.

Each of the blocks shown in FIG. 13 may be performed in each module in the physical layer block of a transmission device. More specifically, the uplink signal processing in FIG. 13 may be performed in the processor of the UE/BS described in this specification. Referring to FIG. 13, the uplink physical channel processing may be performed through scrambling, modulation mapping, layer mapping, transform precoding, precoding, resource element mapping, and SC-FDMA signal generation (SC-FDMA signal generation). Each of the above processes may be performed separately or together in each module of the transmission device. The transform precoding is spreading UL data in a special way to reduce a peak-to-average power ratio (PAPR) of a waveform, and is a kind of discrete Fourier transform (DFT). OFDM using a CP together with the transform precoding that performs DFT spreading is called DFT-s-OFDM, and OFDM using a CP without DFT spreading is called CP-OFDM. Transform precoding may optionally be applied if it is enabled for the UL in an NR system. That is, the NR system supports two options for UL waveforms, one of which is CP-OFDM and the other is DFT-s-OFDM. Whether the UE must use the CP-OFDM as a UL transmit waveform or the DFT-s-OFDM as a UL transmit waveform is provided from the BS to the UE via RRC parameters. FIG. 13 is a conceptual diagram of uplink physical channel processing for DFT-s-OFDM. In the case of CP-OFDM, the transform precoding among the processes of FIG. 13 is omitted.

More specifically, the transmission device scrambles coded bits in a codeword by a scrambling module, and then transmits the coded bits through a physical channel. Here, the codeword is acquired by encoding a transport block. The scrambled bits are modulated by a modulation mapping module into complex-valued modulation symbols. The modulation mapping module may modulate the scrambled bits according to a predetermined modulation scheme and arrange the modulated bits as complex-valued modulation symbols representing a position on a signal constellation. pi/2-BPSK (pi/2-Binary Phase Shift Keying), m-PSK (m-Phase Shift Keying) or m-QAM (m-Quadrature Amplitude Modulation) may be used for modulating the coded data. The complex-valued modulation symbols may be mapped to one or more transport layers by a layer mapping module. The complex-valued modulation symbols on each layer may be precoded by a precoding module for transmission on an antenna port. If the transform precoding is enabled, the precoding module may perform precoding after performing transform precoding on the complex-valued modulation symbols as shown in FIG. 13. The precoding module may process the complex-valued modulation symbols in a MIMO manner according to multiple transmission antennas to output antenna-specific symbols, and distribute the antenna-specific symbols to a corresponding resource element mapping module. An output z of the precoding module may be acquired by multiplying an output y of the layer mapping module by a precoding matrix W of N×M. Here, N is the number of antenna ports and M is the number of layers. The resource element mapping module maps the complex-valued modulation symbols for each antenna port to an appropriate resource element in the resource block allocated for transmission. The resource element mapping module may map the complex-valued modulation symbols to appropriate subcarriers and multiplex the same according to users. The SC-FDMA signal generation module (CP-OFDM signal generation module if the transform precoding is disabled) modulates the complex-valued modulation symbol according to a specific modulation scheme, for example, an OFDM scheme, to generate a complex-valued time domain OFDM (Orthogonal Frequency Division Multiplexing) symbol signal. The signal generation module may perform Inverse Fast Fourier Transform (IFFT) on the antenna specific symbol, and a CP may be inserted into the time domain symbol on which the IFFT has been performed. The OFDM symbol undergoes digital-to-analog conversion, upconverting, and the like, and transmitted to a reception device through each transmission antenna. The signal generation module may include an IFFT module and a CP inserter, a digital-to-analog converter (DAC), and a frequency uplink converter.

A signal processing procedure of a reception device may be the reverse of the signal processing procedure of the transmission device. Details thereof may be referred to the above contents and FIG. 13.

Next, the PUCCH will be described.

The PUCCH supports a plurality of formats, and the PUCCH formats may be classified according to symbol duration, payload size, multiplexing, and the like. Table 5 below illustrates PUCCH formats.

TABLE 5

| | PUCCH length | | | |
|---|---|---|---|---|
| | in OFDM | Number | | |
| Format | symbols | of bits | Usage | Etc. |
| 0 | 1-2 | ≤2 | 1 | Sequence selection |
| 1 | 4-14 | ≤2 | 2 | Sequence modulation |
| 2 | 1-2 | >2 | 4 | CP-OFDM |
| 3 | 4-14 | >2 | 8 | DFT-s-OFDM(no UE |
| | | | | multiplexing) |
| 4 | 4-14 | >2 | 16 | DFT-s-OFDM(Pre |
| | | | | DFT orthogonal |
| | | | | cover code(OCC)) |

The PUCCH formats shown in Table 5 may be divided into (1) a short PUCCH and (2) a long PUCCH. PUCCH formats 0 and 2 may be included in the short PUCCH, and PUCCH formats 1, 3 and 4 may be included in the long PUCCH.

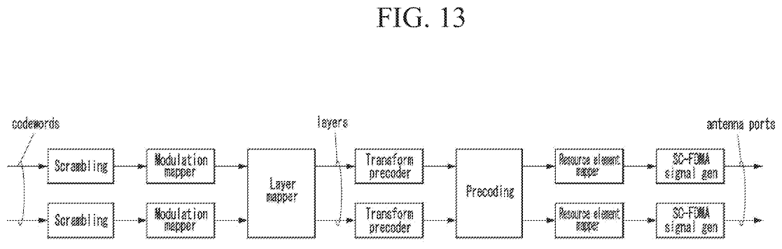

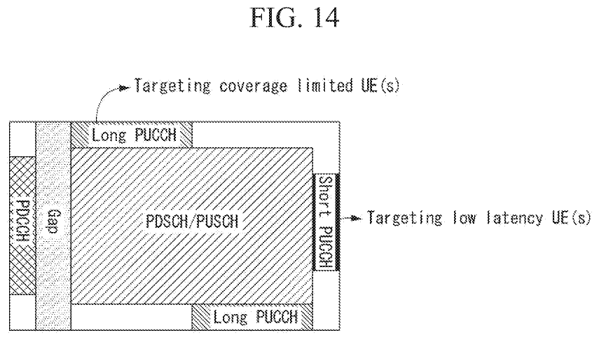

FIG. 14 shows an example of an NR slot in which a PUCCH is transmitted.

The UE transmits one or two PUCCHs through serving cells in different symbols in one slot. When the UE transmits two PUCCHs in one slot, at least one of the two PUCCHs has a structure of the short PUCCH.

I. eMBB (Enhanced Mobile Broadband Communication)

In the case of the NR system, a massive multiple input multiple output (MIMO) environment in which the transmit/receive antennas are significantly increased may be considered. That is, as the large MIMO environment is considered, the number of transmit/receive antennas may increase to several tens or hundreds or more. Meanwhile, the NR system supports communication in above 6 GHz band, that is, the millimeter frequency band. However, the millimeter frequency band has a frequency characteristic in which signal attenuation according to a distance is very sharp due to the use of a frequency band which is too high. Therefore, an NR system using the band of 6 GHz or higher uses a beamforming technique in which energy is collected and transmitted in a specific direction, not in all directions, in order to compensate for sudden propagation attenuation characteristics. In the massive MIMO environment, a hybrid type beamforming technique combining an analog beamforming technique and a digital beamforming technique is required depending on a position to which a beamforming weight vector/precoding vector is applied, to reduce complexity of hardware implementation, increase performance using multiple antennas, obtain flexibility of resource allocation, and facilitate beam control for each frequency.

Hybrid Beamforming

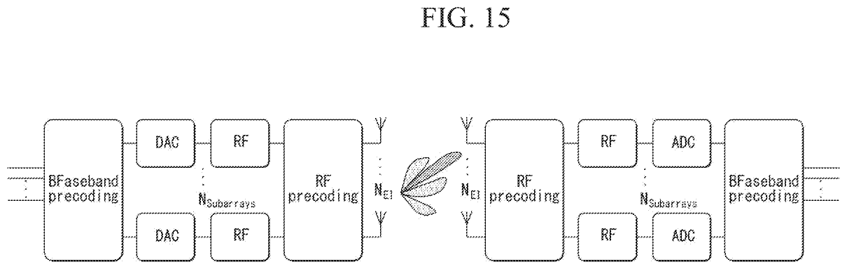

FIG. 15 illustrates an example of a block diagram of a transmitter and a receiver for hybrid beamforming.

As a method for forming a narrow beam in a millimeter frequency band, a beam forming scheme in which energy is increased only in a specific direction by transmitting the same signal using a phase difference suitable for a large number of antennas in a BS or a UE is mainly considered. Such beamforming scheme includes digital beamforming to create a phase difference in a digital baseband signal, analog beamforming to create a phase difference in a modulated analog signal using time delay (i.e., cyclic shift), and hybrid beamforming using both digital beamforming and analog beamforming, or the like. If each antenna element has an RF unit (or transceiver unit (TXRU)) to adjust transmission power and phase, independent beamforming is possible for each frequency resource. However, it is not effective in terms of price to install an RF unit in all 100 antenna elements. That is, since the millimeter frequency band requires a large number of antennas to compensate for the sudden attenuation characteristics and digital beamforming requires an RF component (e.g., a digital-to-analog converter (DAC), a mixer, a power amplifier, a linear amplifier, and the like), implementation of digital beamforming in the millimeter frequency band causes the price of the communication device to increase. Therefore, when a large number of antennas are required such as in the millimeter frequency band, the use of analog beamforming or hybrid beamforming is considered. In the analog beamforming scheme, a plurality of antenna elements are mapped to one TXRU and a direction of a beam is adjusted by an analog phase shifter. Such an analog beamforming scheme may generate only one beam direction in the entire band, and thus, it cannot perform frequency selective beamforming (BF). Hybrid BF is an intermediate form of digital BF and analog BF and has B RF units fewer than Q antenna elements. In the case of the hybrid BF, directions of beams that may be transmitted at the same time is limited to B or less, although there is a difference depending on a method of connecting the B RF units and Q antenna elements.

Beam Management (BM)

The BM process includes processes for acquiring and maintaining a set of BS (or a transmission and reception point (TRP)) and/or UE beams that may be used for downlink (DL) and uplink (UL) transmission/reception and may include the following processes and terms.
beam measurement: operation for BS or UE to measure characteristic of received beamforming signal.
beam determination: operation for BS or UE to select its own Tx beam/Rx beam.
beam sweeping: an operation to cover spatial domain using transmission and/or reception beam during a predetermined time interval in a predetermined manner.
beam report: an operation for UE to report information of beamformed signal on the basis of beam measurement.

The BM process may be classified into (1) DL BM process using SSB or CSI-RS and (2) UL BM process using SRS (sounding reference signal). Also, each BM process may include Tx beam sweeping to determine Tx beam and Rx beam sweeping to determine Rx beam.

DL BM process

The DL BM process may include (1) transmission of beamformed DL RSs (e.g., CSI-RS or SSB) by the BS, and (2) beam reporting by the UE.

Here, the beam report may include a preferred DL RS ID(s) and a corresponding reference signal received power (RSRP). The DL RS ID may be an SSBRI (SSB Resource Indicator) or a CRI (CSI-RS Resource Indicator).

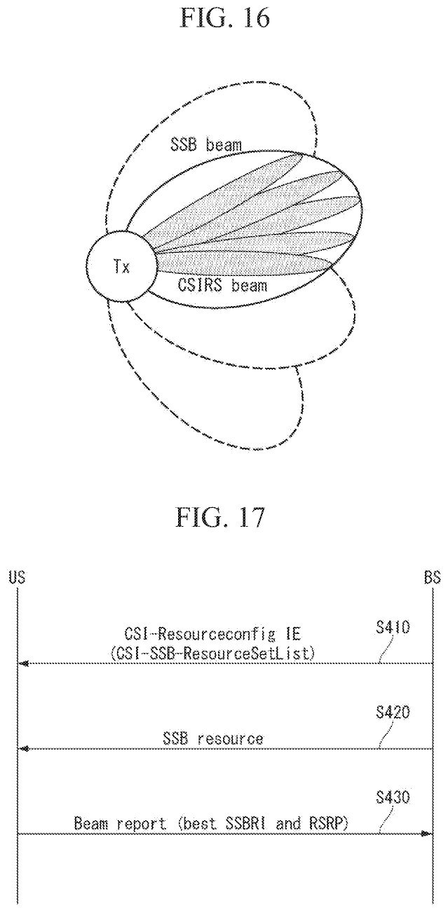

FIG. 16 shows an example of beamforming using SSB and CSI-RS.

As shown in FIG. 16, the SSB beam and the CSI-RS beam may be used for beam measurement. The measurement metric is an RSRP per resource/block. The SSB may be used for coarse beam measurement, and the CSI-RS may be used for fine beam measurement. SSB may be used for both Tx beam sweeping and Rx beam sweeping. Rx beam sweeping using the SSB may be performed by attempting to receive the SSB while the UE changes the Rx beam for the same SSBRI across multiple SSB bursts. Here, one SS burst may include one or more SSBs, and one SS burst set includes one or more SSB bursts.

1. DL BM Using SSB

FIG. 17 is a flowchart illustrating an example of a DL BM process using SSB.

A configuration for beam report using the SSB is performed at the time of channel state information (CSI)/beam configuration in RRC_CONNECTED.
The UE receives from the BS a CSI-ResourceConfig IE including a CSI-SSB-ResourceSetList for the SSB resources used for the BM (S410). The RRC parameter csi-SSB-ResourceSetList represents a list of SSB resources used for beam management and reporting in one resource set. Here, the SSB resource set may be configured to {SSBx1, SSBx2, SSBx3, SSBx4}. The SSB index may be defined from 0 to 63.
The UE receives signals on the SSB resources from the BS on the basis of the CSI-SSB-ResourceSetList (S420).
If the CSI-RS reportConfig associated with reporting on the SSBRI and reference signal received power (RSRP) is configured, the UE reports the best SSBRI and its corresponding RSRP to the BS S430). For example, if the reportQuantity of the CSI-RS reportConfig IE is set to ‘ssb-Index-RSRP’, the UE reports the best SSBRI and a corresponding RSRP to the BS.

When the CSI-RS resource is configured in the same OFDM symbol (s) as the SSB and ‘QCL-Type D’ is applicable, the UE may assume that the CSI-RS and the SSB are quasi co-located (QCL-ed) in terms of ‘QCL-TypeD’. Here, QCL-TypeD may refer to QCL-ed between antenna ports in terms of spatial Rx parameter. The same receive beam may be applied when the UE receives signals of a plurality of DL antenna ports in the QCL-TypeD relationship. Details of QCL may refer to a section 4. QCL below.

2. DL BM Using CSI-RS

Referring to the use of CSI-RS, i) if a repetition parameter is set for a specific CSI-RS resource set and TRS_info is not configured, CSI-RS is used for beam management. ii) If the repetition parameter is not set and TRS_info is set, the CSI-RS is used for a tracking reference signal (TRS). Iii) If the repetition parameter is not set and TRS_info is not set, the CSI-RS is used for CSI acquisition.

(RRC Parameter) If the repetition is set to ‘ON’, it relates to a Rx beam sweeping process of the UE. If the repetition is set to ‘ON’, the UE may assume that if NZP-CSI-RS-ResourceSet is configured, signals of at least one CSI-RS resource in the NZP-CSI-RS-ResourceSet are transmitted in the same downlink space domain filter. That is, at least one CSI-RS resource in the NZP-CSI-RS-ResourceSet is transmitted through the same Tx beam. Here, signals of at least one CSI-RS resource in the NZP-CSI-RS-ResourceSet may be transmitted in different OFDM symbols.

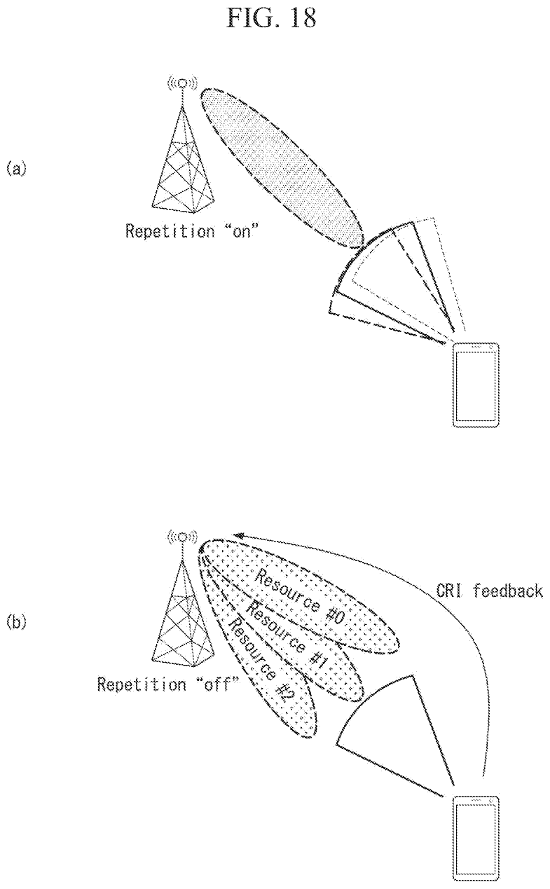

Meanwhile, if the repetition is set to ‘OFF’, it relates to a Tx beam sweeping process of the BS. If the repetition is set to ‘OFF’, the UE does not assume that signals of at least one CSI-RS resource in the NZP-CSI-RS-ResourceSet are transmitted in the same downlink spatial domain transmission filter. That is, the signals of at least one CSI-RS resource in the NZP-CSI-RS-ResourceSet are transmitted through different Tx beams. FIG. 18 shows another example of the DL BM process using CSI-RS.

FIG. 18(a) shows a process of Rx beam determination (or refinement) of the UE, and FIG. 18(b) shows a Tx beam sweeping process of the BS. FIG. 18 (a) shows a case where the repetition parameter is set to ‘ON’, and FIG. 18(b) shows a case where the repetition parameter is set to ‘OFF’.

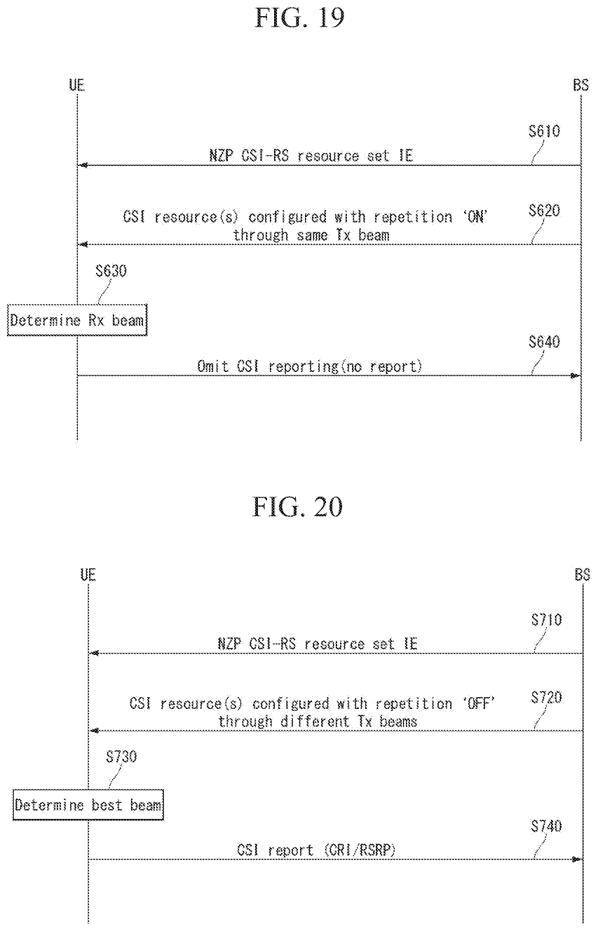

A process of determining the Rx beam of the UE will be described with reference to FIGS. 18(a) and 19.

FIG. 19 is a flowchart illustrating an example of a process of determining a reception beam of a UE.
The UE receives an NZP CSI-RS resource set IE including the RRC parameter regarding ‘repetition’ from the BS through RRC signaling (S610). Here, the RRC parameter ‘repetition’ is set to ‘ON’.
The UE repeatedly receives signals on the resource(s) in the CSI-RS resource in which the RRC parameter ‘repetition’ is set to ‘ON’ in different OFDM (s) through the same Tx beam (or DL space domain transmission filter) of the BS (S620).
The UE determines its own Rx beam (S630).
The UE omits the CSI reporting (S640). That is, the UE may omit CSI reporting when the uplink RRC parameter ‘repetition’ is set to ‘ON’.

A Tx beam determining process of the BS will be described with reference to FIGS. 18(b) and 20.

FIG. 20 is a flowchart illustrating an example of a transmission beam determining process of the BS.
The UE receives an NZP CSI-RS resource set IE including an RRC parameter regarding ‘repetition’ from the BS through RRC signaling (S710). Here, the RRC parameter ‘repetition’ is set to ‘OFF’ and is related to the Tx beam sweeping process of the BS.
The UE receives signals on the resources in the CSI-RS resource in which the RRC parameter ‘repetition’ is set to ‘OFF’ through different Tx beams (DL spatial domain transmission filters) of the BS (S720).
The UE selects (or determines) the best beam (S730)
The UE reports an ID (e.g., CRI) for the selected beam and related quality information (e.g., RSRP) to the BS (S740). That is, the UE reports the CRI and the RSRP to the BS when the CSI-RS is transmitted for the BM.

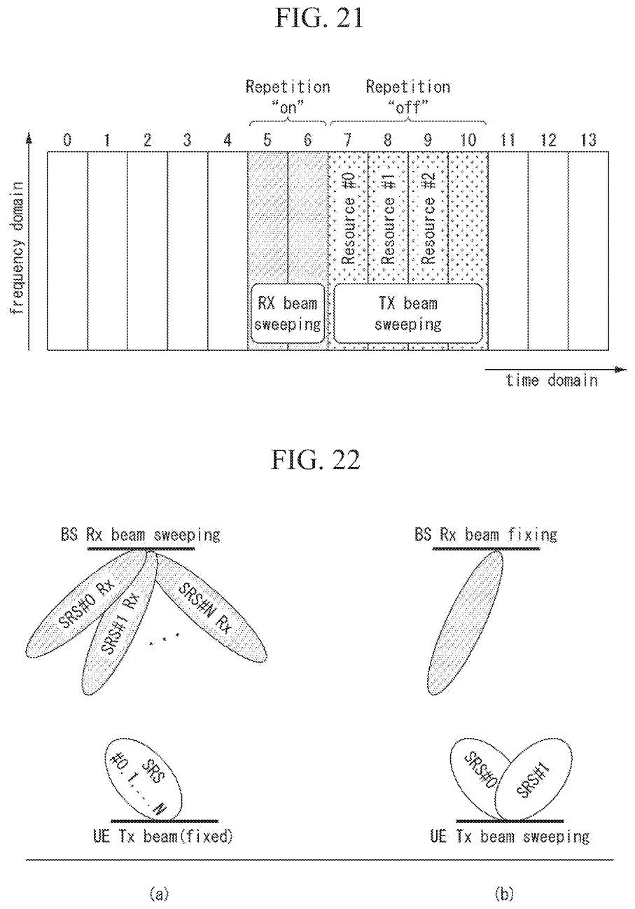

FIG. 21 shows an example of resource allocation in time and frequency domains related to the operation of FIG. 18.

When repetition ‘ON’ is set in the CSI-RS resource set, a plurality of CSI-RS resources are repeatedly used by applying the same transmission beam, and when repetition ‘OFF’ is set in the CSI-RS resource set, different CSI-RS resources may be transmitted in different transmission beams.

3. DL BM-Related Beam Indication

The UE may receive a list of up to M candidate transmission configuration indication (TCI) states for at least a quasi co-location (QCL) indication via RRC signaling. Here, M depends on UE capability and may be 64.

Each TCI state may be configured with one reference signal (RS) set. Table 6 shows an example of a TCI-State IE. The TCI-State IE is associated with a quasi co-location (QCL) type corresponding to one or two DL reference signals (RSs).

TABLE 6

| -- ASN1START | |
|---|---|
| -- TAG-TCI-STATE-START | |
| TCI-State ::= | SEQUENCE { |

| | |
|---|---|
| tci-StateId | TCI-StateId, |
| qcl-Type1 | QCL-Info, |
| qcl-Type2 | QCL-Info |

OPTIONAL, -- Need R

...

| } | |
|---|---|
| QCL-Info ::= | SEQUENCE { |

cell
ServCellIndex

OPTIONAL, -- Need R

| | |
|---|---|
| bwp-Id | BWP-Id |

OPTIONAL, -- Cond CSI-RS-

Indicated

| | |
|---|---|
| referenceSignal | CHOICE { |

csi-rs

NZP-CSI-RS-ResourceId,

ssb

| SSB-Index | |
|---|---|
| }, | |
| qcl-Type | ENUMERATED |

{typeA, typeB, typeC, typeD},

...

}
-- TAG-TCI-STATE-STOP
-- ASN1STOP

In Table 6, ‘bwp-Id’ denotes a DL BWP where RS is located, ‘cell’ denotes a carrier where RS is located, ‘referencesignal’ denotes a reference antenna port(s) which is a QCL-ed source for target antenna port(s) or a reference signal including the same. The target antenna port(s) may be CSI-RS, PDCCH DMRS, or PDSCH DMRS.

4. QCL (Quasi-Co Location)

The UE may receive a list including up to M TCI-state configurations to decode the PDSCH according to the detected PDCCH having an intended DCI for the UE and a given cell. Here, M depends on the UE capability.

As illustrated in Table 6, each TCI-State includes a parameter for establishing a QCL relationship between one or two DL RSs and the DM-RS port of the PDSCH. The QCL relationship is configured with a RRC parameter qcl-Type1 for the first DL RS and a qcl-Type2 (if set) for the second DL RS.

The QCL type corresponding to each DL RS is given by the parameter ‘qcl-Type’ in QCL-Info and may have one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, corresponding NZP CSI-RS antenna ports may be instructed/configured to be QCL-ed with a specific TRS in terms of QCL-Type A and QCL-ed with a specific SSB in terms of QCL-Type D. The thusly instructed/configured UE may receive the corresponding NZP CSI-RS using a Doppler and delay value measured by the QCL-TypeA TRS and apply a reception beam used for receiving the QCL-TypeD SSB to the corresponding NZP CSI-RS reception.

UL BM Process

In the UL BM, a Tx beam-Rx beam reciprocity (or beam correspondence) may be or may not be established depending on UE implementation. If the Tx beam-Rx beam reciprocity is established in both the BS and the UE, a UL beam pair may be matched through a DL beam pair. However, if the Tx beam-Rx beam reciprocity is not established in either the BS or the UE, a UL beam pair determining process is required, apart from DL beam pair determination.

In addition, even when the BS and the UE maintain beam correspondence, the BS may use the UL BM process for DL Tx beam determination without requesting the UE to report a preferred beam.

The UL BM may be performed through beamformed UL SRS transmission and whether to apply the UL BM of the SRS resource set is configured by the RRC parameter in a (RRC parameter) usage. If the usage is configured as ‘BeamManagement (BM)’, only one SRS resource may be transmitted for each of a plurality of SRS resource sets at a given time instant.

The UE may be configured with one or more sounding reference signal (SRS) resource sets (through RRC signaling, etc.) set by the (RRC parameter) SRS-ResourceSet. For each SRS resource set, K≥1 SRS resources may be set for the UE. Here, K is a natural number, and a maximum value of K is indicated by SRS_capability.

Like the DL BM, the UL BM process may also be divided into Tx beam sweeping of the UE and Rx beam sweeping of the BS.

FIG. 22 shows an example of a UL BM process using SRS.

FIG. 22(a) shows a process of determining Rx beamforming of a BS, and FIG. 22(b) shows a process of sweeping Tx beam of the UE.

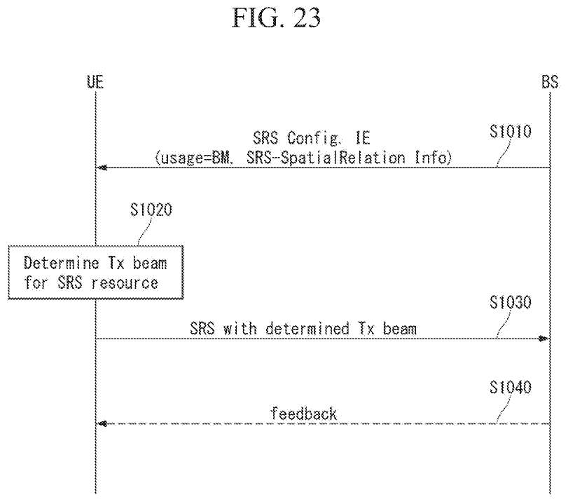

FIG. 23 is a flowchart illustrating an example of a UL BM process using SRS.
The UE receives RRC signaling (e.g., SRS-Config IE) including an (RRC parameter) usage parameter set to ‘beam management’ from the BS (S1010). An SRS-Config IE is used for configuration of SRS transmission. The SRS-Config IE includes a list of SRS-Resources and a list of SRS-ResourceSets. Each SRS resource set refers to a set of SRS-resources.
The UE determines Tx beamforming for the SRS resource to be transmitted on the basis of SRS-SpatialRelation Info included in the SRS-Config IE (S1020). Here, the SRS-SpatialRelation Info is configured for each SRS resource and indicates whether to apply the same beamforming as that used in SSB, CSI-RS, or SRS for each SRS resource.
If SRS-SpatialRelationInfo is configured in the SRS resource, the same beamforming as that used in SSB, CSI-RS, or SRS is applied and transmitted. However, if SRS-SpatialRelationInfo is not configured in the SRS resource, the UE randomly determines the Tx beamforming and transmits the SRS through the determined Tx beamforming (S1030).

More specifically, regarding P-SRS in which ‘SRS-ResourceConfigType’ is set to ‘periodic’:

i) If the SRS-SpatialRelationInfo is set to ‘SSB/PBCH’, the UE transmits the corresponding SRS by applying the same spatial domain transmission filter (or generated from the corresponding filter) as the spatial domain Rx filter used for receiving SSB/PBCH; or

ii) If the SRS-SpatialRelationInfo is set to ‘CSI-RS’, the UE transmits the SRS by applying the same spatial domain transmission filter used for receiving the CSI-RS; or

iii) When SRS-SpatialRelationInfo is set to ‘SRS’, the UE transmits the corresponding SRS by applying the same spatial domain transmission filter used for transmitting the SRS.
In addition, the UE may receive or may not receive a feedback on the SRS from the BS as in the following three cases (S1040).

i) When Spatial_Relation_Info is set for all SRS resources in the SRS resource set, the UE transmits the SRS to the beam indicated by the BS. For example, if Spatial_Relation_Info indicates SSB, CRI, or SRI in which Spatial_Relation_Info is the same, the UE repeatedly transmits the SRS on the same beam.

ii) Spatial_Relation_Info may not be set for all SRS resources in the SRS resource set. In this case, the UE may freely transmit while changing the SRS beamforming.

iii) Spatial_Relation_Info may only be set for some SRS resources in the SRS resource set. In this case, the SRS is transmitted on the indicated beam for the set SRS resource, and for an SRS resource in which Spatial_Relation_Info is not set, the UE may transit the SRS resource by randomly applying Tx beamforming.

A Beam Failure Recovery (BFR) Process

In a beamformed system, a radio link failure (RLF) may occur frequently due to rotation, movement, or beamforming blockage of the UE. Therefore, BFR is supported in NR to prevent frequent occurrence of the RLFs. The BFR is similar to the radio link failure recovery process and may be supported if the UE knows the new candidate beam(s).

For beam failure detection, the BS configures beam failure detection reference signals for the UE, and if the number of times of beam failure indications from the physical layer of the UE reaches a threshold set by the RRC signaling within a period set by the RRC signaling of the BS, the UE declares beam failure.

After the beam failure is detected, the UE triggers a beam failure recovery by initiating a random access procedure on the PCell; and performs beam failure recovery by selecting a suitable beam (If the BS provides dedicated random access resources for certain beams, they are prioritized by the UE). Upon completion of the random access procedure, beam failure recovery is considered to be completed.

J. URLLC (Ultra-Reliable and Low Latency Communication)

The URLLC transmission defined by the NR may refer to transmission for (1) a relatively low traffic size, (2) a relatively low arrival rate, (3) an extremely low latency requirement (e.g., 0.5, 1 ms), (4) relatively short transmission duration (e.g., 2 OFDM symbols), and (5) urgent service/message, etc.

In the case of UL, transmission for a particular type of traffic (e.g., URLLC) needs to be multiplexed with other previously scheduled transmissions (e.g., eMBB) to meet a more stringent latency requirement. In this regard, one method is to give information indicating that a scheduled UE will be preempted for a specific resource, and allow the URLLC UE to use the resource for UL transmission.

Pre-Emption Indication

In the case of NR, dynamic resource sharing between eMBB and URLLC is supported. eMBB and URLLC services may be scheduled on non-overlapping time/frequency resources and URLLC transmission may occur on scheduled resources for ongoing eMBB traffic. The eMBB UE may not know whether PDSCH transmission of the UE is partially punctured and the UE may not be able to decode the PDSCH due to corrupted coded bits. In consideration of this, NR provides a preemption indication.

The preemption indication may also be referred to as an interrupted transmission indication.

With respect to the preamble indication, the UE receives DownlinkPreemption IE through RRC signaling from the BS. Table 7 below shows an example of the DownlinkPreemption IE.

TABLE 7
-- ASN1START
-- TAG-DOWNLINKPREEMPTION-START

| | |
|---|---|
| DownlinkPreemption ::= | SEQUENCE { |

| | |
|---|---|
| int-RNTI | RNTI-Value, |

| | |
|---|---|
| timeFrequencySet | ENUMERATED {set0, set1}, |
| dci-PayloadSize | INTEGER (0..maxINT-DCI-PayloadSize), |

| | |
|---|---|
| int-ConfigurationPerServingCell | SEQUENCE (SIZE (1..maxNrofServingCells)) |

OF INT-ConfigurationPerServingCell,
...
}
INT-ConfigurationPerServingCell ::= SEQUENCE {

| | |
|---|---|
| servingCellId | ServCellIndex, |
| positionInDCI | INTEGER (0..maxINT-DCI-PayloadSize−1) |

}
-- TAG-DOWNLINKPREEMPTION-STOP
-- ASN1STOP

If the UE is provided with the DownlinkPreemption IE, the UE is configured with an INT-RNTI provided by a parameter int-RNTI in the DownlinkPreemption IE to monitor a PDCCH conveying the DCI format 2_1. The UE is further configured with a set of serving cells and a corresponding set of locations for fields in the DCI format 2_1 by positionInDCI by an INT-ConfigurationPerServing Cell including a set of serving cell indices provided by a servingCellID, is configured with an information payload size for DCI format 2_1 by dci-PayloadSize, and is configured with granularity of time-frequency resources by timeFrequencySect.

The UE receives the DCI format 2_1 from the BS on the basis of the DownlinkPreemption IE.

If the UE detects the DCI format 2_1 for a serving cell in the set of serving cells, the UE may assume there is no transmission to the UE in PRBs and symbols indicated by the DCI format 2_1 among sets of PRBs and sets of symbols in the last monitoring period before a monitoring period to which the DCI format 2_1 belongs. For example, referring to FIG. 9A, the UE determines that a signal in the time-frequency resource indicated by pre-emption is not a DL transmission scheduled for the UE itself and decodes data on the basis of signals received in the remaining resource area.

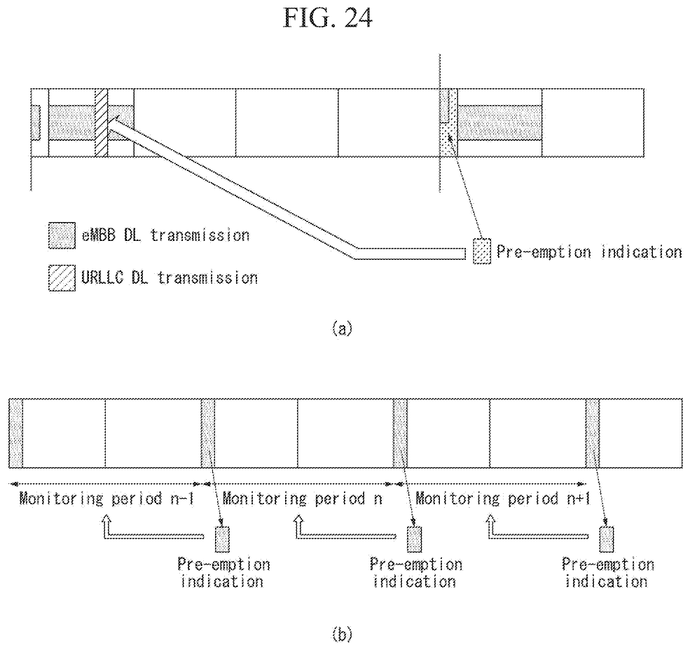

FIG. 24 is a diagram showing an example of an preemption indication method.

A combination of {M,N} is set by the RRC parameter timeFrequencySet. {M, N}={14,1}, {7,2}.

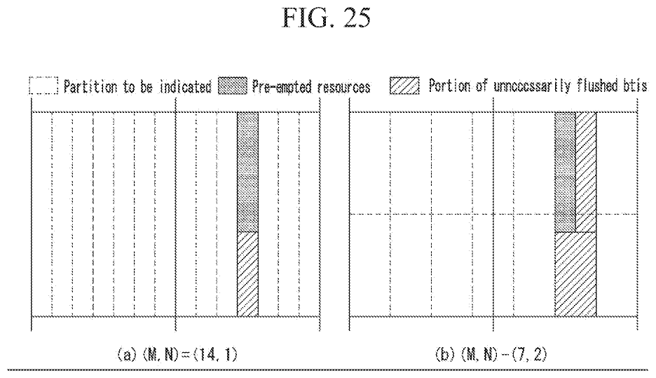

FIG. 25 shows an example of a time/frequency set of a preemption indication.

A 14-bit bitmap for a preemption indication indicates one or more frequency parts (N>=1) and/or one or more time domain parts (M>=1). In the case of {M, N}={14,1}, as shown in FIG. 25(a), 14 parts in the time domain correspond one-to-one to 14 bits of the 14-bit bit map, and a part corresponding to a bit set to 1, among the 14 bits, is part including pre-empted resources. In the case of {M, N}={7,2}, as shown in FIG. 25(b), the time-frequency resources of the monitoring period is divided into seven parts in the time domain and two parts in the frequency domain, so as to be divided into a total of 14 time-frequency parts. The total of 14 time-frequency parts correspond one-to-one to the 14 bits of the 14-bit bitmap, and the part corresponding to the bit set to 1 among the 14 bits includes the pre-empted resources.

K. MMTC (Massive MTC)

The massive machine type communication (mMTC) is one of the 5G scenarios for supporting a hyper-connection service that simultaneously communicates with a large number of UEs. In this environment, the UE intermittently performs communication with a very low transfer rate and mobility. Therefore, mMTC is aimed at how low cost and for how long the UE can be driven. In this regard, MTC and NB-IoT, which are dealt with in 3GPP will be described.

Hereinafter, a case where a transmission time interval of a physical channel is a subframe will be described as an example. For example, a case where a minimum time interval from a start of transmission of one physical channel (e.g., MPDCCH, PDSCH, PUCCH, PUSCH) to a start of transmission of a next physical channel is one subframe will be described as an example. In the following description, the subframe may be replaced by a slot, a mini-slot, or multiple slots.

MTC (Machine Type Communication)

MTC (Machine Type Communication), which is an application that does not require much throughput applicable to M2M (Machine-to-Machine) or IoT (Internet-of-Things), refers to a communication technology adopted to meet the requirements of the IoT service in 3GPP (3rd Generation Partnership Project).

The MTC may be implemented to meet the criteria of (1) low cost & low complexity, (2) enhanced coverage, and (3) low power consumption.

In 3GPP, MTC has been applied since release 10 (3GPP standard document version 10.x.x.) and features of MTC added for each release of 3GPP will be briefly described.

First, the MTC described in 3GPP Release 10 and Release 11 relates to a load control method. The load control method is to prevent IoT (or M2M) devices from suddenly loading the BS. More specifically, 3GPP Release 10 relates to a method of controlling a load by disconnecting IoT devices when the load occurs, and Release 11 relates to a method of preventing connection of the UE in advance by informing the UE about connection to a cell later through system information of the cell. In Release 12, features for low cost MTC are added, for which UE category 0 is newly defined. The UE category is an indicator indicating how much data the UE may handle at a communication modem. A UE in UE category 0 is a UE with a reduced peak data rate and relaxed radio frequency (RF) requirements, thus reducing baseband and RF complexity. In Release 13, a technology called eMTC (enhanced MTC) was introduced, which allows the UE to operate only at 1.08 MHz, a minimum frequency bandwidth supported by legacy LTE, thereby lowering the price and power consumption of the UE.

The contents described hereinafter is features mainly related to eMTC but may also be equally applicable to the MTC, eMTC, 5G (or NR) unless otherwise mentioned. Hereinafter, for convenience of explanation, MTC will be collectively described.

Therefore, the MTC described below may referred to as the enhanced MTC (eMTC), the LTE-M1/M2, BL (bandwidth reduced low complexity/CE (coverage enhanced), non-BL UE (in enhanced coverage), NR MTC, enhanced BL/CE, and the like. That is, the term MTC may be replaced with terms to be defined in the 3GPP standard in the future.

MTC General Features

(1) MTC operates only within a specific system bandwidth (or channel bandwidth).

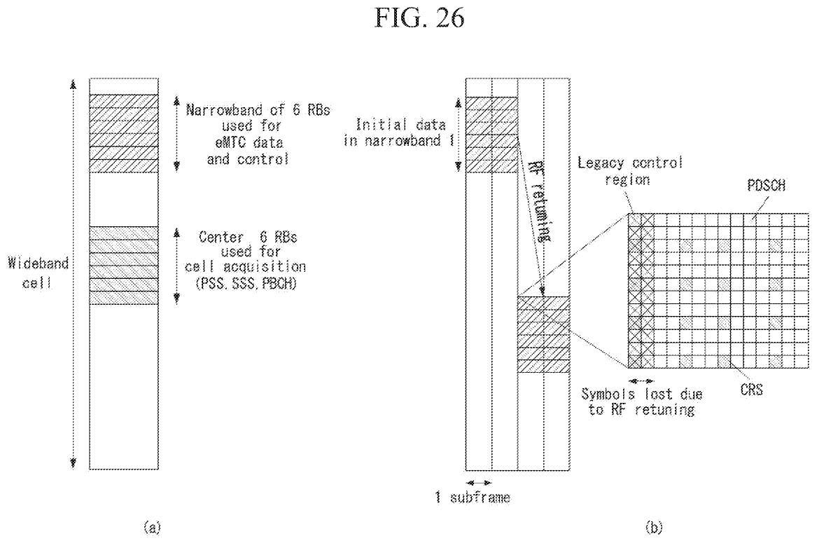

MTC may use six resource blocks (RBs) in the system band of the legacy LTE as shown in FIG. 26 or use a specific number of RBs in the system band of the NR system. The frequency bandwidth in which the MTC operates may be defined in consideration of a frequency range of NR and subcarrier spacing. Hereinafter, a specific system or frequency bandwidth in which the MTC operates is referred to as an MTC narrowband (NB). In the NR, the MTC may operate in at least one bandwidth part (BWP) or in a specific band of BWP.

MTC follows a narrowband operation to transmit and receive physical channels and signals, and a maximum channel bandwidth in which the MTC UE is operable is reduced to 1.08 MHz or six (LTE) RBs.

The narrowband may be used as a reference unit in resource allocation units of some downlink and uplink channels, and a physical location of each narrowband in the frequency domain may be defined to be different depending on the system bandwidth.

The bandwidth of 1.08 MHz defined in MTC is defined for the MTC UE to follow the same cell search and random access procedure as the legacy UE.

MTC may be supported by cells having a bandwidth (e.g., 10 MHz) much larger than 1.08 MHz but the physical channels and signals transmitted and received by the MTC are always limited to 1.08 MHz. The system with having much larger bandwidth may be legacy LTE, NR systems, 5G systems, and the like.

A narrowband is defined as six non-overlapping consecutive physical resource blocks in the frequency domain.

FIG. 26(a) is a diagram showing an example of a narrowband operation, and FIG. 26(b) is a diagram showing an example of repetition having RF retuning.

Frequency diversity by RF retuning will be described with reference to FIG. 26(b).

Due to narrowband RF, single antenna and limited mobility, the MTC supports limited frequency, space and time diversity. In order to reduce fading and outage, frequency hopping is supported by MTC between different narrow bands by RF retuning.

In MTC, frequency hopping is applied to different uplink and downlink physical channels when repetition is possible. For example, if 32 subframes are used for PDSCH transmission, first 16 subframes may be transmitted on a first narrowband. Here, the RF front end is retuned to another narrow band, and the remaining 16 subframes are transmitted on the second narrow band.

The narrowband of MTC may be set to the UE via system information or DCI (downlink control information) transmitted by the BS.

(2) The MTC operates in a half duplex mode and uses a limited (or reduced) maximum transmit power. The half duplex mode refers to a mode in which a communication device operates only in an uplink or a downlink at one frequency at one time point and operates in a downlink or an uplink at another frequency at another time point. For example, when the communication device operates in the half-duplex mode, the communication device performs communication using the uplink frequency and the downlink frequency, and the communication device may not use the uplink frequency and the downlink frequency at the same time. The communication device divides time to perform uplink transmission through the uplink frequency and the downlink reception by re-tuning to the downlink frequency for another predetermined time.

(3) MTC does not use channels (defined in legacy LTE or NR) that must be distributed over the entire system bandwidth of the legacy LTE or NR. For example, in the MTC, the PDCCH of the legacy LTE is not used because the PDCCH is distributed over the entire system bandwidth. Instead, a new control channel, MPDCCH (MTC PDCCH), is defined in the MTC. The MPDCCH is transmitted/received within a maximum of 6 RBs in the frequency domain.

(4) MTC uses the newly defined DCI format. For example, DCI formats 6-0A, 6-0B, 6-1A, 6-1B, 6-2, etc., may be used as a DCI format for MTC (see 3GPP TS 36.212).

(5) In the case of MTC, a physical broadcast channel (PBCH), a physical random access channel (PRACH), an MTC physical downlink control channel (M-PDCCH), a physical downlink shared channel (PDSCH), a physical uplink control channel (PUCCH), and a physical uplink shared channel (PUSCH) may be repeatedly transmitted. Due to the MTC repeated transmission, an MTC channel may be decoded even when signal quality or power is very poor, such as in an inadequate environment such as a basement, thereby increasing a cell radius and increasing a penetration effect.

(6) In MTC, PDSCH transmission based on PDSCH scheduling (DCI) and PDSCH scheduling may occur in different subframes (cross-subframe scheduling).

(7) In the LTE system, the PDSCH carrying a general SIB1 is scheduled by the PDCCH, whereas all the resource allocation information (e.g., subframe, transport block size, narrowband index) for SIB1 decoding is determined by a parameter of the MIB and no control channel is used for SIB1 decoding of the MTC.

(8) All resource allocation information (subframe, TBS, subband index) for SIB2 decoding is determined by several SIB1 parameters and no control channel for SIB2 decoding of MTC is used.

(9) The MTC supports an extended paging (DRX) cycle. Here, the paging period refers to a period during which the UE must be wake up to check whether there is a paging from a network even when the UE is in a discontinuous reception (DRX) mode in which it does not attempt to receive a downlink signal for power saving.

(10) MTC may use the same PSS (Primary Synchronization Signal)/SSS (Secondary Synchronization Signal)/CRS (Common Reference Signal) used in legacy LTE or NR. In the case of NR, the PSS/SSS is transmitted on an SSB basis, and a tracking RS (TRS) is a cell-specific RS and may be used for frequency/time tracking.

MTC Operation Mode and Level

Next, an MTC operation mode and level will be described. MTC is classified into two operation modes (first mode, second mode) and four different levels for coverage improvement as shown in Table 8 below.

The MTC operation mode is referred to as a CE (Coverage Enhancement) mode. In this case, the first mode may be referred to as a CE mode A, and the second mode may be referred to as a CE mode B.

TABLE 8

| Mode | Level | Description |
|---|---|---|
| Mode A | Level 1 | No repetition for PRACH |
| | Level 2 | Small Number of Repetition for PRACH |
| Mode B | Level 3 | Medium Number of Repetition for PRACH |
| | Level 4 | Large Number of Repetition for PRACH |

The first mode is defined for small coverage enhancement to support full mobility and CSI (channel state information, in which there is no repetition or fewer repetition times. The second mode is defined for UEs with extremely poor coverage conditions that support CSI feedback and limited mobility, in which a large number of repetitive transmissions is defined. The second mode provides a coverage improvement of up to 15 dB. Each level of MTC is defined differently in the random access procedure and the paging process.

The MTC operation mode is determined by the BS, and each level is determined by the MTC UE. Specifically, the BS transmits RRC signaling including information on the MTC operation mode to the UE. Here, the RRC signaling may be an RRC connection setup message, an RRC connection reconfiguration message or an RRC connection reestablishment message.

Thereafter, the MTC UE determines a level in each operation mode and transmits the determined level to the BS. Specifically, the MTC UE determines a level in an operation mode on the basis of measured channel quality (e.g., reference signal received power (RSRP), reference signal received quality (RSRQ), or signal to interference plus noise ratio (SINR), and transmits an RACH preamble using a PRACH resource (e.g., frequency, time, preamble resource for PRACH) corresponding to the determined level, thereby informing the BS about the determined level.

MTC Guard Period

As discussed above, MTC operates in narrow band. The location of the narrow band used in the MTC may be different for each particular time unit (e.g., subframe or slot). The MTC UE may tune to different frequencies depending on the time units. A certain amount of time is required for frequency retuning, and certain amount of time is defined as a guard period of MTC. That is, a guard period is required when frequency retuning is performed while transitioning from one time unit to the next time unit, and transmission and reception do not occur during the guard period.

MTC Signal Transmission/Reception Method

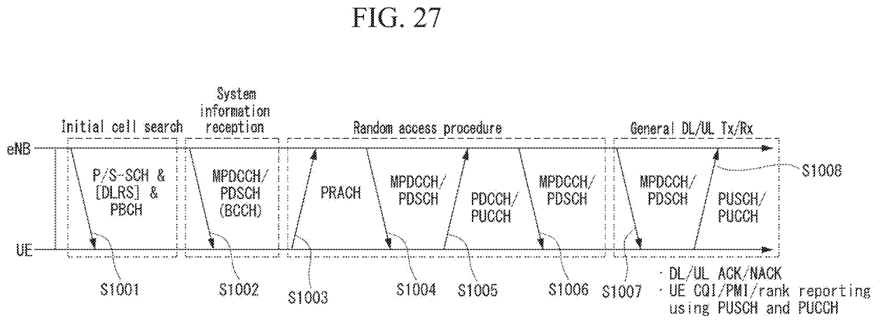

FIG. 27 is a diagram illustrating physical channels that may be used for MTC and a general signal transmission method using the same.

In step S1001, the MTC UE, which is powered on again or enters a new cell, performs an initial cell search operation such as synchronizing with the BS. To this end, the MTC UE receives a primary synchronization signal (PSS) and a secondary synchronization signal (SSS) from the BS, adjusts synchronization with the BS, and acquires information such as a cell ID. The PSS/SSS used in the initial cell search operation of the MTC may be a PSS/SSS, a resynchronization signal (RSS), or the like of an legacy LTE.

Thereafter, the MTC UE may receive a physical broadcast channel (PBCH) signal from the BS to acquire broadcast information in a cell.

Meanwhile, the MTC UE may receive a downlink reference signal (DL RS) in an initial cell search step to check a downlink channel state. The broadcast information transmitted through the PBCH is a master information block (MIB), and in the LTE, the MIB is repeated by every 10 ms.

Among the bits of the MIB of the legacy LTE, reserved bits are used in MTC to transmit scheduling for a new SIB1-BR (system information block for bandwidth reduced device) including a time/frequency location and a transport block size. The SIB-BR is transmitted directly on the PDSCH without any control channel (e.g., PDCCH, MPDDCH) associated with the SIB-BR.

Upon completion of the initial cell search, the MTC UE may receive an MPDCCH and a PDSCH according to the MPDCCH information to acquire more specific system information in step S1002. The MPDCCH may be transmitted only once or repeatedly. The maximum number of repetitions of the MPDCCH is set to the UE by RRC signaling from the BS.

Thereafter, the MTC UE may perform a random access procedure such as steps S1003 to S1006 to complete the connection to the BS. A basic configuration related to the RACH process of the MTC UE is transmitted by SIB2. In addition, SIB2 includes parameters related to paging. In the 3GPP system, a paging occasion (PO) refers to a time unit in which the UE may attempt to receive paging. The MTC UE attempts to receive the MPDCCH on the basis of a P-RNTI in the time unit corresponding to its PO on the narrowband (PNB) set for paging. The UE that has successfully decoded the MPDCCH on the basis of the P-RNTI may receive a PDSCH scheduled by the MPDCCH and check a paging message for itself. If there is a paging message for itself, the UE performs a random access procedure to access a network.

For the random access procedure, the MTC UE transmits a preamble through a physical random access channel (PRACH) (S1003), and receives a response message (RAR) for the preamble through the MPDCCH and the corresponding PDSCH. (S1004). In the case of a contention-based random access, the MTC UE may perform a contention resolution procedure such as transmission of an additional PRACH signal (S1005) and reception of the MPDCCH signal and corresponding PDSCH signal (S1006). The signals and/or messages Msg 1, Msg 2, Msg 3, and Msg 4 transmitted in the RACH process in the MTC may be repeatedly transmitted, and the repeat pattern is set to be different according to the CE level. Msg1 denotes a PRACH preamble, Msg2 denotes a random access response (RAR), Msg3 denotes UL transmission on the basis of a UL grant included in the RAR, and Msg4 denotes a DL transmission of the BS to Msg3.

For random access, PRACH resources for the different CE levels are signaled by the BS. This provides the same control of a near-far effect on the PRACH by grouping together UEs experiencing similar path loss. Up to four different PRACH resources may be signaled to the MTC UE.

The MTC UE estimates RSRP using a downlink RS (e.g., CRS, CSI-RS, TRS, and the like), and selects one of different PRACH resources (e.g., frequency, time, and preamble resources for PRACH) for the random access on the basis of the measurement result. The RAR for the PRACH and search spaces for the contention resolution messages for PRACH are also signaled at the BS via system information.

The MTC UE that has performed the above-described process may then receive an MPDCCH signal and/or a PDSCH signal (S1007) and transmit a physical uplink shared channel (PUSCH) signal and/or a physical uplink control channel (PUCCH) (S1108) as a general uplink/downlink signal transmission process. The MTC UE may transmit uplink control information (UCI) to the BS through the PUCCH or PUSCH. The UCI may include HARQ-ACK/NACK, scheduling request (SR), and/or CSI.

When RRC connection to the MTC UE is established, the MTC UE monitors the MPDCCH in a search space set to acquire uplink and downlink data allocation and attempts to receive the MDCCH.

In the case of MTC, the MPDCCH and the PDSCH scheduled by the MDCCH are transmitted/received in different subframes. For example, the MPDCCH having the last repetition in subframe #n schedules the PDSCH starting at subframe #n+2. The DCI transmitted by the MPDCCH provides information on how many times the MPDCCH is repeated so that the MTC UE may know when the PDSCH transmission is started. For example, when the DCI in the MPDCCH started to be transmitted from the subframe #n includes information that the MPDCCH is repeated 10 times, a last subframe in which the MPDCCH is transmitted is the subframe #n+9 and transmission of the PDSCH may start at subframe #n+11.

The PDSCH may be scheduled in the same as or different from a narrow band in which the MPDCCH scheduling the PDSCH is present. If the MPDCCH and the corresponding PDSCH are located in different narrow bands, the MTC UE needs to retune the frequency to the narrow band in which the PDSCH is present before decoding the PDSCH.

For uplink data transmission, scheduling may follow the same timing as legacy LTE. For example, the MPDCCH which is lastly transmitted at subframe #n may schedule PUSCH transmission starting at subframe #n+4.

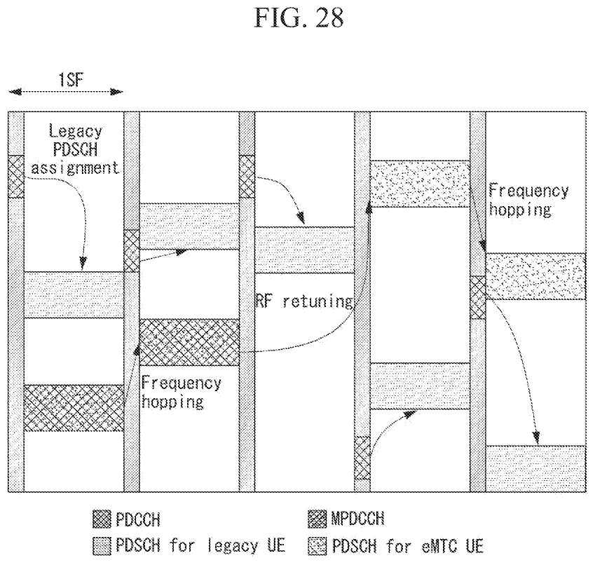

FIG. 28 shows an example of scheduling for MTC and legacy LTE, respectively.

In the legacy LTE, the PDSCH is scheduled using the PDCCH, which uses the first OFDM symbol(s) in each subframe, and the PDSCH is scheduled in the same subframe as the subframe in which the PDCCH is received.

In contrast, the MTC PDSCH is cross-subframe scheduled, and one subframe between the MPDCCH and the PDSCH is used as a time period for MPDCCH decoding and RF retuning. The MTC control channel and data channel may be repeated over a large number of subframes including up to 256 subframes for the MPDCCH and up to 2048 subframes for the PDSCH so that they may be decoded under extreme coverage conditions.

NB-IoT (Narrowband-Internet of Things)

The NB-IoT may refer to a system for supporting low complexity, low power consumption through a system bandwidth (system BW) corresponding to one resource block (RB) of a wireless communication system.

Here, NB-IoT may be referred to as other terms such as NB-LTE, NB-IoT enhancement, enhanced NB-IoT, further enhanced NB-IoT, NB-NR. That is, NB-IoT may be replaced with a term defined or to be defined in the 3GPP standard, and hereinafter, it will be collectively referred to as ‘NB-IoT’ for convenience of explanation.

The NB-IoT is a system for supporting a device (or UE) such as machine-type communication (MTC) in a cellular system so as to be used as a communication method for implementing IoT (i.e., Internet of Things). Here, one RB of the existing system band is allocated for the NB-IoT, so that the frequency may be efficiently used. Also, in the case of NB-IoT, each UE recognizes a single RB as a respective carrier, so that RB and carrier referred to in connection with NB-IoT in the present specification may be interpreted to have the same meaning.

Hereinafter, a frame structure, a physical channel, a multi-carrier operation, an operation mode, and general signal transmission/reception related to the NB-IoT in the present specification are described in consideration of the case of the legacy LTE system, but may also be extendedly applied to a next generation system (e.g., an NR system, etc.). In addition, the contents related to NB-IoT in this specification may be extendedly applied to MTC (Machine Type Communication) oriented for similar technical purposes (e.g., low-power, low-cost, coverage enhancement, etc.).

Hereinafter, a case where a transmission time interval of a physical channel is a subframe are described as an example. For example, a case where a minimum time interval from the start of transmission of one physical channel (e.g., NPDCCH, NPDSCH, NPUCCH, NPUSCH) to the start of transmission of a next physical channel is one subframe will be described, but in the following description, the subframe may be replaced by a slot, a mini-slot, or multiple slots.

Frame Structure and Physical Resource of NB-IoT

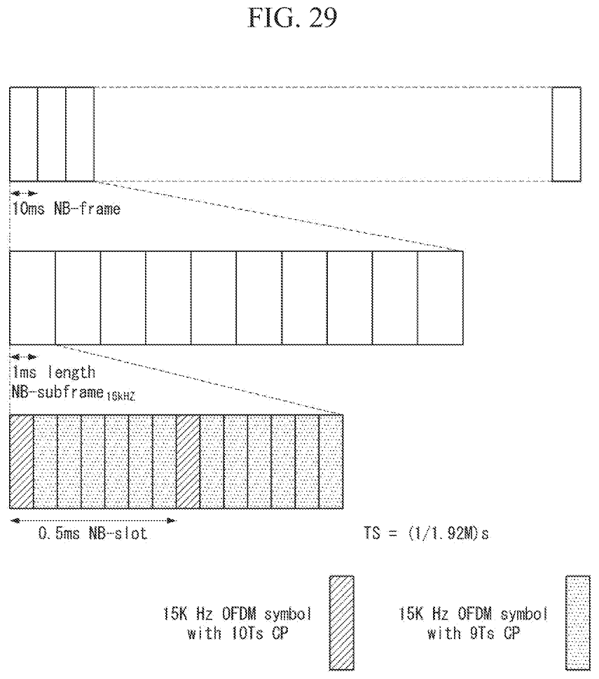

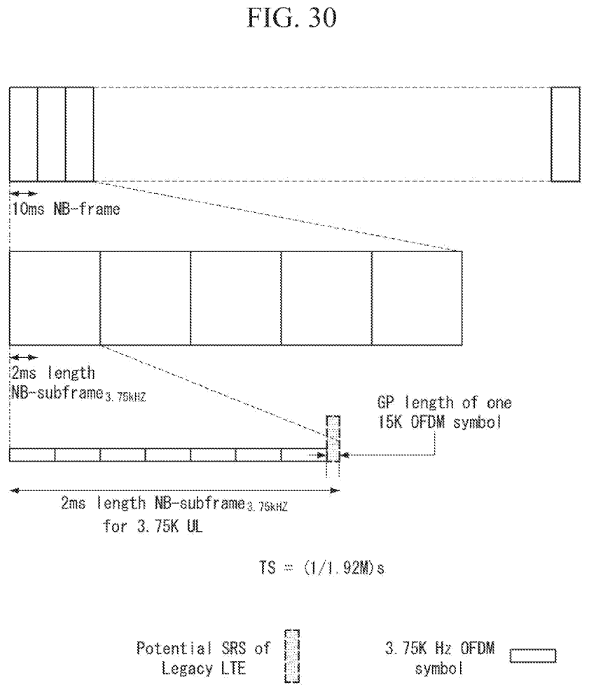

First, the NB-IoT frame structure may be configured to be different according to subcarrier spacing. Specifically, FIG. 29 shows an example of a frame structure when a subscriber spacing is 15 kHz, and FIG. 30 shows an example of a frame structure when a subscriber spacing is 3.75 kHz. However, the NB-IoT frame structure is not limited thereto, and NB-IoT for other subscriber spacings (e.g., 30 kHz) may be considered with different time/frequency units.

In addition, although the NB-IoT frame structure on the basis of the LTE system frame structure has been exemplified in the present specification, it is merely for the convenience of explanation and the present invention is not limited thereto. The method described in this disclosure may also be extendedly applied to NB-IoT based on a frame structure of a next-generation system (e.g., NR system).

Referring to FIG. 29, the NB-IoT frame structure for a 15 kHz subscriber spacing may be configured to be the same as the frame structure of the legacy system (e.g., LTE system) described above. For example, a 10 ms NB-IoT frame may include ten 1 ms NB-IoT subframes, and the 1 ms NB-IoT subframe may include two 0.5 ms NB-IoT slots. Further, each 0.5 ms NB-IoT may include 7 OFDM symbols.

Alternatively, referring to FIG. 30, the 10 ms NB-IoT frame may include five 2 ms NB-IoT subframes, the 2 ms NB-IoT subframe may include seven OFDM symbols and one guard period (GP). Also, the 2 ms NB-IoT subframe may be represented by an NB-IoT slot or an NB-IoT RU (resource unit).

Next, physical resources of the NB-IoT for each of downlink and uplink will be described.

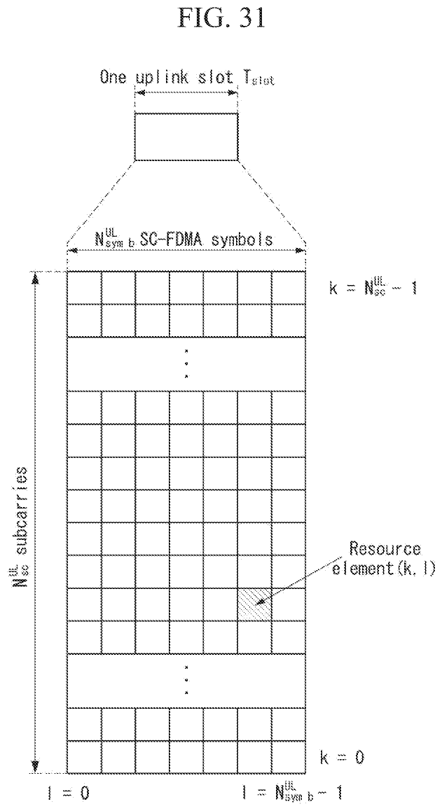

First, the physical resources of the NB-IoT downlink may be configured by referring to physical resources of other wireless communication system (e.g., LTE system, NR system, etc.), except that a system bandwidth is limited to a certain number of RBs (e.g., one RB, i.e., 180 kHz). For example, when the NB-IoT downlink supports only the 15-kHz subscriber spacing as described above, the physical resources of the NB-IoT downlink may be configured as resource regions limiting a resource grid of the LTE system shown in FIG. 31 to one RB in the frequency domain.

Next, in the case of the NB-IoT uplink physical resource, the system bandwidth may be limited to one RB as in the case of downlink. For example, if the NB-IoT uplink supports 15 kHz and 3.75 kHz subscriber spacings as described above, a resource grid for the NB-IoT uplink may be expressed as shown in FIG. 31. In this case, the number of subcarriers NULsc and the slot period Tslot in the uplink band in FIG. 31 may be given as shown in Table 9 below.

TABLE 9

| Subcarrier spacing | NULsc | Tslot |
|---|---|---|
| Δf = 3.75 kHz | 48 | 6144 · Ts |
| Δf = 15 kHz | 12 | 15360 · Ts |

In NB-IoT, resource units (RUs) are used for mapping the PUSCH for NB-IoT (hereinafter referred to as NPUSCH) to resource elements. RU may include NULsymb*NULslot SC-FDMA symbols in the time domain and include NRUsc number of consecutive subcarriers in the frequency domain. For example, NRUsc and NULsymb may be given by Table 10 below for frame structure type 1, which is a frame structure for FDD, and may be given by Table 11 below for frame structure type 2, which is frame structure for TDD.

TABLE 10

| NPUSCH | | | | |
|---|---|---|---|---|
| format | Δf | NRUsc | NULslots | NULsymb |
| 1 | 3.75 kHz | 1 | 16 | 7 |
| | 15 kHz | 1 | 16 | |
| | | 3 | 8 | |
| | | 6 | 4 | |
| | | 12 | 2 | |
| 2 | 3.75 kHz | 1 | 4 | |
| | 15 kHz | 1 | 4 | |

TABLE 11

| | | Supported up- | | | |
|---|---|---|---|---|---|
| NPUSCH | | link-downlink | | | |
| format | Δf | configurations | NRUsc | NULslots | NULsymb |
| 1 | 3.75 kHz | 1, 4 | 1 | 16 | 7 |
| | 15 kHz | 1, 2, 3, 4, 5 | 1 | 16 | |
| | | | 3 | 8 | |
| | | | 6 | 4 | |
| | | | 12 | 2 | |
| 2 | 3.75 kHz | 1, 4 | 1 | 4 | |
| | 15 kHz | 1, 2, 3, 4, 5 | 1 | 4 | |

Physical Channel of NB-IoT

A BS and/or a UE supporting the NB-IoT may be configured to transmit/receive physical channels and/or physical signals configured separately from the legacy system. Hereinafter, specific contents related to physical channels and/or physical signals supported by the NB-IoT will be described.

An orthogonal frequency division multiple access (OFDMA) scheme may be applied to the NB-IoT downlink on the basis of a subscriber spacing of 15 kHz. Through this, co-existence with other systems (e.g., LTE system, NR system) may be efficiently supported by providing orthogonality between subcarriers. A downlink physical channel/signal of the NB-IoT system may be represented by adding ‘N (Narrowband)’ to distinguish it from the legacy system. For example, a downlink physical channel may be referred to as an NPBCH (narrowband physical broadcast channel), an NPDCCH (narrowband physical downlink control channel), or an NPDSCH (narrowband physical downlink shared channel), and a downlink physical signal may be referred to as an NPSS (narrowband primary synchronization signal), an NSSS (narrowband secondary synchronization signal), an NRS (narrowband reference signal), an NPRS (narrowband positioning reference signal), an NWUS (narrowband wake up signal), and the like. Generally, the downlink physical channels and physical signals of the NB-IoT may be configured to be transmitted on the basis of a time domain multiplexing scheme and/or a frequency domain multiplexing scheme. In the case of NPBCH, NPDCCH, NPDSCH, etc., which are the downlink channels of the NB-IoT system, repetition transmission may be performed for coverage enhancement. In addition, the NB-IoT uses a newly defined DCI format. For example, the DCI format for NB-IoT may be defined as DCI format N0, DCI format N1, DCI format N2, and the like.

In the NB-IoT uplink, a single carrier frequency division multiple access (SC-FDMA) scheme may be applied on the basis of a subscriber spacing of 15 kHz or 3.75 kHz. As mentioned in the downlink section, the physical channel of the NB-IoT system may be expressed by adding ‘N (Narrowband)’ to distinguish it from the existing system. For example, the uplink physical channel may be represented by a narrowband physical random access channel (NPRACH) or a narrowband physical uplink shared channel (NPUSCH), and the uplink physical signal may be represented by a narrowband demodulation reference signal (NDMRS), or the like. NPUSCH may be divided into NPUSCH format 1 and NPUSCH format 2. In one example, NPUSCH Format 1 may be used for uplink shared channel (UL-SCH) transmission (or transport), and NPUSCH Format 2 may be used for uplink control information transmission such as HARQ ACK signaling. In the case of NPRACH, which is an uplink channel of the NB-IoT system, repetition transmission may be performed for coverage enhancement. In this case, repetition transmission may be performed by applying frequency hopping.

Multi-Carrier Operation of NB-IoT

Next, a multi-carrier operation of the NB-IoT will be described. The multicarrier operation may refer to that multiple carriers set for different uses (i.e., different types) are used for transmitting/receiving channels and/or signals between the BS and/or UE in the NB-Iot.

The NB-IoT may operate in a multi-carrier mode. Here, in the NB-IoT, a carrier wave in the N-Iot may be classified as an anchor type carrier (i.e., an anchor carrier, an anchor PRB) and a non-anchor type carrier a non-anchor type carrier (i.e., non-anchor carrier).

The anchor carrier may refer to a carrier that transmits NPSS, NSSS, NPBCH, and NPDSCH for a system information block (N-SIB) for initial access from a point of view of the BS. That is, in NB-IoT, the carrier for initial access may be referred to as an anchor carrier and the other(s) may be referred to as a non-anchor carrier. Here, only one anchor carrier wave may exist in the system, or there may be a plurality of anchor carrier waves.

Operation Mode of NB-IoT

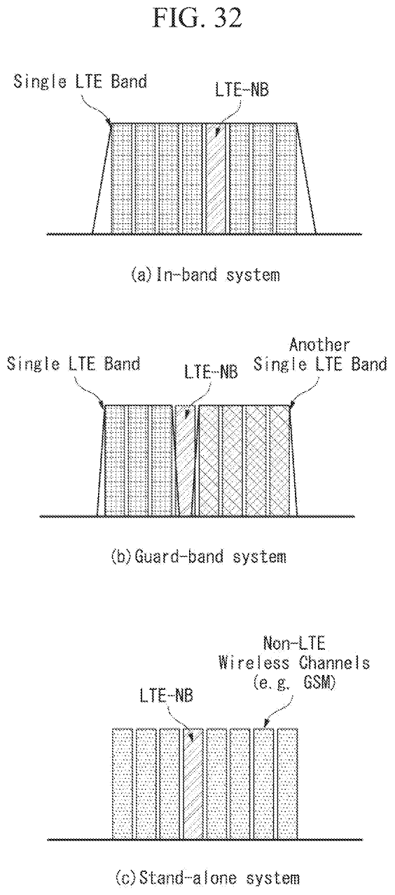

Next, an operation mode of the NB-IoT will be described. In the NB-IoT system, three operation modes may be supported. FIG. 32 shows an example of operation modes supported in the NB-IoT system. Although the operation mode of the NB-IoT is described herein on the basis of an LTE band, this is for convenience of explanation and may be extendedly applied to other system bands (e.g. NR system band).

Specifically, FIG. 32(a) shows an example of an in-band system, FIG. 32 (b) shows an example of a guard-band system, and FIG. 32(c) Represents an example of a stand-alone system. In this case, the in-band system may be expressed as an in-band mode, the guard-band system may be expressed as a guard-band mode, and the stand-alone system may be expressed in a stand-alone mode.

The in-band system may refer to a system or mode that uses a specific RB in the (legacy) LTE band. The in-band system may be operated by allocating some resource blocks of the LTE system carrier.

A guard-band system may refer to a system or mode that uses NB-IoT in a space reserved for a guard-band of the legacy LTE band. The guard-band system may be operated by allocating a guard-band of an LTE carrier not used as a resource block in the LTE system. For example, the (legacy) LTE band may be configured to have a guard-band of at least 100 kHz at the end of each LTE band, and with two non-contiguous guard-bands for 200 kHz for NB-IoT may be used.

As described above, the in-band system and the guard-band system may be operated in a structure in which NB-IoT coexists in the (legacy) LTE band.

By contrast, the stand-alone system may refer to a system or mode that is configured independently of the legacy LTE band. The stand-alone system may be operated by separately allocating frequency bands (e.g., reassigned GSM carriers in the future) used in a GERAN (GSM EDGE radio access network).

The three operation modes described above may be operated independently of each other, or two or more operation modes may be operated in combination.

NB-IoT Signal Transmission/Reception Process

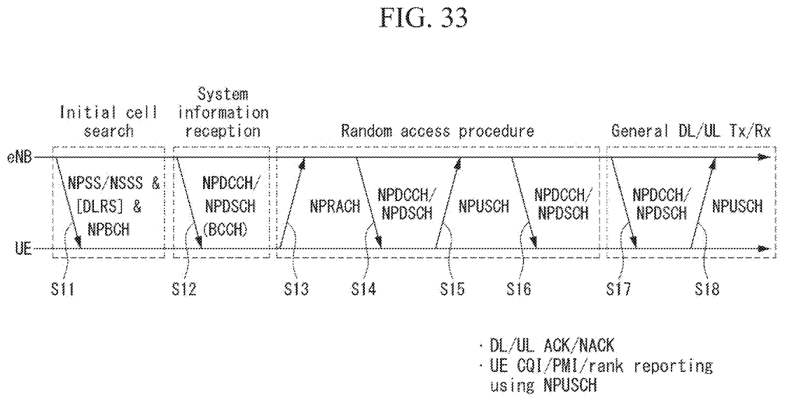

FIG. 33 is a diagram illustrating an example of physical channels that may be used for NB-IoT and a general signal transmission method using the same. In a wireless communication system, an NB-IoT UE may receive information from a BS through a downlink (DL) and the NB-IoT UE may transmit information to the BS through an uplink (UL). In other words, in the wireless communication system, the BS may transmit information to the NB-IoT UE through the downlink and the BS may receive information from the NB-IoT UE through the uplink.

The information transmitted/received by the BS and the NB-IoT UE includes data and various control information, and various physical channels may exist depending on the type/purpose of the information transmitted/received by the BS and NB-IoT UE. The signal transmission/reception method of the NB-IoT may be performed by the above-described wireless communication devices (e.g., BS and UE).

The NB-IoT UE, which is powered on again or enters a new cell, may perform an initial cell search operation such as adjusting synchronization with the BS, or the like (S11). To this end, the NB-IoT UE receives NPSS and NSSS from the BS, performs synchronization with the BS, and acquires cell identity information. Also, the NB-IoT UE may receive the NPBCH from the BS and acquire the in-cell broadcast information. In addition, the NB-IoT UE may receive a DL RS (downlink reference signal) in the initial cell search step to check a downlink channel state.

After completion of the initial cell search, the NB-IoT UE may receive the NPDCCH and the corresponding NPDSCH to acquire more specific system information (S12). In other words, the BS may transmit more specific system information by transmitting the NPDCCH and corresponding NPDSCH to the NB-IoT UE after completion of the initial cell search.

Thereafter, the NB-IoT UE may perform a random access procedure to complete connection to the BS (S13 to S16).

Specifically, the NB-IoT UE may transmit a preamble to the BS via the NPRACH (S13). As described above, the NPRACH may be configured to be repeatedly transmitted on the basis of frequency hopping or the like to enhance coverage or the like. In other words, the BS may (repeatedly) receive a preamble through the NPRACH from the NB-IoT UE.

Thereafter, the NB-IoT UE may receive a random access response (RAR) for the preamble from the BS through the NPDCCH and the corresponding NPDSCH (S14). In other words, the BS may transmit the RAR for the preamble to the NB-IoT UE through the NPDCCH and the corresponding NPDSCH.

Thereafter, the NB-IoT UE transmits the NPUSCH to the BS using scheduling information in the RAR (S15), and may perform a contention resolution procedure such as the NPDCCH and the corresponding NPDSCH (S16). In other words, the BS may receive the NPUSCH from the UE using the scheduling information in the NB-IoT RAR, and perform the contention resolution procedure.

The NB-IoT UE that has performed the above-described process may perform NPDCCH/NPDSCH reception (S17) and NPUSCH transmission (S18) as a general uplink/downlink signal transmission process. In other words, after performing the above-described processes, the BS may perform NPDCCH/NPDSCH transmission and NPUSCH reception as a general signal transmission/reception process to the NB-IoT UE.

In the case of NB-IoT, as mentioned above, NPBCH, NPDCCH, NPDSCH, and the like may be repeatedly transmitted for coverage improvement and the like. In the case of NB-IoT, UL-SCH (i.e., general uplink data) and uplink control information may be transmitted through the NPUSCH. Here, the UL-SCH and the uplink control information (UCI) may be configured to be transmitted through different NPUSCH formats (e.g., NPUSCH format 1, NPUSCH format 2, etc.).

Also, the UCI may include HARQ ACK/NACK (Hybrid Automatic Repeat and reQuest Acknowledgement/Negative-ACK), SR (Scheduling Request), CSI (Channel State Information), and the like. As described above, the UCI in the NB-IoT may generally be transmitted via the NPUSCH. Also, in response to a request/instruction from the network (e.g., BS), the UE may transmit the UCI via the NPUSCH in a periodic, aperiodic, or semi-persistent manner.

Hereinafter, the wireless communication system block diagram shown in FIG. 1 will be described in detail.

N. Wireless Communication Device

Referring to FIG. 1, a wireless communication system includes a first communication device 910 and/or a second communication device 920. ‘A and/or B’ may be interpreted to have the same meaning as ‘includes at least one of A or B.’ The first communication device may represent a BS and the second communication device may represent a UE (alternatively, the first communication device may represent a UE and the second communication device may represent a BS).

The first and second communication devices may include processors 911 and 921, memories 914 and 924, one or more Tx/Rx RF modules 915 and 925, Tx processors 912 and 922, Rx processors 913 and 923, and antennas 916 and 926, respectively. The Tx/Rx module is also called a transceiver. The processor implements the functions, procedures and/or methods discussed above. More specifically, in the DL (communication from the first communication device to the second communication device), a higher layer packet from the core network is provided to the processor 911. The processor implements the function of a layer 2 (i.e., L2) layer. In the DL, the processor multiplexes a logical channel and a transport channel, provides radio resource allocation to the second communication device 920, and is responsible for signaling to the second communication device. A transmission (TX) processor 912 implements various signal processing functions for the L1 layer (i.e., the physical layer). The signal processing function facilitates forward error correction (FEC) in the second communication device, and includes coding and interleaving. The encoded and interleaved signals are scrambled and modulated into complex-valued modulation symbols. For modulation, BPSK (Quadrature Phase Shift Keying), QPSK (Quadrature Phase Shift Keying), 16QAM (quadrature amplitude modulation), 64QAM, 246QAM, and the like may be used. The complex-valued modulation symbols (hereinafter referred to as modulation symbols) are divided into parallel streams, each stream being mapped to an OFDM subcarrier and multiplexed with a reference signal (RS) in the time and/or frequency domain, and combined together using IFFT (Inverse Fast Fourier Transform) to create a physical channel carrying a time domain OFDM symbol stream. The OFDM symbol stream is spatially precoded to produce multiple spatial streams. Each spatial stream may be provided to a different antenna 916 via a separate Tx/Rx module (or transceiver, 915). Each Tx/Rx module may upconvert each spatial stream into an RF carrier for transmission. In the second communication device, each Tx/Rx module (or transceiver, 925) receives a signal of the RF carrier via each antenna 926 of each Tx/Rx module. Each Tx/Rx module restores the RF carrier signal to a baseband signal and provides it to the reception (RX) processor 923. The RX processor implements various signal processing functions of the L1 (i.e., the physical layer). The RX processor may perform spatial processing on the information to recover any spatial stream directed to the second communication device. If multiple spatial streams are directed to the second communication device, they may be combined into a single OFDMA symbol stream by multiple RX processors. The RX processor transforms the OFDM symbol stream, which is a time domain signal, into a frequency domain signal using a fast Fourier transform (FFT). The frequency domain signal includes a separate OFDM symbol stream for each subcarrier of the OFDM signal. The modulation symbols and the reference signal on each subcarrier are recovered and demodulated by determining the most likely signal constellation points sent by the first communication device. These soft decisions may be based on channel estimate values. Soft decisions are decoded and deinterleaved to recover data and control signals originally transmitted by the first communication device on the physical channel. The corresponding data and control signals are provided to the processor 921.

The UL (communication from the second communication device to the first communication device) is processed in the first communication device 910 in a manner similar to that described in connection with a receiver function in the second communication device 920. Each Tx/Rx module 925 receives a signal via each antenna 926. Each Tx/Rx module provides an RF carrier and information to RX processor 923. The processor 921 may be related to the memory 924 that stores program code and data. The memory may be referred to as a computer-readable medium.

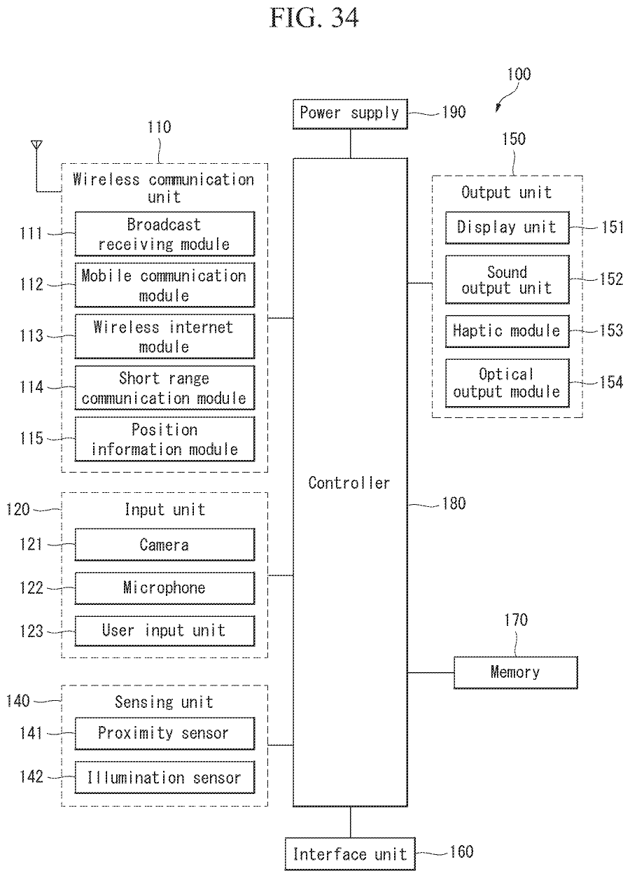

Hereinafter, an intelligent service providing method and apparatus according to an embodiment of the present invention will be described in detail with reference to FIG. 34 to FIG. 66.

FIG. 34 is a block diagram illustrating the intelligent service providing apparatus associated with the present invention.

Referring to FIG. 34, the terminal 10 is shown as an example of a home appliance control apparatus. The terminal 10 includes a wireless communication unit 110, an input unit 120, a sensing unit 140, an output unit 150, an interface unit 160, a memory 170, a processor 180 and a power supply unit 190. The components shown in FIG. 34 are not essential for implementing the terminal, and the terminal described in this disclosure may have greater or fewer components than those listed above.

Specifically, the wireless communication unit 110 may include one or more modules enabling wireless communication between the terminal 10 and a wireless communication system, between the terminal 10 and another terminal 10, and between the terminal 10 and an external server. Further, the wireless communication unit 110 may include one or more modules which connect the terminal 10 to one or more networks.

The wireless communication unit 110 may include at least one of a broadcast receiving module 111, a mobile communication module 112, a wireless Internet module 113, a short-range communication module 114, and a location information module 115.

The input unit 120 may include a camera 121 or an image input unit for inputting an image signal, a microphone 122 for inputting an audio signal, an audio input unit, a user input unit 123 (e.g., a touch key, a mechanical key, etc.) for receiving information from a user. Voice data or image data collected by the input unit 120 may be analyzed and processed as a control command of a user.

The sensing unit 140 may include at least one sensor for sensing at least one of information in the terminal, surrounding environment information of the terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared sensor, a finger scan sensor, an ultrasonic sensor, an optical sensor (e.g., camera 121), a microphone 122, a battery gauge, an environmental sensor (e.g., a barometer, a hygrometer, a thermometer, a radiation detection sensor, a thermal sensor, a gas sensor, etc.), a chemical sensor (e.g., an electronic nose, a healthcare sensor, a biometric sensor, etc.). Meanwhile, the terminal disclosed in the present disclosure may combine and utilize information sensed by at least two of the sensors.

The output unit 150 serves to generate an output related to visual, auditory or tactile sense and includes at least one of a display unit 151, an audio output unit 152, a haptic module 153, and a light output unit 154. The display unit 151 may have an inter-layer structure with a touch sensor or may be integrally formed to realize a touch screen. The touch screen may serve as a user input unit 123 that provides an input interface between the terminal 10 and a user, and provide an output interface between the terminal 10 and the user.

The interface unit 160 serves as an interface with various types of external devices that are connected to the terminal 10. The interface unit 160 may include at least one of wired/wireless headset ports, external power supply ports, wired/wireless data ports, memory card ports, ports for connecting a device having an identification module, audio input/output (I/O) ports, video I/O ports, and earphone ports. When an external device is connected to the interface unit 160, the terminal 10 may perform appropriate control in relation to the connected external device.

The memory 170 stores data supporting various functions of the terminal 10. The memory 170 may store a plurality of application programs or applications that are driven in the terminal 10, data for operation of the terminal 10, and commands. At least some of these applications may be downloaded from an external server via wireless communication. At least some of these application programs may exist on the terminal 10 when the terminal 10 was released from the factory for basic functions (e.g., call incoming and call outgoing function, message reception and message sending function) of the terminal 10. Meanwhile, the application programs may be stored in the memory 170, installed on the terminal 10, and may be driven by the processor 180 to perform an operation (or function) of the terminal.

In addition to the operations related to the application programs, the processor 180 typically controls an overall operation of the terminal 10. The processor 180 may process signals, data, information, and the like, input or output through the components described above or may drive an application program stored in the memory 170 to provide or process appropriate information or functions to the user.

The processor 180 may control at least some of the components shown in FIG. 34 to drive an application program stored in the memory 170. In addition, in order to drive the application program, the processor 180 may operate at least two of the components included in the terminal 10 in combination with each other.

The power supply unit 690 supplies power to the components included in the terminal 10 under the control of the processor 180 upon receiving external power and internal power. The power supply unit 190 may include a battery, and the battery may be an internal battery or a replaceable battery.

At least some of the components may operate in cooperation with each other to implement an operation, control, or a control method of the terminal according to various embodiments described below. In addition, the operation, control, or control method of the terminal may be implemented on the terminal by driving at least one application program stored in the memory 170.

Hereinafter, the components listed above will be described in more detail with reference to FIG. 34 before explaining various embodiments implemented through the terminal 10 as described above.

First, referring to the wireless communication unit 110, the broadcast receiving module 111 of the wireless communication unit 110 receives broadcast signals and/or broadcast-related information from an external broadcast management server through a broadcast channel. The broadcast channel may include a satellite channel and a terrestrial channel. Two or more broadcast receiving modules may be provided to the terminal 10 for simultaneous broadcast reception or broadcast channel switching for at least two broadcast channels.

The mobile communication module 112 may transmit and receive a wireless signal to and from at least one of a base station, an external terminal, and a server in a mobile communication network established according to technical standards or communication scheme for mobile communication (e.g., GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), etc.

The wireless signal may include various types of data according to transmission/reception of a voice call signal, a video call signal, or a text/multimedia message.

The wireless Internet module 113 is a module for wireless Internet access, and may be provided within or outside the terminal 10. The wireless Internet module 113 is configured to transmit and receive a wireless signal in a communication network according to wireless Internet technologies.

Examples of the wireless Internet technologies include a WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), and the wireless Internet module 113 transmits and receives data according to at least one wireless Internet technology in a range including Internet technologies not listed above.

From a viewpoint that wireless Internet access by WiBro, HSDPA, HSUPA, GSM, CDMA, WCDMA, LTE and LTE-A is performed through a mobile communication network, the wireless Internet module 113 performing wireless Internet access through the mobile communication network may be understood as a kind of the mobile communication module 112.

The short-range communication module 114 is for short-range communication and may support short-range communication using at least one of Bluetooth®, an RFID (Radio Frequency Identification), an Infrared Data Association (IrDA), UWB (Ultra Wideband), ZigBee, NFC (Near Field Communication), Wi-Fi (Wireless-Fidelity), Wi-Fi Direct, Wireless USB (Wireless Universal Serial Bus). The short-range communication module 114 may support wireless communication between the terminal 10 and a wireless communication system, between the terminal 10 and another terminal 10, or between the terminal 10 and a network where another terminal 100 (or external server) is positioned through a wireless area network. The short-range wireless communication network may be a wireless personal area network.

Here, the other terminal 10 may be a wearable device (e.g., smartwatch, smart glass, head mounted display (HMD), etc.) capable of exchanging data with the terminal 10 according to the present invention. The short-range communication module 114 may detect (or recognize) a wearable device capable of communicating with the terminal 10 around the terminal 10. Further, if the detected wearable device is a device authenticated to communicate with the terminal 10 according to the present invention.

If the detected wearable device is a device authenticated to communicate with the terminal 10 according to the present invention, the processor 180 may transmit at least a part of data processed in the terminal 10 to the wearable device through a local communication module 114. Therefore, a user of the wearable device may use the data processed in the terminal 10 through the wearable device. For example, when a call is received in the terminal 10, the user may perform call communication through the wearable device, or when a message is received by the terminal 10, the user may read the received message via the wearable device.

The location information module 115 is a module for obtaining a location (or current location) of the terminal, and a typical example thereof is a global positioning system (GPS) module or a wireless fidelity (Wi-Fi) module. For example, when the terminal utilizes a GPS module, the terminal may obtain a location of the terminal using signals transmitted from GPS satellites. As another example, when the terminal utilizes the Wi-Fi module, the terminal may obtain the location of the terminal on the basis of information of a wireless access point (AP) that transmits or receives a wireless signal to or from the Wi-Fi module. If necessary, the location information module 115 may perform any of the other functions of the wireless communication unit 110 to substitutively or additionally obtain data regarding a location of the terminal. The location information module 115 is a module used to obtain the location (or the current location) of the terminal, and is not limited to the module that directly calculates or obtains the location of the terminal.

The input unit 120, which is for inputting image information (or signal), audio information (or signal), data, or information input from a user, may include one or a plurality of cameras 121 to input image information. The camera 121 processes image frames of a still image or a moving image obtained by the image sensor in a video communication mode or an image capturing mode. The processed image frame may be displayed on the display unit 151 or stored in the memory 170. The plurality of cameras 121 provided in the terminal 10 may be arranged to form a matrix structure and a plurality of pieces of image information having a variety of angles or foci may be input to the terminal 10. In addition, the plurality of cameras 121 may be arranged in a stereo structure to obtain a left image and a right image for realizing a stereoscopic image.

The microphone 122 processes an external acoustic signal to electrical voice data. The processed voice data may be utilized variously according to a function (or an executed application program) being executed in the terminal 10. Meanwhile, the microphone 122 may include various noise canceling algorithms for canceling noise generated in the process of receiving an external sound signal.

The user input unit 123 is a component for receiving information from the user. When information is input through the user input unit, the processor 180 may control an operation of the terminal 10 to correspond to the input information. The user input unit 123 may include a mechanical input unit (or a mechanical key, for example, a button located on the front, rear, or side of the terminal 10, a dome switch, a jog wheel, jog switch, etc.) and touch-type input unit. For example, the touch-type input unit may be configured as a virtual key, a soft key, or a visual key displayed on a touch screen through software processing or configured as a touch key disposed on a portion other than the touch screen. Meanwhile, the virtual key or the visual key may have various forms and may be displayed on the touch screen and may be configured as, for example, graphic, text, an icon, video, or a combination thereof.

The sensing unit 140 senses at least one of internal information of the terminal, surrounding environment information of the terminal, and user information, and generates a corresponding sensing signal. The processor 180 may control driving or operation of the terminal 10 or may perform data processing, function or operation related to an application program installed in the terminal 10 on the basis of the sensing signal. Typical sensors among various sensors that may be included in the sensing unit 140 will be described in more detail.

First, the proximity sensor 141 refers to a sensor that detects the presence of an object approaching a predetermined detection surface or the presence of an object in the vicinity of the detection surface using an electromagnetic force or an infrared ray, without mechanical contact. The proximity sensor 141 may be disposed in an inner region of the terminal which is covered by the touch screen or in proximity to the touch screen.

Examples of the proximity sensor 141 include a transmission type photoelectric sensor, a direct reflection type photoelectric sensor, a mirror reflection type photoelectric sensor, a high-frequency oscillation type proximity sensor, a capacitive proximity sensor, a magnetic proximity sensor, and an infrared proximity sensor. In a case where the touch screen is a capacitive touch screen, the proximity sensor 141 may be configured to detect proximity of the object by a change in an electric field according to the proximity of the object having conductivity. In this case, the touch screen (or touch sensor) itself may be classified as a proximity sensor.

Meanwhile, for the sake of convenience of description, an action in which an object approaches the touch screen without contacting the touch screen may be called a proximity touch, and an action in which an object actually touches the touch screen may be called a contact touch. A location of the touch screen proximity-touched by the object may refer to a position of the object that vertically opposes the touch screen when the object performs the proximity touch. The proximity sensor 141 may detect a proximity touch and a proximity touch pattern (e.g., a proximity touch distance, a proximity touch direction, a proximity touch duration, a proximity touch position, a proximity touch shift state, etc.). The processor 180 may process data (or information) corresponding to the proximity touch action detected through the proximity sensor 141 and the detected proximity touch pattern and output visual information corresponding to the processed data to the touch screen. Further, the processor 180 may control the terminal 10 to process different operations or data (or information) depending on whether the touch applied to the same point on the touch screen is a proximity touch or a contact touch.

The touch sensor senses a touch (or touch input) applied to the touch screen (or the display unit 151) using at least one of various touch methods such as a resistive type, a capacitive type, an infrared type, an ultrasonic type, and a magnetic field type.

As an example, the touch sensor may be configured to convert pressure applied to a specific portion of the touch screen or a change in capacitance generated in a specific portion into an electrical input signal. The touch sensor may be configured to detect a position at which a touch object applying a touch to the touch screen touches on the touch sensor, an area, a pressure at the time of touch, a capacitance at the time of touch, and the like. Here, the touch object may be a finger, a touch pen, a stylus pen, a pointer, or the like as an object which applies a touch to the touch sensor.

Thus, when there is a touch input to the touch sensor, a corresponding signal(s) is sent to a touch controller. The touch controller processes the signal(s) and then transmits corresponding data to the processor 180. Thus, the processor 180 may know which area of the display unit 151 is touched or the like. Here, the touch controller may be a separate component from the processor 180 or may be the processor 180 itself.

Meanwhile, the processor 180 may perform different controls or perform the same control according to the type of the touch object which touches the touch screen (or a touch key provided on the touch screen). Whether to perform different controls or to perform the same control depending on the type of the touch object may be determined according to a current operation state of the terminal 10 or an application program being executed.

Meanwhile, the touch sensor and the proximity sensor described above may be used independently or in combination to sense various types of touches such as a short touch (or tap), a long touch, a multi-touch, a drag touch, a flick touch, a pinch-in touch, a pinch-out touch, a swipe touch, a hovering touch, and the like.

The ultrasonic sensor may recognize position information of the object to be sensed using ultrasonic waves. Meanwhile, the processor 180 may calculate a position of a wave generating source through information sensed by an optical sensor and the plurality of ultrasonic sensors. The position of the wave generating source may be calculated using the fact that light is much faster than the ultrasonic wave, that is, a time when light reaches the optical sensor is much faster than a time when the ultrasonic wave reaches the ultrasonic sensor. More specifically, the position of the wave generating source may be calculated using a time difference with the time when the ultrasonic wave reaches based on light as a reference signal.

A posture detection sensor may sense posture information such as movement information such as presence or absence of movement, distance, speed, acceleration, and direction of the terminal and/or an angle at which the terminal 10 is inclined with respect to a predetermined rotation axis.

The posture detection sensor 143 may include at least one acceleration sensor 144, at least one gyroscope 143, or a sensing signal processing unit (not shown) for compensating for a sensing value or converting sensing information.

The posture detection sensor may obtain linear movement, rotational movement, shaking information, and the like of the terminal 10 on the basis of acceleration sensed through various sensors. The acceleration sensor 144 senses movement of the terminal 10, obtains acceleration thereof, and detects information about the presence or absence of movement, distance, speed, acceleration, and direction of the terminal 10.

Also, the gyro sensor 143 may sense rotation of the terminal 10 and obtain the amount of rotation. The acceleration sensor 143 may express the sensed acceleration as vector values for three axes (X axis, Y axis, Z axis), and the gyroscope may express the sensed acceleration as rotation vector values (roll, pitch, and yaw) with respect to the three axes. Including the acceleration sensor 144 and the gyro sensor 143, the posture detection sensor may recognize a speed, position, and position change of the terminal 10. The posture detection sensor may be a general inertial navigation system (INS), and the gyro sensor may be a gyroscope such as an optical, mechanical, or piezoelectric type.

The sensing signal processing unit (not shown) may convert an analog signal output from the acceleration sensor or the gyroscope into an analog/digital signal, integrates the converted signal, and tracks a trace to convert into movement information, angle information, shaking information or the like.

In the above, the posture detection sensor including the acceleration sensor 144 and the gyro sensor 143 to obtain the posture and the movement of the terminal 10 According to an embodiment of the present invention is described but the present invention is not limited thereto and movement and posture information of the terminal 10 may be obtained using a certain sensor within the scope in which the object of the present invention may be achieved.

The camera 121 described as a component of the input unit 120 includes at least one of a camera sensor (e.g., a CCD, a CMOS, etc.), a photo sensor (or an image sensor), and a laser sensor.

The camera 121 and the laser sensor may be combined with each other to sense a touch of the sensing object with respect to a three-dimensional stereoscopic image. A photosensor may be stacked on a display element and may be configured to scan movement of the sensing object proximate to the touch screen. More specifically, the photosensor includes photo diodes and transistors (TRs) in a row/column and scans contents placed on the photosensor using an electrical signal changing according to the amount of light applied to the photo diode. That is, the photo sensor performs coordinate calculation of the sensing object according to variation of light, and position information of the sensing object may be obtained through the calculation.

The display unit 151 displays (outputs) information processed in the terminal 10. For example, the display unit 151 may display execution screen information of an application program driven in the terminal 10 or a user interface (UI) or graphic user interface (GUI) information according to the execution screen information.

In addition, the display unit 151 may be configured as a stereoscopic display unit for displaying a stereoscopic image.

The stereoscopic display unit may adopt a three-dimensional display method such as a stereoscopic method (glass method), an autostereoscopic method (glassless method), and a projection method (holographic method).

The audio output unit 152 may output audio data received from the wireless communication unit 110 or stored in the memory 170 in a call signal reception mode, a call mode or a recording mode, a voice recognition mode, and a broadcast reception mode. The audio output unit 152 may also output an audio signal related to a function (e.g., call signal reception sound, message reception sound, etc.) performed in the terminal 10. The audio output unit 152 may include a receiver, a speaker, a buzzer, and the like.

The haptic module 153 generates various tactile effects that the user may feel. A typical example of the haptic effect generated by the haptic module 153 may be vibration. The intensity and pattern of the vibration generated in the haptic module 153 may be controlled by the user's selection or a setting of the processor. For example, the haptic module 153 may synthesize different vibrations and output the same or sequentially output the vibrations.

In addition to vibration, the haptic module 153 may generate various other tactile effects, including an effect by stimulation such as a pin arrangement vertically moving to a contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 may also be implemented to allow the user to feel a tactile effect through a muscle sensation such as the user's fingers or arm, as well as transferring the tactile effect through direct contact. Two or more haptic modules 153 may be provided according to a particular configuration of the terminal.

The light output unit 154 outputs a signal for notifying the occurrence of an event using light of a light source of the terminal 10. Examples of events that occur in the terminal 10 may include message reception, call signal reception, an absent call, alarm, schedule notification, e-mail reception, information reception through an application, and the like.

The signal output by the light output unit 154 is implemented when the terminal emits light of a single color or a plurality of colors to the front or rear surface. The signal output may be terminated as the terminal detects that the user checks the event.

The interface unit 160 serves as an interface for communication with all external devices connected to the terminal 10. The interface unit 160 receives data or power from an external device and transmits the data to each component in the terminal 10 or allows data in the terminal 10 to be transmitted to an external device. For example, a wired/wireless headset port, an external charger port, a wired/wireless data port, a memory card port, a port connecting a device having an identification module, an audio input/output (I/O) port, a video I/O port, an earphone port, and the like may be included in the interface unit 160.

Meanwhile, the identification module may include a user identification module (UIM), a subscriber identity module (SIM), a universal subscriber identity module (USIM), and the like, as a chip storing various information for authenticating authority to use the terminal 10. A device including the identification module (hereinafter referred to as “identification device”) may be manufactured in a smart card form. Accordingly, the identification device may be connected to the terminal 100 through the interface unit 160.

When the terminal 10 is connected with an external cradle, the interface unit 160 may serve as an interface to allow power from the cradle to be supplied to the terminal 10 or may serve as an interface to allow various command signals input by the user from the cradle to be transferred to the terminal 10 therethrough. Various command signals or power input from the cradle may operate as signals for recognizing that the terminal 10 is properly mounted on the cradle.

The memory 170 may store a program for the operation of the processor 180 and temporarily store input/output data (e.g., a phone book, a message, a still image, a moving picture, etc.). The memory 170 may store data related to vibration and sound of various patterns output when a touch is input on the touch screen.

The memory 170 may include at least one of a flash memory type, a hard disk type, a solid state disk type, a silicon disk drive (SDD) type, a multimedia card micro type, a card type memory (e.g., SD or XD memory, etc.), a random access memory (RAM), static random access memory (SRAM), read-only memory (ROM), an electrically erasable programmable read-only memory (EEPROM), programmable read-only memory (PROM), magnetic memory, magnetic disk, and optical disk. The terminal 10 may be operated in association with a web storage that performs a storage function of the memory 170 on the internet.

Meanwhile, as described above, the processor 180 controls an operation related to an application program and an overall operation of the terminal 10. For example, the processor 180 may execute or release a lock state that restricts input of a user's control command for applications if a state of the terminal meets a set condition.

In addition, the processor 180 may perform control and processing related to a voice call, data communication, video call, and the like, or perform pattern recognition that recognizes handwriting input or drawing input performed on the touch screen as characters and images. Further, the processor 180 may control any one or a combination of a plurality of the above-described components in order to implement various embodiments described below on the terminal 10 according to the present invention.

The power supply unit 190 receives external power and internal power and supplies power required for an operation of each component under the control of the processor 180. The power supply unit 190 includes a battery, the battery may be an internal battery configured to be chargeable or may be detachably coupled to the terminal body for charging or the like.

In addition, the power supply unit 190 may include a connection port, and the connection port may be configured as an example of the interface 160 in which an external charger for supplying power is electrically connected to charge the battery

As another example, the power supply unit 190 may be configured to charge the battery in a wireless manner without using the connection port. In this case, the power supply unit 190 may receive power using at least one of an inductive coupling method based on a magnetic induction phenomenon from an external wireless power transmission device and a magnetic resonance coupling method based on an electromagnetic resonance phenomenon.

Meanwhile, hereinafter, various embodiments may be implemented in a recording medium readable by a computer or similar device using, for example, software, hardware, or a combination thereof.

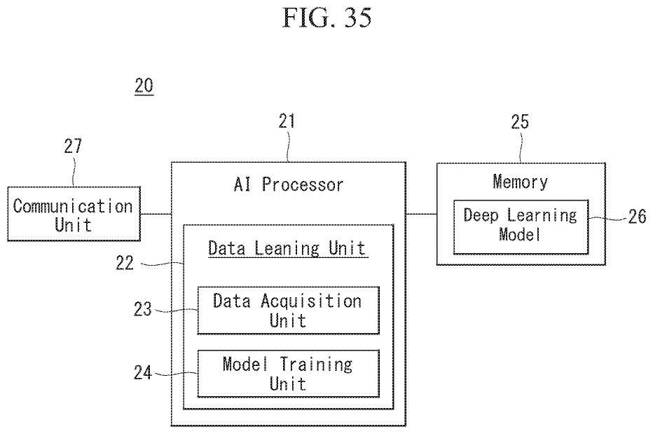

FIG. 35 is a block diagram illustrating an example of the controller in FIG. 34.

As illustrated in FIG. 35, the controller 180 of FIG. 34 may be an AI device 20, but is not necessarily limited thereto.

The AI device 20 may include an electronic device including an AI module capable of performing AI processing or a server including the AI module. In addition, the AI device 20 may be included in at least a part of the intelligent service providing apparatus 100 illustrated in FIG. 34 and may be provided to perform at least some of the AI processing together.

The AI processing may include all operations related to the control of the intelligent service providing apparatus 100 illustrated in FIG. 34. For example, the intelligent service providing apparatus 100 may AI process the sensing data or the acquired data to perform processing/determination and control signal generation. In addition, for example, the intelligent service providing apparatus 100 may AI process the data received through the communication unit to perform control of the intelligent electronic device.

The AI device 20 may be a client device that directly uses the AI processing result or may be a device in a cloud environment that provides the AI processing result to another device.

The AI device 20 may include an AI processor 21, a memory 25, and/or a communication unit 27.

The AI device 20 is a computing device capable of learning neural networks, and may be implemented as various electronic devices such as a server, a desktop PC, a notebook PC, a tablet PC, and the like.

The AI processor 21 may learn a neural network using a program stored in the memory 25. In particular, the AI processor 21 may learn a neural network for obtaining estimated noise information by analyzing the operating state of each speech providing device. In this case, the neural network for outputting estimated noise information may be designed to simulate the human's brain structure on a computer, and may include a plurality of network nodes having weight and simulating the neurons of the human's neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, speech providing, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by obtaining learning data to be used for learning and by applying the obtained learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data obtaining unit 23 and a model learning unit 24.

The learning data acquisition unit 23 may obtain training data for a neural network model for classifying and recognizing data. For example, the learning data acquisition unit 23 may obtain an operating state to be input to the neural network model and/or a feature value, extracted from the operating state, as the training data.

The model learning unit 24 can perform learning such that a neural network model has a determination reference about how to classify predetermined data, using the obtained learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The training data preprocessor may pre-process an obtained operating state so that the obtained operating state may be used for training for recognizing estimated noise information. For example, the training data preprocessor may process an obtained operating state in a preset format so that the model training unit 24 may use obtained training data for training for recognizing estimated noise information.

Furthermore, the training data selection unit may select data for training among training data obtained by the learning data acquisition unit 23 or training data pre-processed by the preprocessor. The selected training data may be provided to the model training unit 24. For example, the training data selection unit may select only data for a syllable, included in a specific region, as training data by detecting the specific region in the feature values of an operating state obtained by the speech providing device 10.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

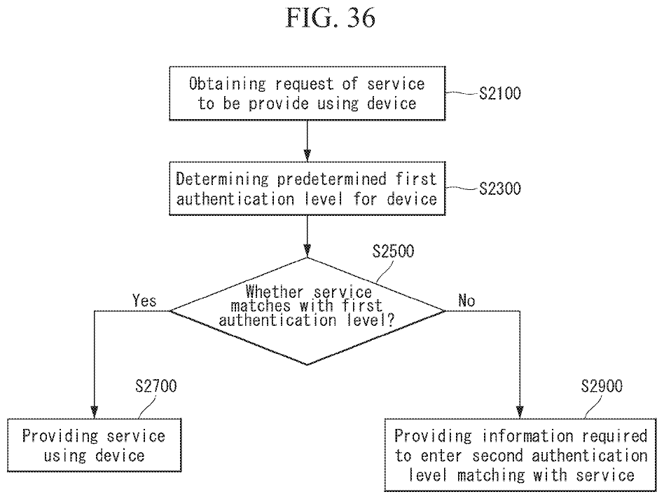

FIG. 36 is a flow chart illustrating an intelligent service providing method according to an embodiment of the present invention.

As shown in FIG. 36, according to an embodiment of the present invention, the intelligent service providing apparatus 100 may first obtain a request of a service provided using a device S2100. For example, the service providing apparatus may be an intelligent service providing apparatus 100, for example, smart refrigerators, smart TVs, smart cars, etc., but is not necessarily limited thereto.

The intelligent service providing apparatus 100 may then determine a predetermined first authentication level for the device at step S2300. For example, prior to obtaining an access request to the service, the intelligent service providing apparatus 100 may obtain an authentication request of configuring an authentication level for the device in advance and may configure the authentication level for the device in response to the authentication request.

The intelligent service providing apparatus 100 may then determine whether the access-requested service matches the first authentication level configured for the device at S2500. For example, the intelligent service providing apparatus 100 may determine whether the access-requested service is a service that may be provided at the first authentication level configured for the device.

Upon determination that the access-requested service is a service matching the first authentication level configured for the device, the intelligent service providing apparatus 100 may provide the requested service using the device 52700.

Otherwise, upon determination that the access-requested service does not match the first authentication level configured for the device, the intelligent service providing apparatus 100 may provide information to enter a second authentication level matching the requested service 52900.

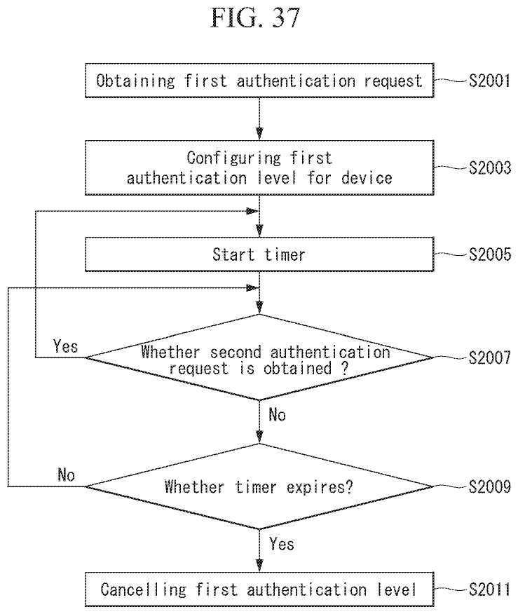

FIG. 37 is a flow chart showing a method for configuring the authentication level according to one embodiment of the present invention.

As shown in FIG. 37, according to one embodiment of the present invention, the intelligent service providing apparatus 100 may acquire a first authentication request of configuring a first authentication level for the device (intelligent service providing apparatus 100) from the user (S2001).

The intelligent service providing apparatus 100 may then configured the first authentication level for the device (intelligent service providing apparatus 100) in response to the first authentication request (S2003)

Then, the intelligent service providing apparatus 100 starts a timer from the time when the first authentication level has been configured for the device at step S2005.

The intelligent service providing apparatus 100 may determine whether or not a second authentication request is obtained after the timer starts (S2007). For example, the second authentication request may be an authentication request that requests of configuring the second authentication level for the device.

Upon determination that the second authentication request is obtained, the intelligent service providing apparatus 100 restarts the timer (S2005).

Upon determination that the second authentication request is not obtained, the intelligent service providing apparatus 100 may determine whether the timer has expired (S2009).

Upon determination that the timer has not expired, the intelligent service providing apparatus 100 waits until obtaining the second authentication request (S2007).

Upon determination that the timer expires, the intelligent service providing apparatus 100 may cancel the first authentication level configured for the device at step S2011.

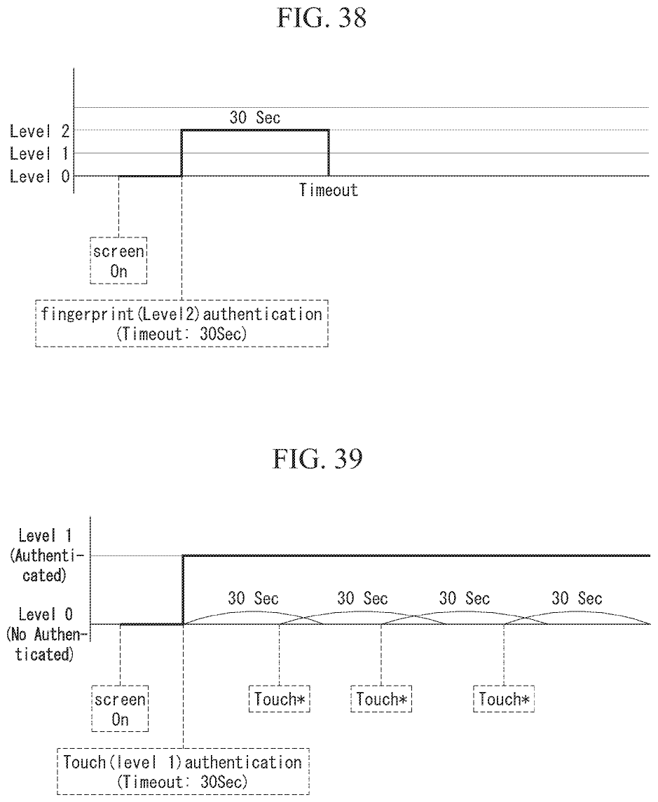

FIG. 38 shows an example of a graph showing authentication levels over time.

As shown in FIG. 38, according to an embodiment of the present invention, the intelligent service providing apparatus 100 may acquire a fingerprint (level 2) authentication after a screen is turned on, and may configure the authentication level for the device to the level 2 in response to the fingerprint authentication.

When the timer starts after the authentication level for the device is configured to the level 2 and, then when a predetermined time, for example, 30 seconds, elapses, the timer expires. When the timer expires, the intelligent service providing apparatus 100 may cancel the authentication level (level 2) configured for the device and return to the default authentication level (level 0).

FIG. 39 shows another example of a graph showing authentication levels over time.

As shown in FIG. 39, according to an embodiment of the present invention, when the intelligent service providing apparatus 100 receives a touch authentication (level 1) on the screen in a turned on state thereof, the apparatus 100 may change the authentication level for the device from the default authentication level (level 0) to the first authentication level (level 1). The intelligent service providing apparatus 100 may then reconfigure the timer each time the apparatus receives a touch input before the timer has expired (before 30 seconds elapse since the first authentication level has been set).

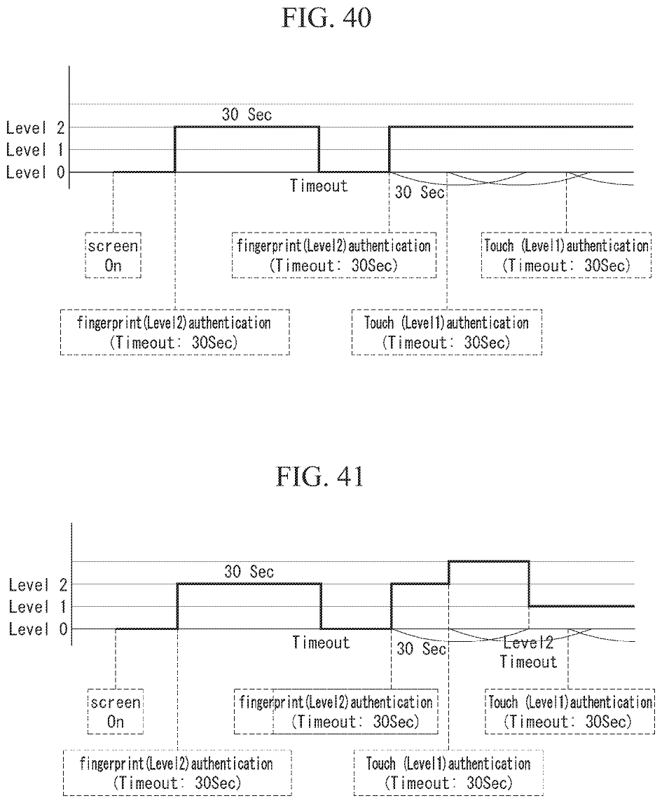

FIG. 40 shows another example of a graph showing authentication levels over time.

As shown in FIG. 40, according to an embodiment of the present invention, when the intelligent service providing apparatus 100 receives a fingerprint authentication (level 2) on the screen in a turned on state thereof, the apparatus may change the authentication level for the device from the default authentication level (level 0) to the second authentication level (level 2).

Then, when the timer expires, the intelligent service providing apparatus 100 may cancel the second authentication level.

In this connection, the apparatus may reconfigure the timer each time the apparatus receives a first authentication request (touch input) whose authentication level is lower than an authentication level of the second authentication level request, after the new fingerprint authentication is carried out and before the expiration of the next timer (before 30 seconds elapses after configuring the second authentication level).

FIG. 41 shows another example of a graph showing authentication levels over time.

As shown in FIG. 41, according to an embodiment of the present invention, when the intelligent service providing apparatus 100 receives a fingerprint authentication (level 2) on the screen at a turned on state thereof, the apparatus may change the authentication level for the device from the default authentication level (level 0) to the second authentication level (level 2).

Then, when the timer expires, the intelligent service providing apparatus 100 may cancel the second authentication level.

In this connection, the apparatus may reconfigure the timer each time the apparatus receives a first authentication request (touch input) whose authentication level is lower than an authentication level of the second authentication level request, after the new fingerprint authentication is carried out and before the expiration of the next timer (before 30 seconds elapses after configuring the second authentication level), and, at the same time, may change the current authentication level to a higher level (for example, level 3) than the level 2.

Further, after the apparatus reconfigures the timer each time the apparatus receives a first authentication request (touch input) whose authentication level is lower than an authentication level of the second authentication level request and changes the current authentication level to the higher level (for example, level 3) than the level 2, the timer may expire after configuring the second authentication level. In this case, the second authentication level may be canceled, but the first authentication level corresponding to the first authentication request invoking the reconfiguring of the timer may be maintained.

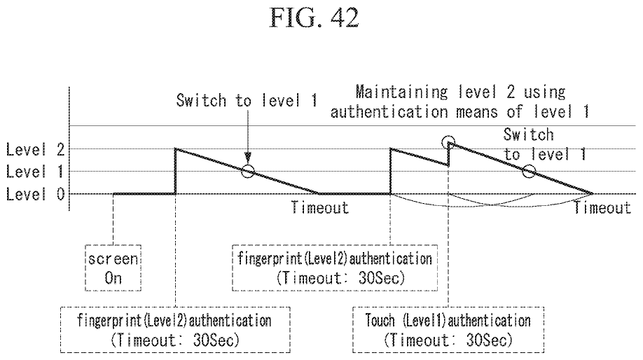

FIG. 42 shows another example of a graph showing authentication levels over time.

As shown in FIG. 42, according to an embodiment of the present invention, when the intelligent service providing apparatus 100 receives a fingerprint authentication (level 2) on the screen at a turned on state thereof, the apparatus may change the authentication level for the device from the default authentication level (level 0) to the second authentication level (level 2).

Then, when the timer expires, the intelligent service providing apparatus 100 may cancel the second authentication level. In this connection, when 30 seconds have elapsed since the level 2 has been set, the apparatus may not change the level directly from the level 2 to the level 0, but may change gradually the authentication level from the level 2 through the level 1 to the level 0 for 30 seconds after the level 2 has been configured.

Further, in this connection, the apparatus may reconfigure the timer each time the apparatus receives a first authentication request (touch input) whose authentication level is lower than an authentication level of the second authentication level request, after the new fingerprint authentication is carried out and before the expiration of the next timer (before 30 seconds elapses after configuring the second authentication level), and, at the same time, may change the current authentication level (a level to which the authentication level has been lowered gradually from the level 2) to the level 2.

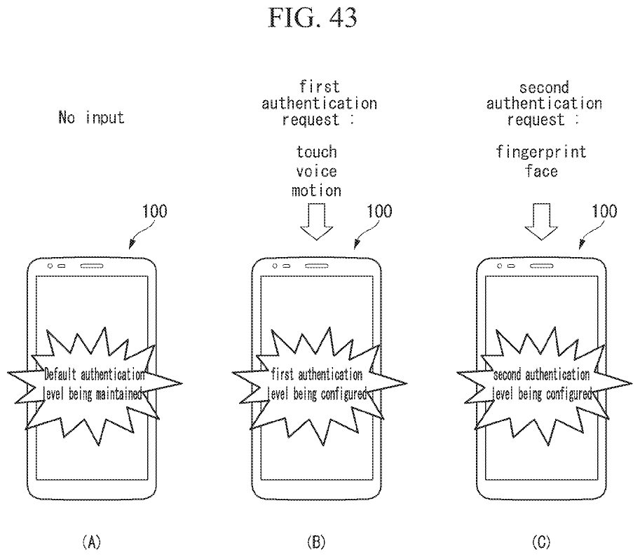

FIG. 43 shows a process for the authentication request and authentication level configuring for a mobile terminal.

As shown in FIG. 43A, when there is no input, the intelligent service providing apparatus 100 may maintain the default authentication level.

As shown in FIG. 43B, the intelligent service providing apparatus 100 may receive first authentication request (touch, voice, and motion inputs). In response, the first authentication level may be configured for the intelligent service providing apparatus.

As shown in FIG. 43C, the intelligent service providing apparatus 100 may receive a second authentication request (fingerprint, face input). In response, the second authentication level may be configured for the intelligent service providing apparatus.

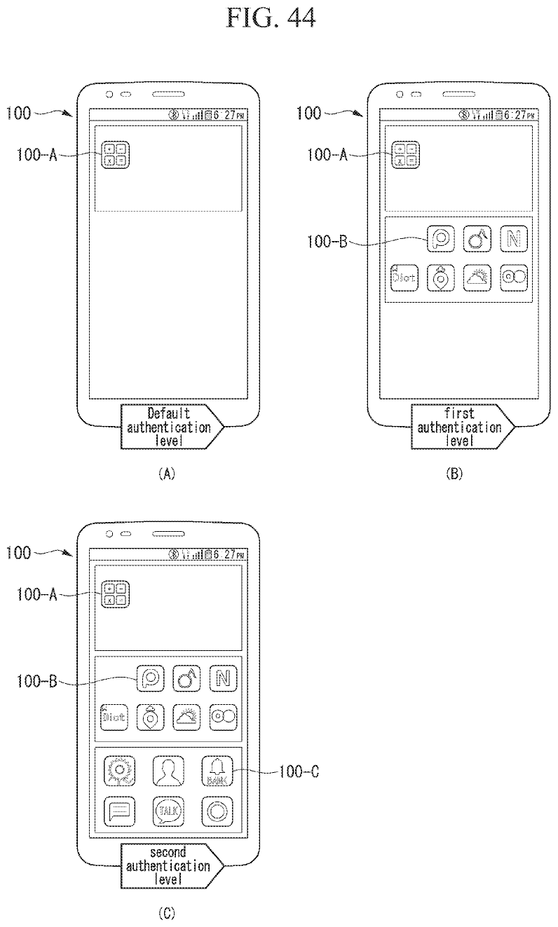

FIG. 44 shows the service provided according to each authentication level of the mobile terminal.

As shown in FIG. 44A, when the default authentication level is configured for the intelligent service providing apparatus 100, the intelligent service providing apparatus 100 may execute a plurality of A applications. That is, when the default authentication level is configured for the intelligent service providing apparatus 100, the intelligent service providing apparatus 100 may allow access for the execution of the plurality of A applications. Further, when the default authentication level is configured for the intelligent service providing device 100, the intelligent service providing apparatus 100 may display an icon 100-A of the plurality of A applications on the touch screen.

As shown in FIG. 44B, when the default authentication level is configured for the intelligent service providing apparatus 100, the intelligent service providing apparatus 100 may execute a plurality of A applications and a plurality of B applications. That is, when the default authentication level is configured for the intelligent service providing apparatus 100, the intelligent service providing apparatus 100 may allow access for execution of a plurality of A applications and a plurality of B applications. Further, when the default authentication level is configured for the intelligent service providing device 100, the intelligent service providing apparatus 100 may display the icon 100-A of the plurality of A application and an icon 100-B of the plurality of applications B on the touch screen.

As shown in FIG. 44C, when the default authentication level is configured for the intelligent service providing apparatus 100, the intelligent service providing apparatus 100 may execute a plurality of A applications, a plurality of B applications and a plurality of C applications. That is, when the default authentication level is configured for the intelligent service providing apparatus 100, the intelligent service providing apparatus 100 may allow access for execution of a plurality of A applications, a plurality of B applications and a plurality of C applications. Further, when the default authentication level is configured for the intelligent service providing device 100, the intelligent service providing apparatus 100 may display an icon 100-A of the plurality of A application, an icon 100-B of a plurality of B application and an icon 100-C of the plurality of C applications on the touch screen.

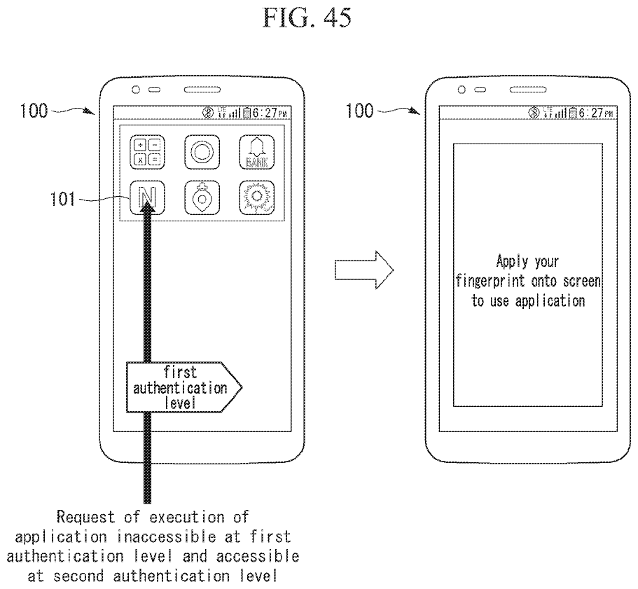

FIG. 45 shows an example of obtaining an application execution request while the first authentication level has been configured.

As shown in FIG. 45, while the first authentication level is configured for the intelligent service providing apparatus, the intelligent service providing apparatus 100 may obtain an execution request of an application accessible at the first authentication level.

When the apparatus obtains the execution request of the application that is accessible at the first authentication level, the intelligent service providing apparatus 100 may determine whether the execution-requested application is accessible at (or matches with) the first authentication level.

When the execution-requested application is determined to be accessible at the first authentication level, the intelligent service providing apparatus may execute the corresponding application. Then, an execution screen of the application may be displayed on the touch screen.

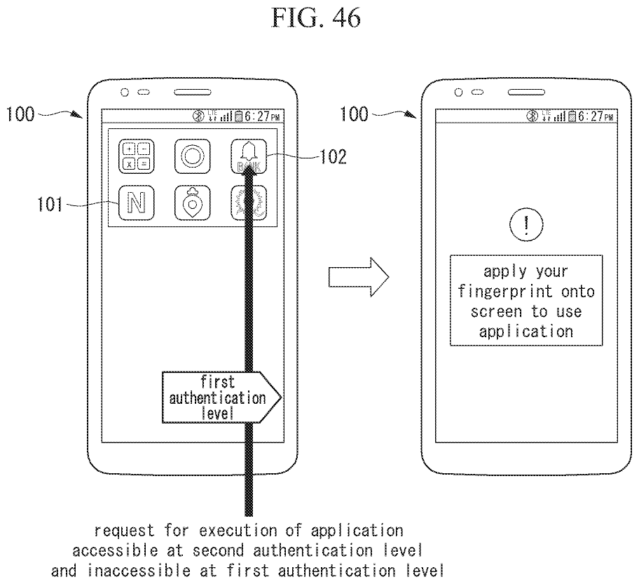

FIG. 46 shows an example of obtaining an application execution request while the first authentication level has been configured.

As shown in FIG. 46, while the first authentication level is configured for the intelligent service providing apparatus, the intelligent service providing apparatus 100 may obtain an execution request of an application that is not accessible at the first authentication level but is accessible at the second authentication level.

When the apparatus obtains the execution request of the application that is accessible at the second authentication level, the intelligent service providing apparatus 100 may determine whether the application requested to be executed is accessible at (or matches with) the first authentication level.

When the execution-requested application is determined to be inaccessible at the first authentication level, the intelligent service providing apparatus 100 does not execute the corresponding application but recommends the second authentication level, which is the authentication level matching with the requested application. Specifically, the intelligent service providing apparatus 100 may display an indication on the touch screen to perform fingerprint authentication as an authentication request required to enter the second authentication level.

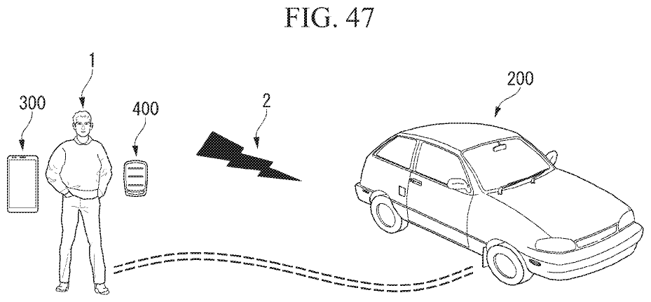

FIG. 47 shows an intelligent service providing system according to one of the other embodiments of the present invention.

As shown in FIG. 47, according to another embodiment of the present invention, an intelligent service providing system may include a mobile terminal 300, a smart key 400, and a vehicle type intelligent service providing apparatus 200 for establishing a wireless network 2 with a smart key. In this connection, the intelligent service providing apparatus 200 may be an intelligent service providing apparatus as described with reference to FIG. 34 to FIG. 46.

The mobile terminal 300 and the smart key 400 may receive an authentication request requesting the user 1 to configure the authentication level. Further, the mobile terminal 300 and the smart key 400 may receive, from the user 1, an access request requesting a specific service provided by the intelligent service providing apparatus 200.

The intelligent service providing apparatus 200 may configure the authentication level based on the authentication request received from the mobile terminal 300 or the smart key 400. Further, the intelligent service providing apparatus 200 may provide the access-requested service in response to the access request received from the mobile terminal 300 or smart key 400.

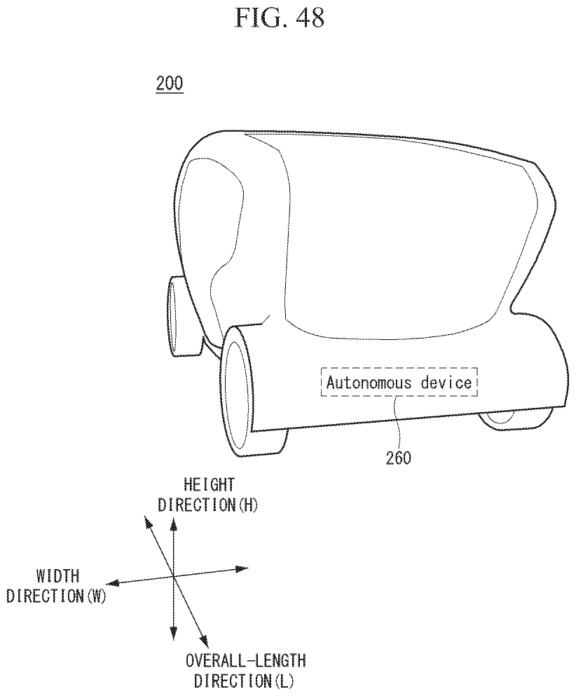

FIG. 48 shows an example of the vehicle in FIG. 47.

As shown in FIG. 48, the intelligent service providing apparatus 200 according to one of the other embodiments of the present invention is defined as transportation means running on roads or railways. The intelligent service providing apparatus 200 may include cars, trains, and motorcycles. The intelligent service providing apparatus 200 may include an internal combustion engine vehicle having an engine as a power source, a hybrid vehicle having an engine and an electric motor as a power source, and an electric vehicle having an electric motor as a power source. The intelligent service providing apparatus 200 may be an individual owned vehicle. The intelligent service providing apparatus 200 may be a shared vehicle. The intelligent service providing apparatus 200 may be an autonomous driving vehicle.

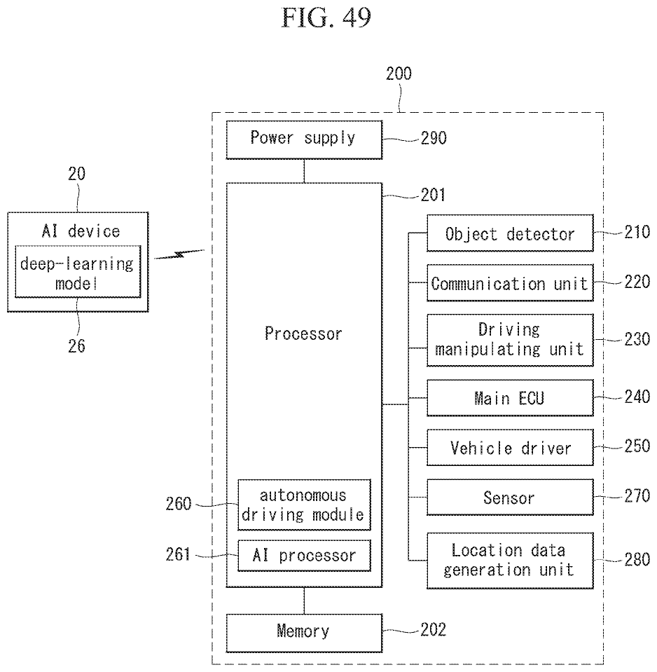

FIG. 49 is a block diagram showing a detailed configuration of the autonomous driving vehicle of FIG. 48.

Referring to FIG. 49, the autonomous driving intelligent service providing apparatus 200 may transmit data required to be subjected to AI processing to an AI device 20 using a communication unit. The AI device 20 including the deep-learning model 26 may transmit the AI processing result using the deep-learning model 26 to the autonomous driving intelligent service providing apparatus 200. The details about the AI device 20 may refer to the description in FIG. 35.

The autonomous driving intelligent service providing apparatus 200 may include a memory 140, a processor 170, and a power supply 190. The processor 170 may further include an autonomous driving module 260 and an AI processor 261. Further, the autonomous driving intelligent service providing apparatus 200 may include an interface that may be connected to at least one electronic device provided in the vehicle in a wired or wireless manner to exchange data necessary for autonomous driving control therewith. The at least one electronic device connected thereto using the interface may include an object detector 210, a communication unit 220, a driving manipulating unit 230, a main ECU 240, a vehicle driver 250, a sensor 270, and a location data generation unit 280.

The interface may comprise at least one of a communication module, a terminal, a pin, a cable, a port, a circuit, an element and a device.

The memory 140 is electrically connected to the processor 170. The memory 140 may store basic data about the unit, control data for controlling the operation of the unit, and data as input/output. The memory 140 may store data processed by the processor 170. The memory 140 may be composed of at least one of ROM, RAM, EPROM, flash drive, and hard drive in hardware. The memory 140 may store various data for operation of the autonomous driving intelligent service providing apparatus 200, such as a program for processing or controlling the processor 170. The memory 140 may be implemented integrally with the processor 170. Depending on the embodiments, the memory 140 may be categorized as a sub-component of the processor 170.

The power supply 190 may power autonomous driving device 10. The power supply 190 may receive power from a power source (e.g., battery) included in the autonomous driving intelligent service providing apparatus 200, and supply the power to each unit of the autonomous driving intelligent service providing apparatus 200. The power supply 190 may be operated according to a control signal provided from the main ECU 240. The power supply 190 may include an SMPS (switched-mode power supply).

The processor 170 may be electrically coupled to the memory 140, interface 280, and power supply 190 to exchange signals therewith. The processor 170 may be implemented using at last one of an ASIC (application specific integrated circuit), DSPs (digital signal processors), DSPs (digital signal processing devices), PLDs (programmable logic devices), FPGAs (field programmable gate arrays), processors, controllers, microcontrollers or microprocessors or the electrical units for execution of the functions.

The processor 170 may be driven by the power provided from a power supply 190. The processor 170 receives data, processes data, generates signals, or supplies signals in a state where the power is supplied thereto from the power supply 190.

The processor 170 may receive information from other electronic devices in the autonomous driving intelligent service providing apparatus 200 using an interface. The processor 170 may provide control signals to the other electronic devices within the autonomous driving intelligent service providing apparatus 200 using the interface.

The autonomous driving intelligent service providing apparatus 200 may include at least one printed circuit board (PCB). The memory 140, interface, power supply 190, and processor 170 may be electrically connected to the printed circuit board.

Hereinafter, other electronic devices and the AI processor 261 and the autonomous driving module 260 in the vehicle as connected to the interface will be described in more detail. Hereinafter, the autonomous driving intelligent service providing apparatus 200 will be referred to as an intelligent service providing apparatus 200 for convenience of explanation.

First, the object detector 210 may generate information about an object outside the intelligent service providing apparatus 200. The AI processor 261 applies a neural network model to the data obtained using the object detector 210. Thus, at least one of the absence or presence of the object, the position information of the object, the distance information between the vehicle and the object, and the relative speed information between the vehicle and the object may be generated by the AI processor 261.

The object detector 210 may include at least one sensor capable of detecting an object outside the intelligent service providing apparatus 200. The sensor may include at least one of a camera, a radar, a lidar, an ultrasonic sensor, and an infrared sensor. The object detector 210 may provide data about the object generated based on the sensing signal as generated by the sensor to at least one electronic device included in the vehicle.

Further, the intelligent service providing apparatus 200 transmits data acquired using the at least one sensor to the AI device 20 using the communication unit 220. The AI device 20 may apply the neural network model 26 to the transmitted data and transmit the generated AI processed data to the intelligent service providing apparatus 200. The intelligent service providing apparatus 200 recognizes information on the detected object based on the received AI processed data. Thus, the autonomous driving module 260 may perform autonomous driving control operations using the recognized information.

The communication unit 220 may exchange signals with devices located outside the intelligent service providing apparatus 200. The communication unit 220 may exchange signals with at least one of an infrastructure (for example, a server, a broadcasting station), another vehicle, or a terminal. The communication unit 220 may include at least one of a transmitting antenna, a receiving antenna, an RF (Radio Frequency) circuit and an RF device capable of implementing various communication protocols to perform communication.

Applying the neural network model to the data obtained using the object detector 210 may result in generating at least one of presence or absence of object, position information of object, distance information of the vehicle and object, and relative speed information between vehicle and object.

The driving manipulating unit 230 is a device that receives a user input for driving. In the manual mode, the intelligent service providing apparatus 200 may be operated based on signals provided by the driving manipulating unit 230. The driving manipulating unit 230 may include a steering input device, for example, a steering wheel, an acceleration input device, for example, an accelerator pedal and a brake input device, for example, a brake pedal.

Further, in the autonomous driving mode, the AI processor 261 may generate an input signal of the driver manipulation unit 230 according to a signal for controlling the vehicle movement according to the driving plan generated using the autonomous driving module 260.

Further, the intelligent service providing apparatus 200 transmits data necessary for controlling the driver manipulation unit 230 to the AI device 20 using the communication unit 220. The AI device 20 may apply the neural network model 26 to the transmitted data and then transmit the generated AI processed data to the intelligent service providing apparatus 200. Thus, the intelligent service providing apparatus 200 may use the input signal of the driver manipulation unit 230 for vehicle motion control based on the received AI processed data.

The main ECU 240 may control the overall operation of the at least one electronic device provided in the intelligent service providing apparatus 200.

The vehicle driver 250 is a device that electrically controls various vehicle driving devices in the intelligent service providing apparatus 200. The vehicle driver 250 may include a powertrain drive control device, a chassis drive control device, a door/window drive control device, a safety device drive control device, a lamp drive control device, and an air conditioning drive control device. The powertrain drive control device may include a power source drive control device and a transmission drive control device. The chassis drive control device may include a steering drive control device, a brake drive control device, and a suspension drive control device. Further, the safety device drive control device may include a seat belt drive control device for seat belt control.

The vehicle driver 250 may include at least one electronic control device, for example, control ECU (Electronic Control Unit).

The vehicle driver 250 may control the power train, the steering device, and the brake device based on signals received from the autonomous driving module 260. The signal received from the autonomous driving module 260 may be a driving control signal generated by applying the neural network model to the vehicle-related data using the AI processor 261. The drive control signal may be a signal received from an external AI device 20 using the communication unit 220.

The sensor 270 may sense the state of the vehicle. The sensor 270 may include at least one of an IMU (inertial measurement unit sensor), a crash sensor, a wheel sensor wheel sensor, a speed sensor, a tilt sensor, a weight sensor, a heading sensor, position module, vehicle forward/reverse sensor, battery sensor, fuel sensor, tire sensor, steering sensor, a temperature sensor, a humidity sensor, an ultrasonic sensor, an illuminance sensor, and a pedal position sensor. Further, the IMU (inertial measurement unit) sensor may include at least one of an acceleration sensor, a gyro sensor, and a magnetic sensor.

The AI processor 261 may generate vehicle state data by applying the neural network model to the sensing data generated by the at least one sensor. The AI processing data generated by applying the neural network model include vehicle orientation data, vehicle motion data, vehicle yaw data, vehicle roll data, vehicle pitch data, vehicle collision data, vehicle direction data, vehicle angle data, vehicle speed data, vehicle acceleration data, vehicle slope data, vehicle forward/backward data, vehicle weight data, battery data, fuel data, tire air pressure data, vehicle internal temperature data, vehicle internal humidity data, steering wheel rotation angle data, vehicle exterior brightness data, pressure data to be applied to the accelerator pedal, and pressure data to be applied to the brake pedal, etc.

The autonomous driving module 260 may generate the driving control signal based on the AI processed state data of the vehicle.

Further, the intelligent service providing apparatus 200 transmits the sensing data obtained using the at least one sensor to the AI device 20 using the communication unit 22. Then, the AI device 20 may apply the neural network model 26 to the transmitted sensing data and then transmit the generated AI processed data to the intelligent service providing apparatus 200.

The location data generation unit 280 may generate location data of the intelligent service providing apparatus 200. The location data generation unit 280 may include at least one of a GPS (Global Positioning System) and a DGPS (Differential Global Positioning System).

The AI processor 261 may generate more precise vehicle position data by applying the neural network model to the position data generated by the at least one position data generation unit.

According to one embodiment, the AI processor 261 performs a deep-learning operation based on at least one of the IMU (Inertial Measurement Unit) of the sensor 270 and the camera image of the object detection device 210. The position data may be corrected by the AI processor based on the generated AI processed data.

Further, the intelligent service providing apparatus 200 transmits position data obtained from the location data generation unit 280 to the AI device 20 using the communication unit 220. Then, the AI device 20 may apply the neural network model 26 to the received position data and then may transmit the generated AI processed data to the intelligent service providing apparatus 200.

The intelligent service providing apparatus 200 may include an internal communication system 50. A plurality of electronic devices included in the intelligent service providing apparatus 200 may exchange signals via the internal communication system 50. The signal may include data. The internal communication system 50 may use at least one communication protocol, for example, CAN, LIN, FlexRay, MOST, Ethernet.

The autonomous driving module 260 generates a path for autonomous driving based on the acquired data and creates a driving plan for traveling along the generated route.

The autonomous driving module 260 may implement at least one ADAS (Advanced Driver Assistance System) function. The ADAS may implement at least one of ACC (Adaptive Cruise Control) system, AEB (Autonomous Emergency Braking) system, FCW (Forward Collision Warning) system, LKA (Lane Keeping Assist) system, LCA (Lane Change Assist) system, TFA (Target Following Assist) system, BSD (Blind Spot Detection) system, HBA (High Beam Assist) system, APS (Auto Parking System) system, PD (collision warning system) system, TSR (Traffic Sign Recognition) system, TSA (Traffic Sign Assist) system, NV (Night Vision) system, DSM (Driver Status Monitoring) system, and TJA (Traffic Jam Assist) system.

The AI processor 261 applies the traffic-related information received from the external device or the at least one sensor included in the vehicle, and the information received from the other vehicle communicating with the vehicle to the neural network model. Thus, a control signal capable of performing at least one of the ADAS functions as described above may be transmitted from the AI processor 261 to the autonomous driving module 260.

Further, the intelligent service providing apparatus 200 transmits at least one data to perform ADAS functions to the AI device 20 using the communication unit 220. The AI device 20 may apply the neural network model 260 to the received data and thus deliver a control signal capable of performing the ADAS function to the intelligent service providing apparatus 200.

The autonomous driving module 260 may obtain driver status information and/or vehicle status information from the AI processor 261 and perform the switching operation from the autonomous driving mode to the manual driving mode or the switching from the manual driving mode to the autonomous driving mode based on the driver status information and/or vehicle status information.

Further, the intelligent service providing apparatus 200 may utilize AI processed data for passenger support to execute driving control. For example, as described above, the intelligent service providing apparatus 200 may use the at least one sensor provided inside the vehicle to check the status of the driver and the passenger.

Alternatively, the intelligent service providing apparatus 200 may use the AI processor 261 to recognize the voice signal of the driver or occupant, and to perform a voice processing operation and to execute the speech synthesis operation.

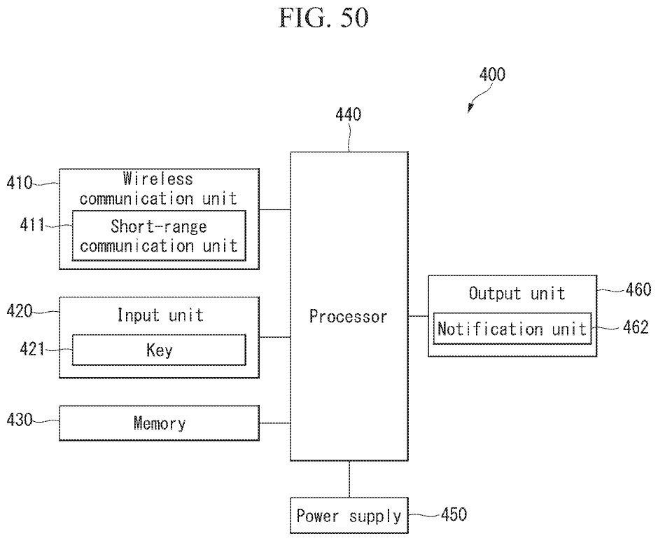

FIG. 50 is a block diagram showing the detailed configuration of the smart key 400 in FIG. 47.

As shown in FIG. 50, the smart key 400 may include a wireless communication unit 410, an input unit 420, a memory 430, a power supply 450, an output unit 460, and a processor 440 for controlling the components.

The wireless communication unit 410 may include a short range communication unit 411 capable of transmitting and receiving necessary data to and from the intelligent service providing apparatus 200. For example, the wireless communication unit 410 may obtain the authentication request of the user and/or an access request to the vehicle service and forward the requests to the intelligent service providing apparatus 200.

The input unit 420 may include a key 421 that includes both a physical key for obtaining an input from a user and a touch key for obtaining fingerprint authentication from the user.

The power supply 450 may power all components of the smart key 400, including the processor 440.

The output unit 460 may include a notification unit 462 that outputs a sound in response to an input of the key 421 from the user.

The processor 440 may control the wireless communication unit 410 to transmit an authentication request or an access request to the intelligent service providing apparatus 200.

For example, the mobile terminal 300 in FIG. 47 may include the same components as those of the smart key 400 in FIG. 50. For example, the mobile terminal 300 in FIG. 47 may perform the same functions as those of the smart key 400 in FIG. 50.

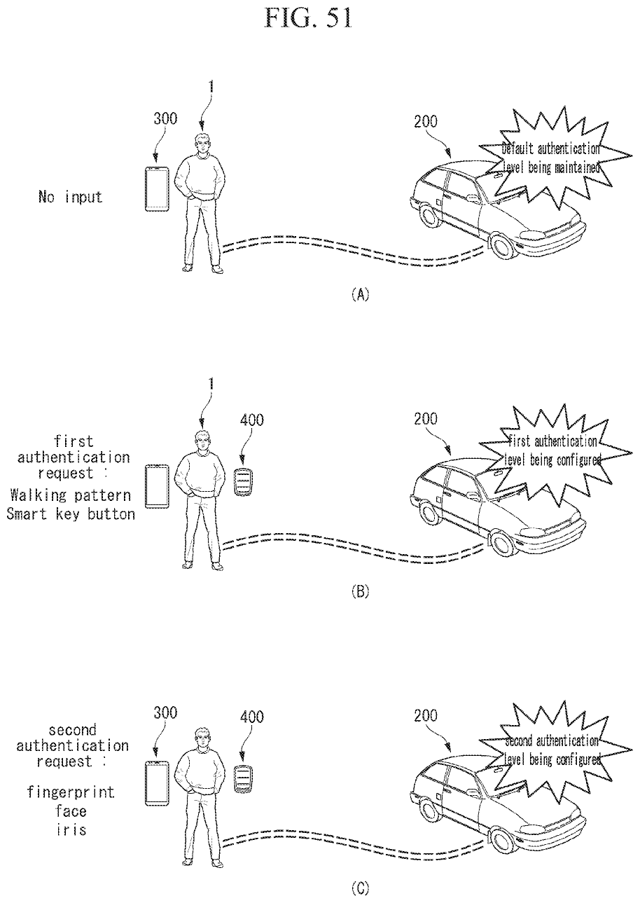

FIG. 51 shows a process of the authentication request and authentication level configuring for the vehicle.

As shown in FIG. 51A, the smart key 400 or the intelligent service providing apparatus 200 may maintain the default authentication level when there is no input from the mobile terminal 300.

As shown in FIG. 51B, the smart key 400 or intelligent service providing apparatus 200 may obtain a first authentication request requesting to configure the first authentication level for the intelligent service providing apparatus 200. For example, the smart key 400 may obtain, as an example of the first authentication request, an input to one of the buttons of the smart key. Further, an intelligent service providing apparatus 200 may recognize or obtain a predetermined walking pattern of the user 1 as an example of the first authentication request.

The intelligent service providing apparatus 200 may obtain the first authentication request directly from the user or obtain the first authentication request from the smart key 400. In response, the first authentication level may be configured for the intelligent service providing apparatus.

As shown in FIG. 51C, the mobile terminal 300 may obtain a second authentication request (fingerprint, face or iris recognition). Further, the smart key 400 may obtain a second authentication request (fingerprint recognition). Further, the intelligent service providing apparatus 200 may obtain the second authentication request (fingerprint, face, and iris recognition).

Upon acquiring the second authentication request, the intelligent service providing apparatus 200 may configure the second authentication level for the intelligent service providing apparatus 200 in response to the second authentication request.

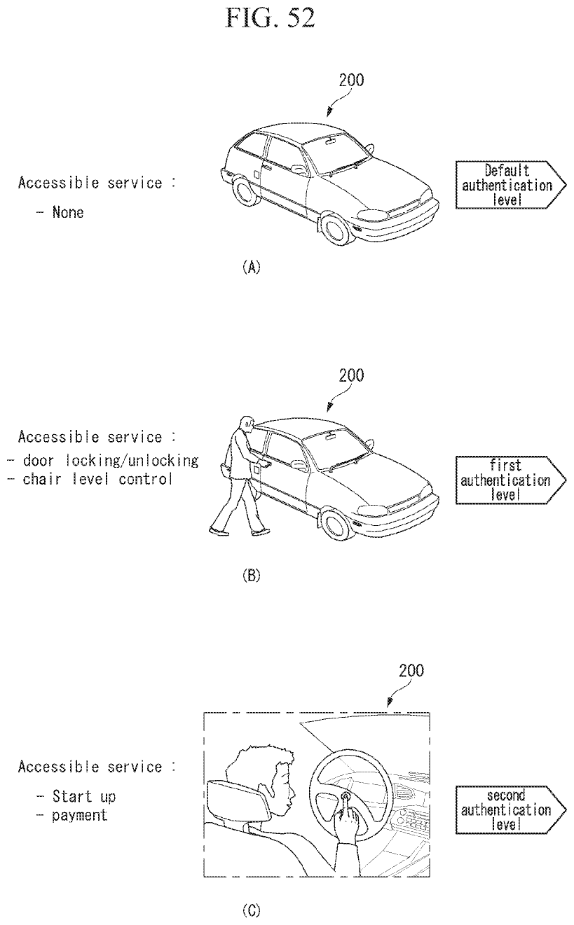

FIG. 52 shows the service provided for each authentication level for the vehicle.

As shown in FIG. 52A, the intelligent service providing apparatus 200 in the form of a vehicle does not have a service corresponding to the default authentication level (when no authentication request is obtained).

As shown in FIG. 52B, the intelligent service providing apparatus 200 may provide a door locking service, a door unlocking service, and a chair position adjustment service at the first authentication level.

As shown in FIG. 52C, the intelligent service providing apparatus 200 may provide a start-up service and a payment service at the second authentication level.

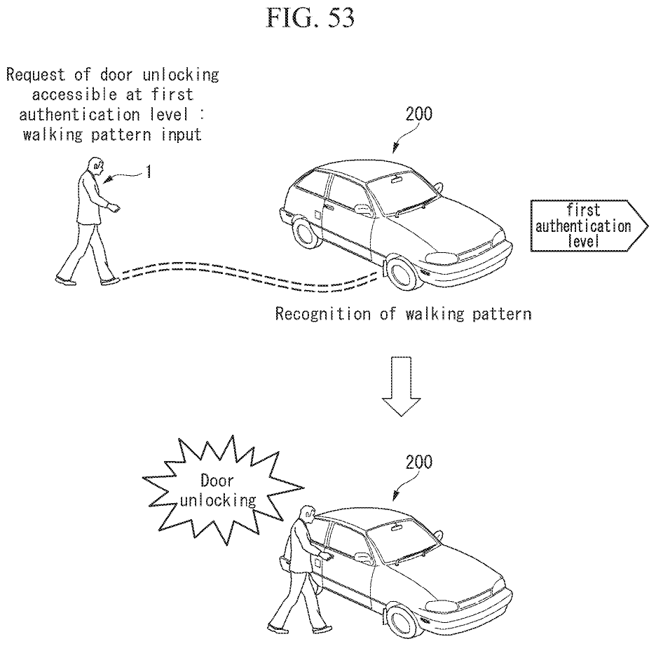

FIG. 53 shows an example of acquiring a door unlocking request while the first authentication level has been configured for the vehicle.

As shown in FIG. 53, the intelligent service providing apparatus 200 may obtain a door unlocking request accessible at the first authentication level while the first authentication level is configured for the intelligent service providing apparatus.

When the apparatus obtains a door unlocking request that is accessible at the first authentication level, the intelligent service providing apparatus 200 may determine whether the requested door unlocking service is accessible at or match with the first authentication level.

When it is determined that the requested door unlocking service is accessible at or match with the first authentication level, the intelligent service providing apparatus 200 may cancel the door locking.

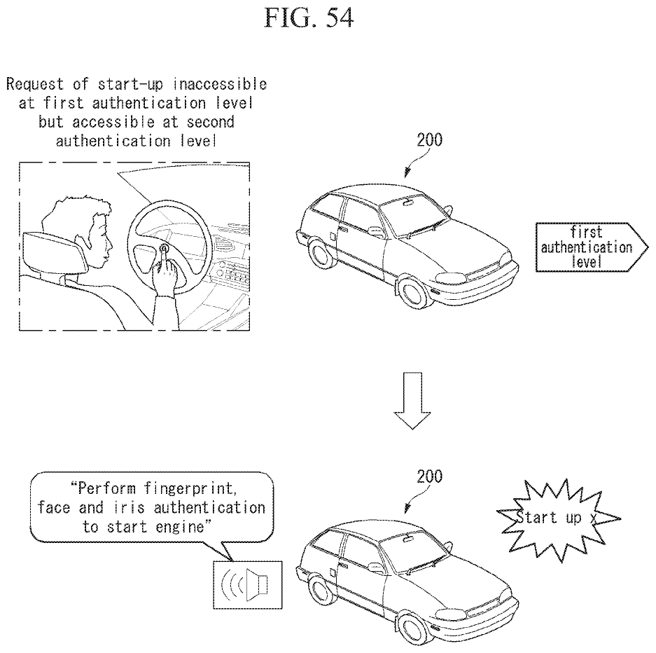

FIG. 54 shows an example of obtaining a start-up request while the first authentication level is configured for the vehicle.

As shown in FIG. 54, the intelligent service providing apparatus 200 may obtain a start-up request that matches the second authentication level or is accessible at the second authentication level while the first authentication level is configured for the intelligent service providing apparatus.

Upon obtaining the start-up request, the intelligent service providing apparatus 200 may determine whether the requested start-up service is an accessible service at the first authentication level, which is the current authentication level.

When it is determined that the requested start-up service is not an accessible service at the first authentication level, which is the current authentication level, the intelligent service providing apparatus 200 does not start the vehicle but may recommend a second authentication level as an authentication level that matches the start-up service. Specifically, the intelligent service providing apparatus 200 transmits a voice to instruct performing the face or iris or fingerprint authentication as an authentication request required to enter the second authentication level. For example, the voice may be “Please perform fingerprint/face/iris authentication to start the vehicle”.

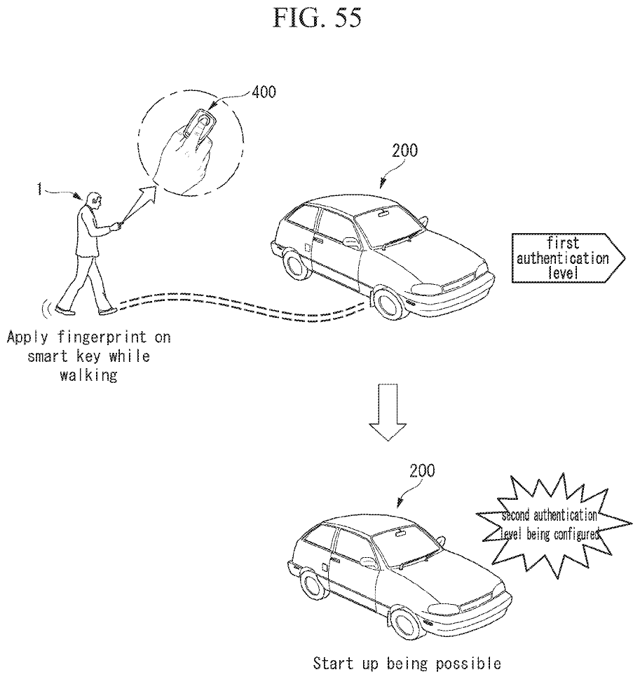

FIG. 55 shows one process in which the vehicle obtains a second authentication request.

As shown in FIG. 55, when the user 1 apply a fingerprint on the fingerprint recognition button of the smart key 400, the smart key 400 recognizes this application as the second authentication request corresponding to the second authentication level. Thus, the second authentication request may be sent from the smart key 400 to the intelligent service providing apparatus 200.

When the second authentication request is obtained by the intelligent service providing apparatus 200 for which the first authentication level has been configured, the intelligent service providing apparatus 200 may change the first level to the second authentication level in response to the second authentication request.

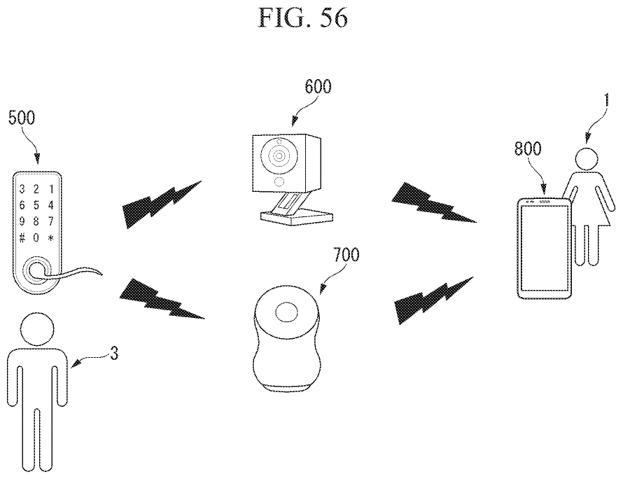

FIG. 56 shows an intelligent service provisioning system according to another embodiment of the present invention.

As shown in FIG. 56, according to another embodiment of the present invention, the intelligent service providing system may include a mobile terminal 800, a camera 600, a robot 700, and an intelligent service providing apparatus 500 in the form of a door lock.

The intelligent service providing apparatus 500 may obtain an authentication request or an access request to an intelligent service providing apparatus 500 from an external party 3. The intelligent service providing apparatus 500 may command the image capture to the camera 600 or robot 700 in response to the authentication request or access request.

The camera 600 and/or the robot 700 may transmit the photographed image to the mobile terminal 800 of the user 1.

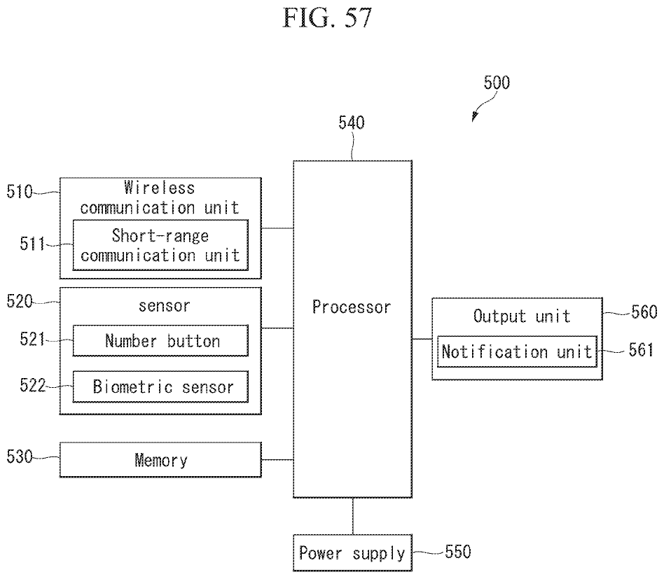

FIG. 57 shows the detailed configuration of the intelligent service providing apparatus 500 of FIG. 56.

As shown in FIG. 57, the intelligent service providing apparatus 500 may include a wireless communication unit 510, a sensor 520, a memory 530, a power supply 550, an output unit 560, and a processor 540 controlling the components.

The wireless communication unit 510 may include a short range communication unit 511 for performing wireless communication with the camera 600 and the robot 700. Specifically, the wireless communication unit 510 may transmit a photographing command to the camera 600 and the robot 700 under the control of the processor 540.

The sensor 520 may include a plurality of number buttons 521 for obtaining a first authentication request and a plurality of biometric sensors 522 for acquiring a second authentication request, for example, fingerprint authentication.

The memory 530 may store information necessary for the processor 540 to control the remaining components.

The power supply 550 may power all components of the intelligent service providing apparatus 500, including the processor 540.

The output unit 560 may include a notification unit 561 for outputting sound in response to an input of a number button 521 of the user.

The processor 540 may configure an authentication level for the intelligent service providing apparatus 500 based on the authentication request obtained by the sensor 520. Further, processor 540 may cancel the door locking based on an access request to the service acquired by the sensor 520.

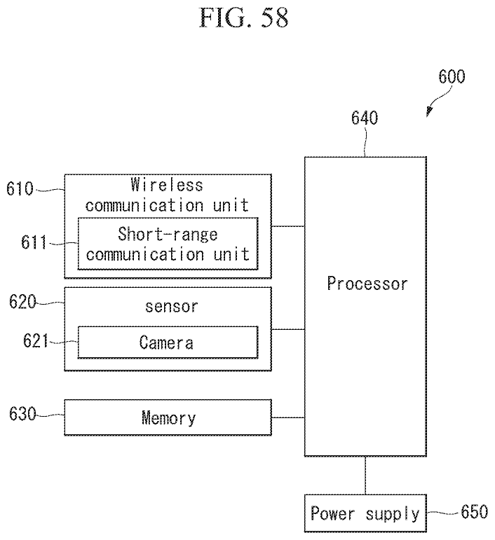

FIG. 58 shows the camera in FIG. 56.

As shown in FIG. 58, the camera 600 may include a wireless communication unit 610, a sensor 620, a memory 630, a power supply 650, and a processor 640 for controlling the above components.

The wireless communication unit 610 may include a short range communication unit 511 for acquiring a photographing command from the intelligent service providing apparatus 500 and transmitting the photographing command to the processor 540.

The sensor 520 may include a camera 621 for capturing an outside person 3 that has entered the space of the home.

The memory 630 may store instructions that include functions performed by the processor 640.

The power supply 650 may supply power to all components in the intelligent service providing apparatus 500.

The processor 640 controls the camera 621 to photograph the inside of the house. The captured image may be transmitted from the camera to the mobile terminal 800 of the user 1 using the wireless communication unit 610.

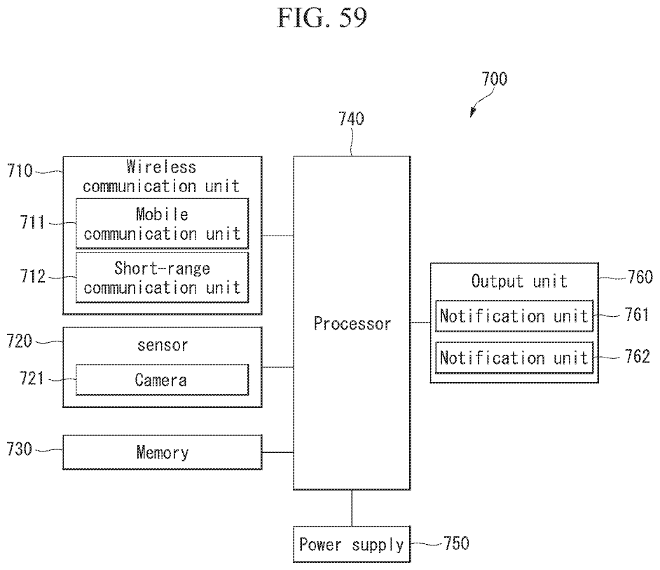

FIG. 59 shows the robot in FIG. 56.

As shown in FIG. 59, the robot 700 may include a wireless communication unit 710, a sensor 720, a memory 730, a power supply 750, and an output unit 760.

The wireless communication unit 710 may include a short-range communication unit 712 for obtaining an imaging command from the intelligent service providing apparatus 500 under the control of the processor 740, and a mobile communication unit 711 for transmitting the imaged image to the mobile terminal 800.

The sensor 720 may include a camera 721 for photographing a home space under the control of the processor 740.

The memory 730 may store information necessary for the operation of the processor 740.

The power supply 750 may power all components within the robot 700, including the processor 740.

The output unit 760 may include an audio output unit 761 and a notification unit 762 for outputting a predetermined voice under the control of the processor 740.

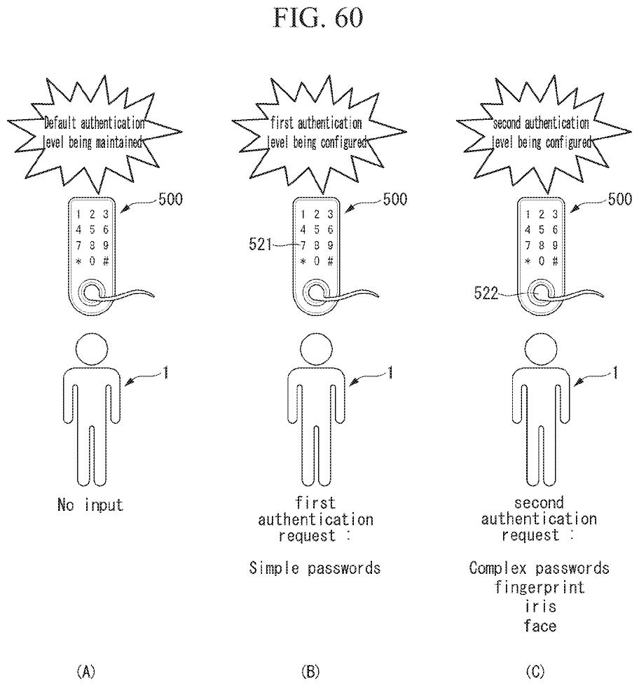

FIG. 60 shows the process of the authentication request and authentication level configuring for the door lock.

As shown in FIG. 60A, the intelligent service providing apparatus 500 may enable the default authentication level to be maintained when there is no input.

As shown in FIG. 60B, the intelligent service providing apparatus 500 may obtain a first authentication request that requests the first authentication level to be configured for the intelligent service providing apparatus 500. For example, the intelligent service providing apparatus 500 may obtain an input at a first difficulty level onto the number button 521 of the intelligent service providing apparatus 500 as an example of the first authentication request.

The intelligent service providing apparatus 500 may configure the first authentication level for the intelligent service providing apparatus in response to the first authentication request.

As shown in FIG. 60C, the intelligent service providing apparatus 500 may obtain a second authentication request (fingerprint, face or iris recognition).

Upon acquiring the second authentication request, the intelligent service providing apparatus 500 may configure the second authentication level for the intelligent service providing apparatus 500 in response to the second authentication request.

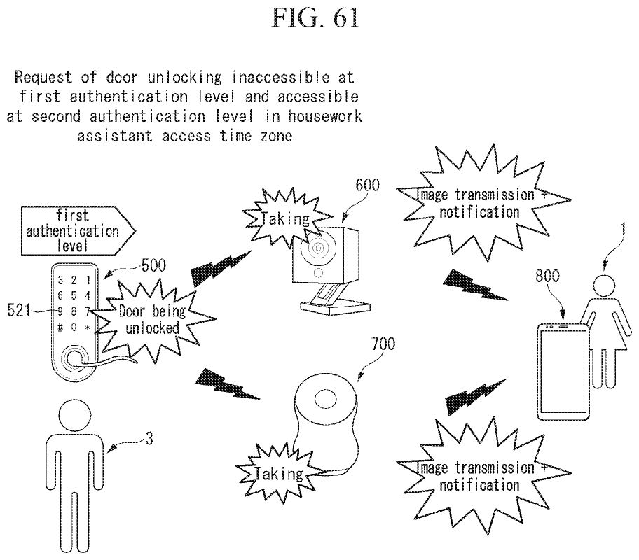

FIG. 61 shows an example of acquiring a door unlocking request while the first authentication level is configured for the door lock.

As shown in FIG. 61, while the first authentication level is configured to the intelligent service providing apparatus 500, the intelligent service providing apparatus 500 may obtain an unlocking request using a numeric button 521 or other input device in the housework assistant access time zone. For example, in the housework assistant access time zone, the intelligent service providing apparatus 500 may obtain an unlocking request that is not accessible at the first authentication level but is accessible at the second authentication level.

The intelligent service providing apparatus 500 does not execute unlocking immediately even when an unlocking request that is accessible at the second authentication level is acquired while the first authentication level is configured for the apparatus. Then, the intelligent service providing apparatus 500 may determine when the current time is a housework assistant access time zone.

When the current time zone is the housework assistant access time zone, the intelligent service providing apparatus 500 cancels the door locking. When the outsider 3 comes into the user home, the intelligent service providing apparatus 500 may send a command to take a picture in the house to the camera 600 and the robot 700.

The camera 600 and/or the robot 700 may transmit the in-house image taken in the house to the mobile terminal 800 of the user 1.

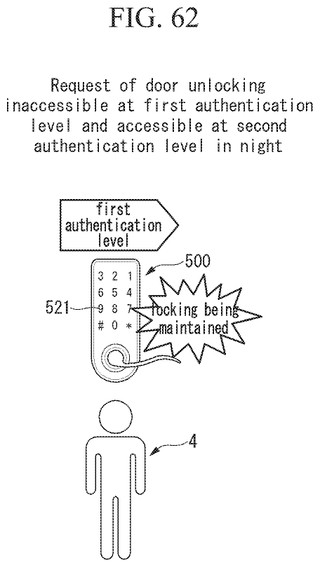

FIG. 62 shows another example of obtaining a door unlocking request while the first authentication level is configured for the door lock.

Unlike FIG. 61, as shown in FIG. 62, at night-time, not at the housework assistant access time, an unlocking request that is not accessible at the first authentication level but is accessible at the second authentication level is obtained by the intelligent service providing apparatus 500 while the first authentication level has been configured for the intelligent service providing apparatus 500. In response, the intelligent service providing apparatus 500 may maintain the door locking.

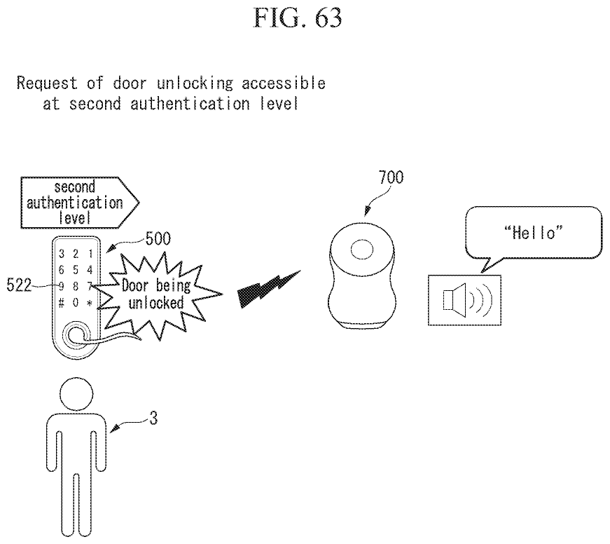

FIG. 63 shows another example of obtaining a door unlocking request while the second authentication level is configured for the door lock.

Unlike FIG. 62, as shown in FIG. 63, when an unlocking request that is accessible at the second authentication level is obtained by the intelligent service providing apparatus 500 while the second authentication level is configured for the intelligent service providing apparatus 500, the intelligent service providing apparatus 500 cancels the door locking.

Further, after canceling the door locking, the intelligent service providing apparatus 500 may control the robot 700 to output a greeting to the outsider 3 entering the house. Thus, the robot 700 may output the greeting “Hello”.

The present invention as described above may be implemented using a computer readable code on a medium on which a program is recorded. A computer readable medium may include any type of recording device that stores data that may be read by a computer system. Examples of the media that can be read by a computer include HDD (Hard Disk Drive), SSD (Solid State Disk), SDD (Silicon Disk Drive), ROM, RAM, CD-ROM, magnetic tape, floppy disk, optical data storage, etc. Further, a carrier wave, for example, in the form of transmission over the Internet may be used as the media. Accordingly, the detailed description above is to be considered in all respects only as illustrative and not in a limiting sense. The scope of the present invention should be determined by rational interpretation of the appended claims. All changes within the equivalent range of the present invention are included in the scope of the present invention.

What is claimed is:

1. A method for providing a service using a device based on an authentication level, the method comprising:
when a first authentication request to request configuring of a first authentication level for the device is obtained, configuring the first authentication level for the device;
when an access request to one of a plurality of services provided using the device is obtained, determining whether the first authentication level for the device matches the access request; and
upon determination that the first authentication level matches the access request, providing the service using the device.

2. The method of claim 1, further comprising:
upon determination that the authentication level does not match the access request, recommending an authentication level matching the access request.

3. The method of claim 1, further comprising:
when a threshold time duration has elapsed after the first authentication level has been set, cancelling the first authentication level.

4. The method of claim 3, wherein the cancelling includes:
when a second authentication request is obtained before the threshold time duration has elapsed, maintaining the first authentication level.

5. The method of claim 4, wherein the maintaining includes:
reconfiguring a timer as soon as the second authentication request is obtained.

6. The method of claim 3, wherein the cancelling includes:
switching the first authentication level gradually to a default authentication level in an inverse proportional manner to a time lapse for the threshold time duration.

7. The method of claim 1,
further comprising configuring a third authentication level for the device when a second authentication request to request a second authentication level is obtained, wherein a number of services matching the second authentication level is smaller than a number of services matching the first authentication level, and
a number of services matching the third authentication level is larger than a number of services matching the first authentication level.

8. The method of claim 7, further comprising:
when a first threshold time duration has elapsed after the first authentication level is set, switching the third authentication level to the second authentication level for the device; and
when a second threshold time duration has elapsed after the second authentication request is obtained, cancelling the second authentication level.

9. The method of claim 7, wherein a service matching the second authentication level requires a security level lower than a security level of a service matching the first authentication level.

10. The method of claim 7,
wherein the first authentication request includes fingerprint recognition or face recognition,
wherein the second authentication request includes touch recognition, speech recognition, or gesture recognition.

11. An intelligent service providing apparatus for providing a service based on an authentication level, the apparatus comprising:
an input interface configured for obtaining a first authentication request to request configuring of a first authentication level for a device, and for obtaining an access request to one of a plurality of services provided using the device;
a processor configured for configuring the first authentication level for the device in response to the first authentication request, and for determining, in response to the access request, whether the first authentication level for the device matches the access request; and
an output interface configured for providing the service using the device, upon determination that the first authentication level matches the access request.

12. The apparatus of claim 11, wherein the processor recommends an authentication level matching the access request, upon determination that the authentication level does not match the access request.

13. The apparatus of claim 11, wherein the processor cancels the first authentication level when a threshold time duration has elapsed after the first authentication level has been configured.

14. The apparatus of claim 13, wherein the processor maintains the first authentication level when a second authentication request is obtained before the threshold time duration has elapsed.

15. The apparatus of claim 14, wherein the processor reconfigures a timer as soon as the second authentication request is obtained.

16. The apparatus of claim 13, wherein the processor switches the first authentication level gradually to a default authentication level in an inverse proportional manner to a time lapse for the threshold time duration.

17. The apparatus of claim 11, wherein the processor configures a third authentication level for the device when a second authentication request to request a second authentication level is obtained,
wherein a number of services matching the second authentication level is smaller than a number of services matching the first authentication level, wherein a number of services matching the third authentication level is larger than a number of services matching the first authentication level.

18. The apparatus of claim 17, wherein the processor:
switches the third authentication level to the second authentication level for the device when a first threshold time duration has elapsed after the first authentication level is set; and
cancels the second authentication level when a second threshold time duration has elapsed after the second authentication request is obtained.

19. The apparatus of claim 17, wherein a service matching the second authentication level requires a security level lower than a security level of a service matching the first authentication level.

20. The apparatus of claim 17, wherein the first authentication request includes fingerprint recognition or face recognition, wherein the second authentication request includes touch recognition, speech recognition, or gesture recognition.
